(19) United States
(12) Patent Application Publication
(10) Pub. No.: US 2019/0307154 A1
(43) Pub. Date: Oct. 10, 2019

(54) STEVIOL GLYCOSIDE COMPOSITIONS WITH IMPROVED FLAVOR

(71) Applicants: Weiyao SHI, BETHLEHEM, PA (US); EPC Natural Products Co., Ltd., BEIJING (CN)

(72) Inventors: Jingang SHI, BEIJING (CN); Hansheng WANG, BEIJING (CN); Xin SHI, BEIJING (CN)

(21) Appl. No.: 16/405,748

(22) Filed: May 7, 2019

Related U.S. Application Data
(63) Continuation-in-part of application No. 14/714,644, filed on May 18, 2015, now Pat. No. 10,264,811.
(60) Provisional application No. 62/000,210, filed on May 19, 2014.
(60) Provisional application No. 62/023,216, filed on Jul. 11, 2014.
(60) Provisional application No. 62/668,535, filed on May 8, 2018.
(60) Provisional application No. 62/691,723, filed on Jun. 29, 2018.
(60) Provisional application No. 62/730,449, filed on Sep. 12, 2018.

(51) Int. Cl. A23L 27/30; A23L 33/10

(52) U.S. Cl. CPC A23L 27/36; A23L 33/10; A23V 2200/15; A23V 2200/238; A23V 2002/00; A23V 2250/262

(57) ABSTRACT

The application describes a stevia sweetener with improved taste profile and solubility in an aqueous solution for convenience of use in the food and beverage industry.

This application is a continuation-in-part application to U.S. patent application Ser. No. 14/714,644, filed May 18, 2015, which claims priority from U.S. Provisional Patent Application No. 62/000,210, filed May 19, 2014, and U.S. Provisional Patent Application No. 62/023,216, filed Jul. 11, 2014. This application also claims priority from U.S. Provisional Patent Application No. 62/668,535, filed May 8, 2018; U.S. Provisional Patent Application No. 62/691,723, filed Jun. 29, 2018; and U.S. Provisional Patent Application No. 62/730,449, filed Sep. 12, 2018. The contents of the above cited references are incorporated herein in their entirety for all purposes.

### FIELD

The present application generally relates to SG compositions with desirable solubility and taste profiles.

### BACKGROUND

Steviol glycosides (SGs) are high intensity sweeteners and have been widely used as sweeteners in food and beverage products. Many SGs have been isolated and identified, including rebaudioside A (RA), rebaudioside B (RB), stevioside (ST), steviol bioside (STB), rebaudiosides C (RC), rebaudiosides D (RD), etc.

Stevia glycosides generally have poor solubility. The taste of some stevia glycosides, such as RA, also needs improvement. Therefore, a need exists in the food and beverage industry for stevia glycoside compositions with improved solubility and a desirable taste profile.

Therefore, a need for SGs or a stevia glycoside composition with superior solubility exists in the food and beverage industry.

### SUMMARY

A first aspect of the present application relates to a composition comprising SGs from Table A, the composition comprising one or more SGs having a molecular weight of greater than 965 daltons. In some embodiments, the composition's content of SGs having a molecular weight of greater than 965 daltons is greater than 0.2%. In some further embodiments, the composition's content of SGs having a molecular weight of greater than 965 daltons is greater than 0.5%. In some still further embodiments, the composition's content of SGs having a molecular weight of greater than 965 daltons is greater than 1%.

In some embodiments, the composition comprises RA as 15-35% by weight of the total SGs. In other embodiments, the composition comprises RA as 20-30% by weight of the total SGs in the composition.

In some embodiments, the composition further comprises ST. In some further embodiments, ST is 15-30% by weight of the total SGs in the composition.

In some embodiments, the one or more SGs having a molecular weight of greater than 965 daltons is selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, AND RO2.

In some embodiments, the composition comprises one or more SGs having a molecular weight equal to or greater than 981 daltons. In some embodiments, the composition comprises one or more SGs having a molecular weight equal to or greater than 1097 daltons. In some embodiments, the composition comprises one or more SGs having a molecular weight equal to or greater than 1111 daltons. In some embodiments, the composition comprises one or more SGs having a molecular weight equal to or greater than 1127 daltons. In some embodiments, the composition comprises one or more SGs having a molecular weight equal to or greater than 1259 daltons. In some embodiments, the composition comprises one or more SGs having a molecular weight equal to or greater than 1273 daltons. In some embodiments, the composition comprises one or more SGs having a molecular weight equal to or greater than 1289 daltons. In some embodiments, the composition comprises one or more SGs having a molecular weight equal to or greater than 1305 daltons. In some embodiments, the composition comprises one or more SGs having a molecular weight equal to or greater than 1435 daltons.

In some embodiments, the composition further comprises RM. In some embodiments, RM is greater than 0.1% by weight of the total SGs in the composition. In some embodiments, RM is greater than 0.2% by weight of the total SGs in the composition. In some embodiments, RM is greater than 0.3% by weight of the total SGs in the composition. In some embodiments, RM is greater than 0.4% by weight of the total SGs in the composition. In some embodiments, RM is greater than 0.5% by weight of the total SGs in the composition. In some embodiments, RM is greater than 1% by weight of the total SGs in the composition. In some embodiments, RM is greater than 2% by weight of the total SGs in the composition. In some embodiments, RM is greater than 3% by weight of the total SGs in the composition. In some embodiments, RM is greater than 4% by weight of the total SGs in the composition. In some embodiments, RM is greater than 5% by weight of the total SGs in the composition. In some embodiments, RM is greater than 6% by weight of the total SGs in the composition. In some embodiments, RM is greater than 7% by weight of the total SGs in the composition. In some embodiments, RM is greater than 8% by weight of the total SGs in the composition. In some embodiments, RM is greater than 9% by weight of the total SGs in the composition. In some embodiments, RM is 0.5-10% by weight of the total SGs in the composition.

In some embodiments, the composition further comprises RN. In some embodiments, RN is greater than 0.1% by weight of the total SGs in the composition. In some embodiments, RN is 0.1-2% by weight of the total SGs in the composition.

In some embodiments, the composition further comprises RO. In some embodiments, RO is greater than 0.1% by weight of the total SGs in the composition. In some embodiments, RO is greater than 0.2% by weight of the total SGs in the composition. In some embodiments, RO is greater than 0.5% by weight of the total SGs in the composition. In some embodiments, RO is greater than 1% by weight of the total SGs in the composition. In some embodiments, RO is 0.2-1.5% by weight of the total SGs in the composition.

In some embodiments, the composition further comprises RH. In some embodiments, RH is greater than 0% by weight of the total SGs in the composition. In some embodiments, RH is greater than 0.1% by weight of the total SGs in the composition. In some embodiments, RH is greater than 0.2% by weight of the total SGs in the composition. In some embodiments, RH is 0-0.3% by weight of the total SGs in the composition.

In some embodiments, the composition further comprises RI. In some embodiments, RI is greater than 0.1% by weight of the total SGs in the composition. In some embodiments, RI is greater than 0.2% by weight of the total SGs in the composition. In some embodiments, RI is greater than 0.3% by weight of the total SGs in the composition. In some embodiments, RI is greater than 0.4% by weight of the total SGs in the composition. In some embodiments, RI is 0.2-0.5% by weight of the total SGs in the composition.

In some embodiments, the composition further comprises RI3. In some embodiments, RI3 is greater than 0.1% by weight of the total SGs in the composition. In some embodiments, RI3 is greater than 0.2% by weight of the total SGs in the composition. In some embodiments, RI3 is greater than 0.3% by weight of the total SGs in the composition. In some embodiments, RI3 is greater than 0.4% by weight of the total SGs in the composition. In some embodiments, RI3 is greater than 0.5% by weight of the total SGs in the composition. In some embodiments, RI3 is greater than 0.6% by weight of the total SGs in the composition. In some embodiments, RI3 is greater than 0.7% by weight of the total SGs in the composition. In some embodiments, RI3 is greater than 0.8% by weight of the total SGs in the composition. In some embodiments, RI3 is greater than 0.9% by weight of the total SGs in the composition. In some embodiments, RI3 is 0.4-1% by weight of the total SGs in the composition. In some embodiments, RI3 is absent from the composition.

In some embodiments, the composition further comprises RJ. In some embodiments, RJ is greater than 0.1% by weight of the total SGs in the composition. In some embodiments, RJ is greater than 0.2% by weight of the total SGs in the composition. In some embodiments, RJ is greater than 0.3% by weight of the total SGs in the composition. In some embodiments, RJ is greater than 0.4% by weight of the total SGs in the composition. In some embodiments, RJ is greater than 0.5% by weight of the total SGs in the composition. In some embodiments, RJ is greater than 0.6% by weight of the total SGs in the composition. In some embodiments, RJ is 0.1-0.7% by weight of the total SGs in the composition.

In some embodiments, the composition further comprises RK. In some embodiments, RK is greater than 0.1% by weight of the total SGs in the composition. In some embodiments, RK is greater than 0.2% by weight of the total SGs in the composition. In some embodiments, RK is greater than 0.3% by weight of the total SGs in the composition. In some embodiments, RK is greater than 0.4% by weight of the total SGs in the composition. In some embodiments, RK is greater than 0.5% by weight of the total SGs in the composition. In some embodiments, RK is greater than 0.6% by weight of the total SGs in the composition. In some embodiments, RK is greater than 0.7% by weight of the total SGs in the composition. In some embodiments, RK is 0.3-0.8% by weight of the total SGs in the composition

In some embodiments, the composition further comprises RK2. In some embodiments, RK2 is greater than 0.1% by weight of the total SGs in the composition. In some embodiments, RK2 is greater than 0.2% by weight of the total SGs in the composition. In some embodiments, RK2 is greater than 0.3% by weight of the total SGs in the composition. In some embodiments, RK2 is greater than 0.4% by weight of the total SGs in the composition. In some embodiments, RK2 is 0-0.5% by weight of the total SGs in the composition.

In some embodiments, the composition further comprises RL. In some embodiments, RL is greater than 0% by weight of the total SGs in the composition. In some embodiments, RL is greater than 0.1% by weight of the total SGs in the composition. In some embodiments, RL is greater than 0.2% by weight of the total SGs in the composition. In some embodiments, RL is greater than 0.3% by weight of the total SGs in the composition. In some embodiments, RL is 0-0.4% by weight of the total SGs in the composition.

In some embodiments, the composition further comprises RT. In some embodiments, RT is greater than 0.1% by weight of the total SGs in the composition. In some embodiments, RT is greater than 0.2% by weight of the total SGs in the composition. In some embodiments, RT is greater than 0.3% by weight of the total SGs in the composition. In some embodiments, RT is greater than 0.4% by weight of the total SGs in the composition. In some embodiments, RT is greater than 0.5% by weight of the total SGs in the composition. In some embodiments, RT is greater than 0.6% by weight of the total SGs in the composition. In some embodiments, RT is greater than 0.7% by weight of the total SGs in the composition. In some embodiments, RT is greater than 0.8% by weight of the total SGs in the composition. In some embodiments, RT is greater than 0.9% by weight of the total SGs in the composition. In some embodiments, RT is 0-1% by weight of the total SGs in the composition.

In some embodiments, the composition further comprises RU. In some embodiments, RU is greater than 0.1% by weight of the total SGs in the composition. In some embodiments, RU is greater than 0.2% by weight of the total SGs in the composition. In some embodiments, RU is greater than 0.3% by weight of the total SGs in the composition. In some embodiments, RU is greater than 0.4% by weight of the total SGs in the composition. In some embodiments, RU is 0.1-0.5% by weight of the total SGs in the composition.

In some embodiments, the composition further comprises RU2. In some embodiments, RU2 is greater than 0.1% by weight of the total SGs in the composition. In some embodiments, RU2 is greater than 0.2% by weight of the total SGs in the composition. In some embodiments, RU2 is greater than 0.3% by weight of the total SGs in the composition. In some embodiments, RU2 is greater than 0.4% by weight of the total SGs in the composition. In some embodiments, RU2 is 0-0.5% by weight of the total SGs in the composition.

In some embodiments, the composition further comprises RV. In some embodiments, RV is greater than 0% by weight of the total SGs in the composition. In some embodiments, RV is greater than 0.1% by weight of the total SGs in the composition. In some embodiments, RV is greater than 0.2% by weight of the total SGs in the composition. In some embodiments, RV is greater than 0.3% by weight of the total SGs in the composition. In some embodiments, RV is 0-0.4% by weight of the total SGs in the composition.

In some embodiments, the composition further comprises RV2. In some embodiments, RV2 is greater than 0% by weight of the total SGs in the composition. In some embodiments, RV2 is greater than 0.1% by weight of the total SGs in the composition. In some embodiments, RV2 is greater than 0.2% by weight of the total SGs in the composition. In some embodiments, RV2 is greater than 0.3% by weight of the total SGs in the composition. In some embodiments, RV2 is greater than 0.4% by weight of the total SGs in the composition. In some embodiments, RV2 is greater than 0.5% by weight of the total SGs in the composition. In some embodiments, RV2 is 0-0.6% by weight of the total SGs in the composition.

In some embodiments, the composition further comprises RW. In some embodiments, RW is greater than 0.1% by weight of the total SGs in the composition. In some embodiments, RW is greater than 0.2% by weight of the total SGs in the composition. In some embodiments, RW is greater than 0.3% by weight of the total SGs in the composition. In some embodiments, RW is greater than 0.4% by weight of the total SGs in the composition. In some embodiments, RW is 0-0.5% by weight of the total SGs in the composition.

In some embodiments, the composition further comprises RW2/3. In some embodiments, RW2/3 is greater than 0.1% by weight of the total SGs in the composition. In some embodiments, RW2/3 is 0-0.2% by weight of the total SGs in the composition.

In some embodiments, the composition further comprises RY. In some embodiments, RY is greater than 0% by weight of the total SGs in the composition. In some embodiments, RY is greater than 0.1% by weight of the total SGs in the composition. In some embodiments, RY is greater than 0.2% by weight of the total SGs in the composition. In some embodiments, RY is greater than 0.3% by weight of the total SGs in the composition. In some embodiments, RY is 0-0.4% by weight of the total SGs in the composition.

In some embodiments, the SG compositions described herein can be blended with one another in any combination for different taste profiles. In some further embodiments, the SG compositions listed in Tables 15-26 and 29-32 can be blended with one another in any combination for different taste profiles.

In some embodiments, any of the SG compositions described herein, or any combination thereof, can be used as a raw or starting material for enzymatic treatment, such as glycosylation, to obtain further alternative flavor and taste stevia products.

In particular embodiments, the percentage of each SG in the composition with a molecular weight of greater than 965 daltons creates a sugar-like taste profile and mouthful feeling.

In some embodiments, the composition containing SGs with a molecular weight of greater than 965 daltons has increased solubility in an aqueous solution compared to an SG composition not containing SGs with a molecular weight of greater than 965 daltons.

In some embodiments, the composition further comprises one or more non-SG sweeteners.

In some embodiments, the composition further comprises one or more salts.

In preferred embodiments, the composition contains trace or undetectable amounts of non-SG off-taste components.

Another aspect of the present application relates to an orally consumable composition comprising the composition of the present application. In some embodiments, the orally consumable composition is a sweetener. In other embodiments, the orally consumable composition is a flavoring agent. In some embodiments, the one or more SGs having a molecular weight of greater than 965 daltons constitute at least 5 ppm, 10 ppm, 20 ppm, 30 ppm, 40 ppm, 50 ppm, 60 ppm, 70 ppm, 80 ppm, 90 ppm, 100 ppm, 150 ppm, 200 ppm, 300 ppm, 400 ppm, 600 ppm, 800 ppm, 1000 ppm or 1200 ppm of the total orally consumable composition

Another aspect of the present application relates to a composition comprising SGs from Table A, wherein the composition comprises one or more SGs having high molecular weight. In some embodiments, the composition comprising one or more SGs having high molecular weight is useful for improving the solubility of other SG compositions. In some embodiments, the composition comprising one or more SGs having high molecular weight is useful for improving the taste profile of other SG compositions. In some embodiments, the other SG compositions comprise or consist essentially of ST, RA, RC, RB, RD, RE and DA.

Another aspect of the present application relates to a method for the preparation of a SG composition having an improved taste profile and increased solubility as compared to a nontreated SG composition. The method comprises the steps of mixing a SG or a SG composition with water to form a mixture; heating the mixture until the mixture provides a solution; cooling the solution to ambient temperature; and subjecting the solution to drying. In some embodiments, the drying is by spray drying. In particular embodiments, the method further comprises a step of removing non-steviol off-taste compounds. In some further embodiments, the off-taste compound has a bitter taste.

Still another aspect of the present application relates to a method for increasing the sweetness of an orally consumable composition, comprising the step of: adding an effective amount of a composition of any one of the embodiments in the numbered paragraphs described herein to the orally consumable composition.

Yet another aspect of the present application relates to a method for increasing a taste or flavor of an orally consumable composition, comprising the step of: adding an effective amount of a composition any one of the embodiments in the numbered paragraphs described herein to the orally consumable composition

Still another aspect of the present disclosure relates to a composition comprising one or more SGs, wherein the SG has a parent structure of formula II or formula III; wherein R₁ and R₂ are substituent groups individually selected from the group consisting of glucosyl (G), rhamnosyl (R), xylosyl (X), deoxy-glucosyl (dG), frucosyl (F), arabinosyl (A), galactosyl (Ga) groups, and any combination thereof, further wherein the number of the glucosyl group is equal to or greater than 4.

In some embodiments, the number of the rhamnosyl groups is equal to or greater than 1.

In some embodiments, the number of the xylosyl groups is equal to or greater than 1.

In some embodiments, the number of the deoxy-glucosyl groups is equal to or greater than 1.

In some embodiments, the number of the frucosyl groups is equal to or greater than 1.

In some embodiments, the number of the arabinosyl groups is equal to or greater than 1.

In some embodiments, the number of the galactosyl groups is equal to or greater than 1.

In some embodiments, the one or more SGs are selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, and RO2.

In some embodiments, the total SGs are present at an amount of over 80% by weight of the composition.

In some embodiments, the total SGs are present at an amount of over 90% by weight of the composition.

In some embodiments, the one or more SGs are present at an amount of 0.1-99.9% by weight of the total SGs in the composition.

In some embodiments, the one or more SGs are present at an amount of 1-30% by weight of the total SGs in the composition.

In some embodiments, the one or more SGs are present at an amount of 6-23% by weight of the total SGs in the composition.

In some embodiments, RD is 1.0-10.0% by weight of the total SGs in the composition.

In some embodiments, RD is 2.0-8.0% by weight of the total SGs in the composition.

In some embodiments, RO is 0.2-1.5% by weight of the total SGs in the composition.

In some embodiments, RK is 1-5% by weight of the total SGs in the composition.

In some embodiments, RV is 0-0.6% by weight of the total SGs in the composition.

In some embodiments, RT is 0-0.9% by weight of the total SGs in the composition.

In some embodiments, RN is 0-0.3% by weight of the total SGs in the composition.

In some embodiments, RM is 0-0.4% by weight of the total SGs in the composition.

In some embodiments, RJ is 0-0.3% by weight of the total SGs in the composition.

In some embodiments, RW is 0-0.4% by weight of the total SGs in the composition.

In some embodiments, RU2 is 0-0.5% by weight of the total SGs in the composition.

In some embodiments, RY is 0-0.3% by weight of the total SGs in the composition.

In some embodiments, RI is 0-0.3% by weight of the total SGs in the composition.

In some embodiments, RV2 is 0-0.5% by weight of the total SGs in the composition.

In some embodiments, RK2 is 0-0.5% by weight of the total SGs in the composition.

In some embodiments, RH is 0-0.3% by weight of the total SGs in the composition.

Another aspect of the present disclosure relates to a composition comprising RA and any of the above-identified compositions comprising one or more SGs, wherein the SG has a parent structure of formula II or formula III; wherein R₁ and R₂ are substituent groups individually selected from the group consisting of glucosyl (G), rhamnosyl (R), xylosyl (X), deoxy-glucosyl (dG), frucosyl (F), arabinosyl (A), galactosyl (Ga) groups, and any combination thereof, further wherein the number of the glucosyl group is equal to or greater than 4.

In some embodiments, RA is 15-50 wt % of the total SGs in the composition.

In some embodiments, RA is 25-35 wt % of the total SGs in the composition.

In some embodiments, the composition further comprises ST.

In some embodiments, the ST is 20-70 wt % of the total SGs in the composition.

In some embodiments, the ST is 20-45 wt % of the total SGs in the composition.

Another aspect of the present disclosure relates to a sweetener composition comprising any of the above-identified compositions comprising one or more SGs, wherein the SG has a parent structure of formula II or formula III; wherein R₁ and R₂ are substituent groups individually selected from the group consisting of glucosyl (G), rhamnosyl (R), xylosyl (X), deoxy-glucosyl (dG), frucosyl (F), arabinosyl (A), galactosyl (Ga) groups, and any combination thereof, further wherein the number of the glucosyl group is equal to or greater than 4.

In some embodiments, the sweetener composition is dissolved in a water solution. In some further embodiments, the sweetener composition is present in the solution at a concentration of less than 1500 ppm, less than 1000 ppm, less than 700 ppm, less than 400 ppm or less than 200 ppm. In other further embodiments, the sweetener composition is present in the solution at a concentration of at least 100 ppm.

In some embodiments, the sweetener composition has an improved property including lingering and upfront sweetness as compared with RA

Another aspect of the present disclosure relates to a flavor composition comprising any of the above-identified compositions comprising one or more SGs, wherein the SG has a parent structure of formula II or formula III; wherein R₁ and R₂ are substituent groups individually selected from the group consisting of glucosyl (G), rhamnosyl (R), xylosyl (X), deoxy-glucosyl (dG), frucosyl (F), arabinosyl (A), galactosyl (Ga) groups, and any combination thereof, further wherein the number of the glucosyl group is equal to or greater than 4.

In some embodiments, the flavor composition is dissolved in a water solution. In some further embodiments, the flavor composition is present in the solution at a concentration of 0-30 ppm, preferably 0-10 ppm, more preferably 5-10 ppm.

In some embodiments, the flavor composition increases the degree of sweetness.

In some embodiments of the flavor composition, the number of the rhamnosyl groups is equal to or greater than 1, and/or the number of the xylosyl groups is equal to or greater than 1, and/or the number of the deoxy-glucosyl groups is equal to or greater than 1, and/or the number of the frucosyl groups is equal to or greater than 1, and/or the number of the arabinosyl groups is equal to or greater than 1, and/or the number of the galactosyl groups is equal to or greater than 1.

In some embodiments of the flavor composition, the one or more SGs are selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, and RO2.

In some embodiments, the total SGs are present at an amount of 50-90% by weight of the flavor composition.

In some embodiments, RD is present at an amount of 0.2-9% by weight of the flavor composition.

In some embodiments, RM is present at an amount of 0.1-4.0% by weight of the flavor composition.

In some embodiments, RU is present at an amount of 0.1-3.0% by weight of the flavor composition.

In some embodiments, the flavor composition further comprises RA and STV. In some further embodiments, RA is present at an amount of 20-30% by weight of the flavor composition. In other further embodiments, STV is present at an amount of 8-40% by weight of the flavor composition.

In some embodiments, the flavor composition further comprises RF, RC, Dulc A, RB and STB.

In some embodiments, the flavor composition is dissolved in a water solution. In some further embodiments, the flavor composition is present in the solution at a concentration of less than 60 ppm, less than 70 ppm, less than 75 ppm, less than 100 ppm, less than 200 ppm or less than 300 ppm.

Another aspect of the present disclosure relates to a composition comprising two groups of SGs. The first group of SGs comprises one or more SGs selected from any SGs having a parent structure of formula II or formula III; wherein R₁ and R₂ are substituent groups individually selected from the group consisting of glucosyl (G), rhamnosyl (R), xylosyl (X), deoxy-glucosyl (dG), frucosyl (F), arabinosyl (A), galactosyl (Ga) groups, and any combination thereof, further wherein the number of the glucosyl group is equal to or greater than 4, and optionally, the number of the rhamnosyl groups is equal to or greater than 1, and/or the number of the xylosyl groups is equal to or greater than 1, and/or the number of the deoxy-glucosyl groups is equal to or greater than 1, and/or the number of the frucosyl groups is equal to or greater than 1, and/or the number of the arabinosyl groups is equal to or greater than 1, and/or the number of the galactosyl groups is equal to or greater than 1. The second group of SGs comprises one or more SGs selected from the groups essentially consisting of RA, RB, Stevioside, RC, RD, RM or the combination thereof.

In some embodiments, the ratio of the weight of the first group and the second group of SG is 1:99, 2:98, 3:97, 4:96; 5:95; 6:94; 7:93; 8:94; 9:91; 10:90; 11:89; 12:88; 13:87; 14:86; 15:85; 16:84; 17:83; 18:82; 19:81; 20:80; 21:79; 22:78; 23:77; 24:76; 25:75; 26:74; 27:73; 28:72; 29:71; 30:70; 31:69; 32:68; 33:67; 34:66; 35:65; 36:64; 37:63; 38:62; 39:61; 40:60; 41:59; 42:58; 43:57; 44:56; 45:55; 46:54; 47:53; 48:52; 49:51; 50:50; 51:49; 52:48; 53:47; 54:45; 55:45; 56:44; 57:43; 58:42; 59:41; 60:40; 61:39; 62:38; 63:37; 64:36; 65:35; 66:37; 67:33; 68:32; 69:31; 70:30; 71:29; 72:28; 73:27; 74:26; 75:25; 76:24; 77:23; 78:22; 79:21; 80:20; 81:19; 82:18; 83:17; 84:16; 85:15; 86:14; 87:13; 88:12; 89:11; 90:10; 91:9; 92:8; 93:7; 94:6; 95:5; 96:4; 97:3; 98:2 or 99:1.

### BRIEF DESCRIPTION OF THE DRAWINGS

FIG. 1 shows a Powder XRD spectrum of sample 094-39-01.

FIG. 2 shows a Powder XRD spectrum of sample 094-39-02.

FIG. 3 is a graphical illustration showing an analytical methodology for determining the SGs and their amounts in mother liquid samples.

FIG. 4 is an HPLC standardization curve for STB.

FIG. 5 is an HPLC standardization curve for RA.

FIG. 6 is an HPLC standardization curve for RD.

FIG. 7 is an exemplary peak identification plot.

FIG. 8 is an HPLC chromatogram of the exemplary composition of the present disclosure in Table 10.

FIG. 9 is a chromatogram of the total ion current of the exemplary composition of the present disclosure in Table 10.

FIG. 10 is an HPLC chromatogram of the exemplary composition of the present disclosure in Table 11.

FIG. 11 is a chromatogram of the total ion current of the exemplary composition of the present disclosure in Table 11.

FIG. 12 is an HPLC chromatogram of the exemplary composition of the present disclosure in Table 12.

FIG. 13 is a chromatogram of the total ion current of the exemplary composition of the present disclosure in Table 12.

FIG. 14 is an HPLC chromatogram of the exemplary composition of the present disclosure in Table 13.

FIG. 15 is a chromatogram of the total ion current of the exemplary composition of the present disclosure in Table 13.

FIG. 16 is an HPLC chromatogram of the exemplary composition of the present disclosure in Table 14.

FIG. 17 is a chromatogram of the total ion current of the exemplary composition of the present disclosure in Table 14.

FIG. 18 is an HPLC chromatogram of the exemplary composition of the present disclosure in Table 15.

FIG. 19A is an exemplary generic sweetness profile. FIG. 19B is a sweetness profile for a 5% sucrose solution.

FIG. 20A is a sweetness profile for Sample Composition #3 (Table 16). FIG. 20B is a sweetness profile for Sample Composition #4 (Table 17). FIG. 20C is a sweetness profile for Sample Composition #11 (Table 24). FIG. 20D is a sweetness profile for Sample Composition #12 (Table 25).

FIG. 21A depicts a chromatogram MS corresponding to the composition shown in Table 62 and 63. (Upper trace: FEML, Lower Trace SEML).

FIG. 21B depicts a chromatogram UV detection corresponding to the composition shown in Table 62 and 63. (Upper trace: FEML, Lower Trace SEML.)

### DETAILED DESCRIPTION

In the specification and in the claims, the terms “including” and “comprising” are open-ended terms and should be interpreted to mean “including, but not limited to . . . ”. These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this application belongs. All publications and patents specifically mentioned herein are incorporated by reference in their entirety for all purposes including describing and disclosing the chemicals, instruments, statistical analyses and methodologies which are reported in the publications which might be used in connection with the application. All references cited in this specification are to be taken as indicative of the level of skill in the art. Nothing herein is to be construed as an admission that the application is not entitled to antedate such disclosure by virtue of prior application.

As used herein, the term “rebaudioside” can be abbreviated as “Reb” or “R.” For example, the phrase “Rebaudioside A” has the same meaning as “Reb A” and “RA.” The same holds true for all rebaudiosides. Similarly, the term “dulcoside” can be appreviated as “Dul” or “D” with reference to DA, DA1, or DB.

The term “SG” is recognized in the art and is intended to include the major and minor constituents of stevia as listed, for example, in Table A. These include, but are not limited to components of stevia, such as Steviol, STB, ST, RA, RB, RC, RD, RE, RF, RM (also referred to as Rebaudioside X (RX)), Rubusoside and Dulcosides A, A1 and B. The SG can be purified before use.

As used herein, the term “high molecular weight” in regard to a SG refers to a SG having a molecular weight of more than 965 daltons.

The phrase “stevia containing sweetener” is intended to include any composition that is prepared from a stevia plant, such as a stevia extract, or the individual components found in stevia. The sweetener can include one or more of the components associated with the stevia plant, such as those noted above. The sweetener can also include conventional artificial or natural sweeteners, such as sucrose, glucose, maltose, fructose, mannitol, sorbitol, aspartame, inulin, sucralose, acesulfame-K, sodium cyclamate, mogroside and its derivatives, etc.

A “SG composition” as referred to herein, pertains to a material that includes one or two or more previously purified SGs found in the stevia plant or sweet tea plant or a stevia extract or a sweet tea extract. Additionally, the “SG composition” may refer to a stevia extract, sweet tea extract, or “stevia starting material” as described below.

The phrase “stevia starting material” or “raw material” means a material containing SGs of the plant Stevia rebaudiana or other species of the Stevia genus. In some embodiments, the stevia starting material or raw material can be a crude extract, a purified extract, or a byproduct of a purification process. In other embodiments, the stevia starting material comprises SGs that originated from a fermentation and/or enzymatic transformation process, or any synthetic process. A crude extract is typically the first dried product produced after processing harvested Stevia plant material. A purified extract contains a higher concentration of one or more SGs of interest than contained in a crude extract. A byproduct of a purification process typically is all or a portion of the waste stream from purifying SGs from crude extract or from an intermediate purity.

The phrase “sucrose equivalence” or “SE” is the amount of non-sucrose sweetener required to provide the sweetness of a given percentage of sucrose in the same food, beverage, or solution. For instance, a non-diet soft drink typically contains 12 grams of sucrose per 100 ml of water, i.e., 12% sucrose. This means that to be commercially accepted, diet soft drinks must have the same sweetness as a 12% sucrose soft drink, i.e., a diet soft drink must have a 12% SE. Soft drink dispensing equipment assumes an SE of 12%, since such equipment is set up for use with sucrose-based syrups.

The phrases “taste profile” or “sensory profile” are used with reference to the temporal profile of all basic tastes of a sweetener. The onset and decay of sweetness when a sweetener is consumed, as perceived by trained human tasters and measured in seconds from first contact with a taster's tongue (“onset”) to a cutoff point (typically 180 seconds after onset), is called the “temporal profile of sweetness.” A plurality of such human tasters is called a “sensory panel.” In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness.”

The term “flavor” or “flavor characteristic”, as used herein, is the combined sensory perception of the components of taste, odor, and/or texture. The term “enhance”, as used herein, includes augmenting, intensifying, accentuating, magnifying, and potentiating the sensory perception of a flavor characteristic without changing the nature or quality thereof. The term “modify”, as used herein, includes altering, varying, suppressing, depressing, fortifying and supplementing the sensory perception of a flavor characteristic where the quality or duration of such characteristic was deficient.

The solubility disclosed throughout the present disclosure is “long term solubility”, not “initial solubility” as described in the field. The long term solubility of the current embodiments differentiates over initial or short term solubilities. In other words, the solutions of the present application remain homogenous for a long period of time, without crystallization, precipitation, or solution heterogeneity. Generally, long term solubility described herein is from at least 1 day to greater than 5 years, from about 5 days to about 2 years, and more particularly from about 30 days to about 1 year. The technology may also be applied for improving the initial solubility of a single SG.

### 1. SG Compositions with Desirable Solubility and Taste Profiles

One aspect of the present application relates to a SG composition with desirable solubility and/or taste profile. The SG composition may be used as a sweetener and/or flavoring agent. In some embodiments, the SG composition of the present application comprises one or more SGs and has significantly improved long term solubility in water and/or significantly improved taste profiles over previously reported SG compositions, such as purified RA.

The bitter taste associated with SG compositions is not only the result of SGs exceeding a threshold of off-taste properties, such as astringency and bitterness, but is also the result of the compositions containing non-stevia off-taste components, such as polyphenols, etc. The present inventors through the processes described herein have successfully removed non-stevia off-taste components and incorporated stevia glycosides in the composition in an amount lower than the sense-able, or orally detectable, bitterness of every SG in solution. The present inventors have surprisingly found that the taste of all such SG compositions taste like sugar at all industrial usable concentrations.

In some embodiments, it has been surprisingly found by the present inventors that the long term solubility of a SG or a SG composition can be significantly improved by solubilizing the SG or SG composition at elevated temperature in water and then lowering the temperature to ambient temperature. The resultant solution can be spray dried wherein the SG or SG composition is stable in water or water/alcohol for greater than 1 day at ambient temperature. The terms “stable” or “stability” throughout the specification refers to without limitation, the duration of solubility of the SG or a SG composition when dissolved in a solvent. The process provides a stevia extract, a stevia component, or mixtures of stevia components that are treated.

In some embodiments, the present disclosure provides SG compositions having improved solubility and taste profiles comprising one or more SGs, one or more non-SG sweeteners and/or one or more additional additives. In some embodiments, the additional additives include, but are not limited to, flavoring agents, salts, minerals, organic acids and inorganic acids, polyols, nucleotides, bitter compounds, astringent compounds, proteins or protein hydrolysates, surfactants, gums and waxes, antioxidants, polymers, fatty acids, vitamins, preservatives, hydration agents and combinations thereof.

In some embodiments, the present disclosure provides SG compositions comprising trace or undetectable amounts of non-stevia substances that impart bitter taste.

SGs and SG Compositions

SGs are glycosides of steviol, a diterpene compound shown below in formula I.

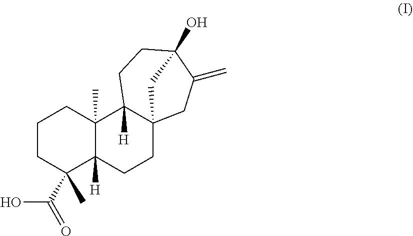

As shown in Formula II, SGs can have a parent or core structure comprising a steviol molecule with glycosylation at the C13 and/or C19 position.

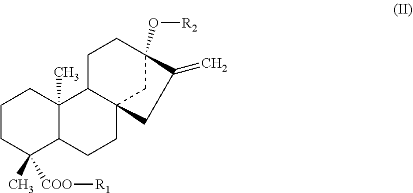

As shown in Formula III, steviol glycosides can also have a parent or core structure comprising an iso-steviol (Iso-Sv) molecule with glycosylation at the C13.

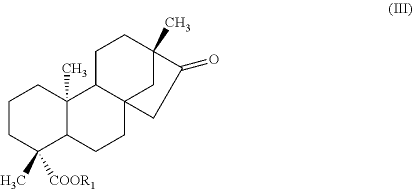

In some embodiments of SGs having a parent or core structure of Formula II or Formula III, R1 and R2 are substituent groups individually selected from the groups comprising glucosyl (G), rhamnosyl (R), xylosyl (X), deoxy-glucosyl (dG), frucosyl (F), arabinosyl (A) or galactosyl (Ga) group. In some further embodiments, the number of the glucosyl group is equal to or greater than 4.

Table A provides a list of about 80 SGs for use in the present application.

TABLE A
SGs

| | | | | # of | | | |
|---|---|---|---|---|---|---|---|
| | | # of | # of | Xylose or | | | |
| | | Glucose | Rhamnose | Arabinose | | | |
| SG | | moieties | moieties | moieties | | | |
| Name | MW | (mr = 180) | (mr = 164) | (mr = 150) | R1 (C-19) | R2 (C-13) | Backbone |
| Related SG#1 | 457 | — | | | | | |
| Steviol- | 479 | 1 | | | H- | Glcβ1- | Steviol |
| monoside | | | | | | | |
| Steviol- | 479 | 1 | 1 | | Glcβ1- | H- | |
| monoside A | | | | | | | |
| SG-4 | 611 | 1 | | 1 | H- | Xylβ(1-2)Glcβ1- | Steviol |
| Dulcoside A1 | 625 | 1 | 1 | | H- | Rhaα(1-2)Glcβ1- | Steviol |
| Iso- | 641 | 2 | | | H- | Glcβ(1-2)Glcβ1- | Isosteviol |
| Steviolbioside | | | | | | | |
| Reb-G1 | 641 | 2 | | | H- | Glcβ(1-3)Glcβ1- | Steviol |
| rubusoside | 641 | 2 | | | Glcβ1- | Glcβ1- | Steviol |
| steviolbioside | 641 | 2 | | | H- | Glcβ(1-2)Glcβ1- | Steviol |
| Related SG#3 | 675 | — | | | | | |
| Reb-F1 | 773 | 2 | | 1 | H- | Xylβ(1-2)[Glcβ(1- | Steviol |
| | | | | | | 3)]Glcβ1- | |
| Reb-R1 | 773 | 2 | | 1 | H- | Glcβ(1-2)[Glcβ(1- | Steviol |
| | | | | | | 3)]Xylβ1- | |
| Stevioside F | 773 | 2 | | 1 | Glcβ1- | Xylβ(1-2)Glcβ1- | Steviol |
| (SG-1) | | | | | | | |
| SG-Unk1 | 773 | 2 | | 1 | — | — | Steviol |
| Dulcoside A | 787 | 2 | 1 | | Glcβ1- | Rhaα(1-2)Glcβ1- | Steviol |
| Dulcoside B | 787 | 2 | 1 | | H- | Rhaα(1-2)[Glcβ(1- | Steviol |
| (JECFA C) | | | | | | 3)]Glcβ1- | |
| SG-3 | 787 | 2 | 1 | | H- | 6-deoxyGlcβ(1- | Steviol |
| | | | | | | 2)[Glcβ(1-3)]Glcβ1- | |
| Stevioside D | 787 | 2 | 1 | | Glcβ1- | Glcβ(1-2)6- | |
| | | | | | | deoxyGlcβ1- | |
| Iso-Reb B | 803 | 3 | | | H- | Glcβ(1-2)[Glcβ(1- | Isosteviol |
| | | | | | | 3)]Glcβ1- | |
| Iso-Stevioside | 803 | 3 | | | Glcβ1- | Glcβ(1-2)Glcβ1- | Isosteviol |
| Reb B | 803 | 3 | | | H- | Glcβ(1-2)[Glcβ(1- | Steviol |
| | | | | | | 3)]Glcβ1- | |
| Reb G | 803 | 3 | | | Glcβ1- | Glcβ(1-3)Glcβ1- | Steviol |
| Reb-KA | 803 | 3 | | | Glcβ(1- | Glcβ1- | Steviol |
| | | | | | 2)Glcβ1- | | |
| SG-13 | 803 | 3 | | | Glcβ1- | Glcβ(1-2)Glcβ1- | Isomeric |
| | | | | | | | steviol |
| | | | | | | | (12α-hydroxy) |
| Stevioside | 803 | 3 | | | Glcβ1- | Glcβ(1-2)Glcβ1- | Steviol |
| Stevioside B | 803 | 3 | | | Glcβ(1- | Glcβ1- | Steviol |
| (SG-15) | | | | | 3)Glcβ1- | | |
| Reb F | 935 | 3 | | 1 | Glcβ1- | Xylβ(1-2)[Glcβ(1- | Steviol |
| | | | | | | 3)]Glcβ1- | |
| Reb R | 935 | 3 | | 1 | Glcβ1- | Glcβ(1-2)[Glcβ(1- | Steviol |
| | | | | | | 3)]Xylβ1- | |
| SG-Unk2 | 935 | 3 | | 1 | — | — | Steviol |
| SG-Unk3 | 935 | 3 | | 1 | — | — | Steviol |
| Reb F3 | 935 | 3 | | 1 | Xylβ(1- | Glcβ(1-2)Glcβ1- | Steviol |
| (SG-11) | | | | | 6)Glcβ1- | | |
| Reb F2 | 935 | 3 | | 1 | Glcβ1- | Glcβ(1-2)[Xylβ(1- | Steviol |
| (SG-14) | | | | | | 3)]Glcβ1- | |
| Reb C | 949 | 3 | 1 | | Glcβ1- | Rhaα(1-2)[Glcβ(1- | Steviol |
| | | | | | | 3)]Glcβ1- | |
| Reb C2/Reb S | 949 | 3 | 1 | | Rhaα(1- | Glcβ(1-2)Glcβ1- | Steviol |
| | | | | | 2)Glcβ1- | | |
| Stevioside E | 949 | 3 | 1 | | Glcβ1- | 6-DeoxyGlcβ(1- | Steviol |
| (SG-9) | | | | | | 2)[Glcβ(1-3)]Glcβ1- | |
| Stevioside E2 | 949 | 3 | 1 | | 6- | Glcβ(1-2)[Glcβ(1- | |
| | | | | | DeoxyGlcβ1- | 3)]Glcβ1- | |
| SG-10 | 949 | 3 | 1 | | Glcβ1- | Glcα(1-3)Glcβ(1- | Steviol |
| | | | | | | 2)[Glcβ(1-3])Glcβ1- | |
| Reb L1 | 949 | 3 | 1 | | H- | Glcβ(1-3)Rhaα(1- | Steviol |
| | | | | | | 2)[Glcβ(1-3)]Glcβ1- | |
| SG-2 | 949 | 3 | 1 | | Glcβ1- | 6-deoxyGlcβ(1- | Steviol |
| | | | | | | 2)[Glcβ(1-3)]Glcβ1- | |
| Reb A3 | 965 | 4 (1 Fru) | | | Glcβ1- | Glcβ(1-2)[Fruβ(1- | |
| (SG-8) | | | | | | 3)]Glcβ1- | |
| Iso-Reb A | 965 | 4 | | | Glcβ1- | Glcβ(1-2)[Glcβ(1- | Isosteviol |
| | | | | | | 3)]Glcβ1- | |
| Reb A | 965 | 4 | | | Glcβ1- | Glcβ(1-2)[Glcβ(1- | Steviol |
| | | | | | | 3)]Glcβ1- | |
| Reb A2 | 965 | 4 | | | Glcβ1- | Glcβ(1-6)[Glcβ(1-2 | Steviol |
| (SG-7) | | | | | | )]Glcβ1- | |
| Reb E | 965 | 4 | | | Glcβ(1- | Glcβ(1-2)Glcβ1- | Steviol |
| | | | | | 2)Glcβ1- | | |
| Reb H1 | 965 | 4 | | | H- | Glcβ(1-6)Glcβ(1- | Steviol |
| | | | | | | 3)[Glcβ1-3)]Glcβ1- | |
| Related SG#2 | 981 | — | | | | | |
| Related SG#5 | 981 | — | | | | | |
| Reb U2 | 1097 | 4 | | 1 | Xylβ(1- | Glcβ(1-2)Glcβ1- | |
| | | | | | 2)[Glcβ(1- | | |
| | | | | | 3)]Glcβ1- | | |
| Reb T | 1097 | 4 | | 1 | Xylβ(1- | Glcβ(1-2)[Glcβ(1- | |
| | | | | | 2)Glcβ1- | 3)]Glcβ1- | |
| Reb W | 1097 | 4 | | 1 | Glcβ(1- | Glcβ(1-2)Glcβ1- | |
| | | | | | 2)[Araβ(1- | | |
| | | | | | 3)]Glcβ1- | | |
| Reb W2 | 1097 | 4 | | 1 | Araβ(1- | Glcβ(1-2)[Glcβ(1- | |
| | | | | | 2)Glcβ1- | 3)]Glcβ1- | |
| Reb W3 | 1097 | 4 | | 1 | Araβ(1- | Glcβ(1-2)[Glcβ(1- | |
| | | | | | 6)Glcβ1- | 3)]Glcβ1- | |
| Reb U | 1097 | 4 | | 1 | Araα(1-2)- | Glcβ(1-2)[Glcβ(1- | Steviol |
| | | | | | Glcβ1- | 3)]Glcβ1- | |
| SG-12 | 1111 | 4 | 1 | | Rhaα(1- | Glcβ(1-2)[Glcβ(1- | Steviol |
| | | | | | 2)Glcβ1- | 3)]Glcβ1- | |
| Reb H | 1111 | 4 | 1 | | Glcβ1- | Glcβ(1-3)Rhaα(1- | Steviol |
| | | | | | | 2)[Glcβ(1-3)]Glcβ1- | |
| Reb J | 1111 | 4 | 1 | | Rhaα(1- | Glcβ(1-2)[Glcβ(1- | Steviol |
| | | | | | 2)Glcβ1- | 3)]Glcβ1- | |
| Reb K | 1111 | 4 | 1 | | Glcβ(1- | Rhaα(1-2)[Glcβ(1- | Steviol |
| | | | | | 2)Glcβ1- | 3)]Glcβ1- | |
| Reb K2 | 1111 | 4 | 1 | | Glcβ(1- | Rhaα(1-2)[Glcβ(1- | Steviol |
| | | | | | 6)Glcβ1- | 3)]Glcβ1- | |
| SG-Unk4 | 1111 | 4 | 1 | | — | — | Steviol |
| SG-Unk5 | 1111 | 4 | 1 | | — | — | Steviol |
| Reb D | 1127 | 5 | | | Glcβ(1- | Glcβ(1-2)[Glcβ(1- | Steviol |
| | | | | | 2)Glcβ1- | 3)]Glcβ1- | |
| Reb I | 1127 | 5 | | | Glcβ(1- | Glcβ(1-2)[Glcβ(1- | Steviol |
| | | | | | 3)Glcβ1- | 3)]Glcβ1- | |
| Reb L | 1127 | 5 | | | Glcβ1- | Glcβ(1-6)Glcβ(1- | Steviol |
| | | | | | | 2)[Glcβ(1-3)]Glcβ1- | |
| Reb I3 | 1127 | 5 | | | [Glcβ(1-2)G | Glcβ(1-2)Glcβ1- | |
| | | | | | lcβ(1-6)]Glc | | |
| | | | | | β1- | | |
| SG-Unk6 | 1127 | 5 | | | — | — | Steviol |
| Reb Q (SG- | 1127 | 5 | | | Glcβ1- | Glcα(1-4)Glcβ(1- | Steviol |
| 5) | | | | | | 2)[Glcβ(1-3)]Glcβ1- | |
| Reb I2 (SG- | 1127 | 5 | | | Glcβ1- | Glcα(1-3)Glcβ1- | Steviol |
| 6) | | | | | | 2[Glcβ1-3)]Glcβ1- | |
| Reb Q2 | 1127 | 5 | | | Glcα(1- | Glcβ(1-2)Glcβ1- | |
| | | | | | 2)Glcaα(1-4)Glcβ1- | | |
| Reb Q3 | 1127 | 5 | | | Glcβ1- | Glcα(1-4)Glcβ(1- | |
| | | | | | | 3)[Glcβ(1-2)]Glcβ1- | |
| Reb T1 | 1127 | 5 (1 | | | Galβ(1- | Glcβ(1-2)[Glcβ(1- | |
| | | Gal) | | | 2)Glcβ1- | 3)]Glcβ1- | |
| Related SG#4 | 1127 | — | | | | | |
| Reb V2 | 1259 | 5 | | 1 | Xylβ(1- | Glcβ(1-2)[Glcβ(1- | Steviol |
| | | | | | 2)[Glcβ(1- | 3)]Glcβ1- | |
| | | | | | 3)]-Glcβ1- | | |
| Reb V | 1259 | 5 | | 1 | Glcβ(1- | Xylβ(1-2)[Glcβ(1- | |
| | | | | | 2)[Glcβ(1- | 3)]-Glcβ1- | |
| | | | | | 3)]Glcβ1- | | |
| Reb Y | 1259 | 5 | | 1 | Glcβ(1- | Glcβ(1-2)[Glcβ(1- | |
| | | | | | 2)[Araβ(1- | 3)[Glcβ1- | |
| | | | | | 3)]Glcβ1- | | |
| Reb N | 1273 | 5 | 1 | | Rhaα(1- | Glcβ(1-2)[Glcβ(1- | Steviol |
| | | | | | 2)[Glcβ(1- | 3)]Glcβ1- | |
| | | | | | 3)]Glcβ1- | | |
| Reb M | 1289 | 6 | | | Glcβ(1- | Glcβ(1-2)[Glcβ(1- | Steviol |
| | | | | | 2)[Glcβ(1- | 3)]Glcβ1- | |
| | | | | | 3)]Glcβ1- | | |
| 15α-OH Reb | 1305 | 6 | | | Glcβ1- | Glcβ(1-2)[Glcβ1- | 15α- |
| M | | | | | 2(Glcβ1- | 3]Glcβ1- | Hydroxy- |
| | | | | | 3)Glcβ1- | | steviol |
| Reb O | 1435 | 6 | 1 | | Glcβ(1- | Glcβ(1-2)[Glcβ(1- | Steviol |
| | | | | | 3)Rhaα(1- | 3)]Glcβ1- | |
| | | | | | 2)[Glcβ(1- | | |
| | | | | | 3)]Glcβ1- | | |
| Reb O2 | 1435 | 6 | 1 | | Glcβ(1- | Glcβ(1-2)[Glcβ(1- | |
| | | | | | 4)Rhaα(1- | 3)]Glcβ1- | |
| | | | | | 2)[Glcβ(1- | | |
| | | | | | 3)]Glcβ1- | | |

Exemplary SGs include, for example, ST, STB, RA, RB, RC, RD, RE, RF, RM, Rubusoside and Dulcoside A. Additional SGs include, but are not limited to, SG-1 to 16 (SGs without a specific name); SG-Unk1-6 (SGs without detailed structural proof); glucosylated SGs (GSGs), steviol monoside, iso-steviolbioside, iso-RB, iso-ST, Dulcoside B, RG, RK, RR, RI, RL, RT, RN, 15α-OH RM, RL, RS, and RO.

The one or more SGs contained in the SG composition of the present application can make up anywhere from about 1 wt. % of the SG composition to about 99 wt. % of the SG composition, specifically about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, about 66 wt. %, about 67 wt. %, about 68 wt. %, about 69 wt. %, about 70 wt. %, about 71 wt. %, about 72 wt. %, about 73 wt. %, about 74 wt. %, about 75 wt. %, about 76 wt. %, about 77 wt. %, about 78 wt. %, about 79 wt. %, about 80 wt. %, about 81 wt. %, about 82 wt. %, about 83 wt. %, about 84 wt. %, about 85 wt. %, about 86 wt. %, about 87 wt. %, about 88 wt. %, about 89 wt. %, about 90 wt. %, about 91 wt. %, about 92 wt. %, about 93 wt. %, about 94 wt. %, about 95 wt. %, about 96 wt. %, about 97 wt. %, about 98 wt. %, about 99 wt. %, and all ranges therebetween, including for example from about 40 wt % to about 45 wt %, 40 wt % to about 50 wt %, 40 wt % to about 55 wt %, 40 wt % to about 60 wt %, 40 wt % to about 65 wt %, 40 wt % to about 70 wt %, 40 wt % to about 75 wt %, 40 wt % to about 80 wt %, 40 wt % to about 85 wt %, 40 wt % to about 90 wt %, 40 wt % to about 95 wt %, 40 wt % to about 97 wt %, 40 wt % to about 99 wt %, 45 wt % to about 50 wt %, 45 wt % to about 55 wt %, 45 wt % to about 60 wt %, 45 wt % to about 65 wt %, 45 wt % to about 70 wt %, 45 wt % to about 75 wt %, 45 wt % to about 80 wt %, 45 wt % to about 85 wt %, 45 wt % to about 90 wt %, 45 wt % to about 95 wt %, 45 wt % to about 97 wt %, 45 wt % to about 99 wt %, 50 wt % to about 55 wt %, 50 wt % to about 60 wt %, 50 wt % to about 65 wt %, 50 wt % to about 70 wt %, 50 wt % to about 75 wt %, 50 wt % to about 80 wt %, 50 wt % to about 85 wt %, 50 wt % to about 90 wt %, 50 wt % to about 95 wt %, 50 wt % to about 97 wt %, 50 wt % to about 99 wt %, 55 wt % to about 60 wt %, 55 wt % to about 65 wt %, 55 wt % to about 70 wt %, 55 wt % to about 75 wt %, 55 wt % to about 80 wt %, 55 wt % to about 85 wt %, 55 wt % to about 90 wt %, 55 wt % to about 95 wt %, 55 wt % to about 97 wt %, 55 wt % to about 99 wt %, 60 wt % to about 65 wt %, 60 wt % to about 70 wt %, 60 wt % to about 75 wt %, 60 wt % to about 80 wt %, 60 wt % to about 85 wt %, 60 wt % to about 90 wt %, 60 wt % to about 95 wt %, 60 wt % to about 97 wt %, 60 wt % to about 99 wt %, 65 wt % to about 70 wt %, 65 wt % to about 75 wt %, 65 wt % to about 80 wt %, 65 wt % to about 85 wt %, 65 wt % to about 90 wt %, 65 wt % to about 95 wt %, 65 wt % to about 97 wt %, 65 wt % to about 99 wt %, 70 wt % to about 75 wt %, 70 wt % to about 80 wt %, 70 wt % to about 85 wt %, 70 wt % to about 90 wt %, 70 wt % to about 95 wt %, 70 wt % to about 97 wt %, 70 wt % to about 99 wt %, 75 wt % to about 80 wt %, 75 wt % to about 85 wt %, 75 wt % to about 90 wt %, 75 wt % to about 95 wt %, 75 wt % to about 97 wt %, 75 wt % to about 99 wt %, 80 wt % to about 85 wt %, 80 wt % to about 90 wt %, 80 wt % to about 95 wt %, 80 wt % to about 97 wt %, 80 wt % to about 99 wt %, 85 wt % to about 90 wt %, 85 wt % to about 95 wt %, 85 wt % to about 97 wt %, 85 wt % to about 99 wt %, 90 wt % to about 95 wt %, 90 wt % to about 97 wt %, 90 wt % to about 99 wt %, 95 wt % to about 97 wt %, and 95 wt % to about 99 wt %.

In some embodiments, the one or more SGs in the composition comprise RA in an amount of 10-80 wt %, 10-70 wt %, 10-60 wt %, 10-50 wt %, 10-40 wt %, 10-30 wt %, 10-20 wt %, 20-80 wt %, 20-70 wt %, 20-60 wt %, 20-50 wt %, 20-40 wt %, 20-35 wt %, 20-30 wt %, 20-25 wt %, 25-80 wt %, 25-70 wt %, 25-60 wt %, 25-50 wt %, 25-40 wt %, 25-30 wt %, 30-80 wt %, 30-70 wt %, 30-60 wt %, 30-50 wt %, 30-40 wt %, 30-35 wt %, 40-80 wt %, 40-70 wt %, 40-60 wt %, 40-50 wt %, 50-80 wt %, 50-70 wt %, 50-60 wt %, 60-80 wt %, 60-70 wt % or 70-80 wt %.

In some embodiments, the one or more SGs in the composition comprise RB in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RB or is substantially devoid of RB.

In some embodiments, the one or more SGs in the composition comprise RC in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have RC or is substantially devoid of RC.

In some embodiments, the one or more SGs in the composition comprise RD in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have RD or is substantially devoid of RD.

In some embodiments, the one or more SGs in the composition comprise RE in an amount of 0-99 wt %, 0-10 wt %, 0-8 wt %, 0-5 wt %, 0-2 wt %, 0-1 wt %, 0-0.5 wt %, 0.1-10 wt %, 0.1-8 wt %, 0.1-5 wt %, 0.1-2 wt %, 0.1-1 wt %, 0.1-0.5 wt %, 0.5-10 wt %, 0.5-8 wt %, 0.5-5 wt %, 0.5-2 wt %, 0.5-1 wt %, 1-10 wt %, 1-8 wt %, 1-5 wt %, 1-2 wt %, 1.5-10 wt %, 1.5-8 wt %, 1.5-5 wt %, 2-10 wt %, 2-8 wt %, 2-5 wt %, 3-10 wt %, 3-8 wt %, 3-5 wt %, 5-10 wt %, 5-8 wt %, and combinations thereof. In certain embodiments, the composition does not have RE or is substantially devoid of RE.

In some embodiments, the one or more SGs in the composition comprise RF in an amount of 0-99 wt %, 0-20 wt %, 0-15 wt %, 0-10 wt %, 0-8 wt %, 0-5 wt %, 0-2 wt %, 0-1 wt %, 0-0.5 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-20 wt %, 0.5-15 wt %, 0.5-10 wt %, 0.5-8 wt %, 0.5-5 wt %, 0.5-2 wt %, 0.5-1 wt %, 1-20 wt %, 1-15 wt %, 1-10 wt %, 1-8 wt %, 1-5 wt %, 1-2 wt %, 1.5-20 wt %, 1.5-15 wt %, 1.5-10 wt %, 1.5-8 wt %, 1.5-5 wt %, 2-20 wt %, 2-15 wt %, 2-10 wt %, 2-8 wt %, 2-5 wt %, 3-20 wt %, 3-15 wt %, 3-10 wt %, 3-8 wt %, 3-5 wt %, 5-20 wt %, 5-15 wt %, 5-10 wt %, 5-8 wt %, 10-20 wt %, 10-15 wt %, and combinations thereof. In certain embodiments, the composition does not have RF or is substantially devoid of RF.

In some embodiments, the one or more SGs in the composition comprise RM in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have RM or is substantially devoid of RM.

In some embodiments, the one or more SGs in the composition comprise RN in an amount of 0-99 wt %, 0-10 wt %, 0-8 wt %, 0-5 wt %, 0-2 wt %, 0-1 wt %, 0-0.5 wt %, 0.1-10 wt %, 0.1-8 wt %, 0.1-5 wt %, 0.1-2 wt %, 0.1-1 wt %, 0.1-0.5 wt %, 0.5-10 wt %, 0.5-8 wt %, 0.5-5 wt %, 0.5-2 wt %, 0.5-1 wt %, 1-10 wt %, 1-8 wt %, 1-5 wt %, 1-2 wt %, 1.5-10 wt %, 1.5-8 wt %, 1.5-5 wt %, 2-10 wt %, 2-8 wt %, 2-5 wt %, 3-10 wt %, 3-8 wt %, 3-5 wt %, 5-10 wt %, 5-8 wt %, and combinations thereof. In certain embodiments, the composition does not have RN or is substantially devoid of RN.

In some embodiments, the one or more SGs in the composition comprise RO in an amount of 0-99 wt %, 0-10 wt %, 0-8 wt %, 0-5 wt %, 0-2 wt %, 0-1 wt %, 0-0.5 wt %, 0.1-10 wt %, 0.1-8 wt %, 0.1-5 wt %, 0.1-2 wt %, 0.1-1 wt %, 0.1-0.5 wt %, 0.5-10 wt %, 0.5-8 wt %, 0.5-5 wt %, 0.5-2 wt %, 0.5-1 wt %, 1-10 wt %, 1-8 wt %, 1-5 wt %, 1-2 wt %, 1.5-10 wt %, 1.5-8 wt %, 1.5-5 wt %, 2-10 wt %, 2-8 wt %, 2-5 wt %, 3-10 wt %, 3-8 wt %, 3-5 wt %, 5-10 wt %, 5-8 wt %, and combinations thereof. In certain embodiments, the composition does not have RO or is substantially devoid of RO.

In some embodiments, the one or more SGs in the composition comprise stevioside in an amount of 0-99 wt %, 5-80 wt %, 5-70%, 5-60 wt %, 5-55 wt %, 5-50 wt %, 5-45 wt %, 5-40 wt %, 5-35 wt %, 5-30 wt %, 5-25 wt %, 5-20 wt %, 5-15 wt %, 5-10 wt %, 5-8 wt %, 10-80 wt %, 10-70%, 10-60 wt %, 10-55 wt %, 10-50 wt %, 10-45 wt %, 10-40 wt %, 10-35 wt %, 10-30 wt %, 10-25 wt %, 10-20 wt %, 10-15 wt %, 15-80 wt %, 15-70%, 15-60 wt %, 15-55 wt %, 15-50 wt %, 15-45 wt %, 15-40 wt %, 15-35 wt %, 15-30 wt %, 15-25 wt %, 15-20 wt %, 20-80 wt %, 20-70%, 20-60 wt %, 20-55 wt %, 20-50 wt %, 20-45 wt %, 20-40 wt %, 20-35 wt %, 20-30 wt %, 20-25 wt %, 25-80 wt %, 25-70%, 25-60 wt %, 25-55 wt %, 25-50 wt %, 25-45 wt %, 25-40 wt %, 25-35 wt %, 25-30 wt %, 30-80 wt %, 30-70%, 30-60 wt %, 30-55 wt %, 30-50 wt %, 30-45 wt %, 30-40 wt %, 30-35 wt %, 40-80 wt %, 40-70%, 40-60 wt %, 40-55 wt %, 40-50 wt %, 40-45 wt %, 50-80 wt %, 50-70%, 50-60 wt %, 50-55 wt %, 60-80 wt %, 60-70%, and combinations thereof.

In some embodiments, the one or more SGs in the composition comprise Related SG#2 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have Related SG#2 or is substantially devoid of Related SG#2.

In some embodiments, the one or more SGs in the composition comprise Related SG#5 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have Related SG#5 or is substantially devoid of Related SG#5.

In some embodiments, the one or more SGs in the composition comprise RU2 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RU2 or is substantially devoid of RU2.

In some embodiments, the one or more SGs in the composition comprise RT in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RT or is substantially devoid of RT.

In some embodiments, the one or more SGs in the composition comprise RW in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RW or is substantially devoid of RW.

In some embodiments, the one or more SGs in the composition comprise RW2 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RW2 or is substantially devoid of RW2.

In some embodiments, the one or more SGs in the composition comprise RW3 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RW3 or is substantially devoid of RW3.

In some embodiments, the one or more SGs in the composition comprise RU in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RU or is substantially devoid of RU.

In some embodiments, the one or more SGs in the composition comprise SG-12 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have SG-12 or is substantially devoid of SG-12.

In some embodiments, the one or more SGs in the composition comprise RH in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RH or is substantially devoid of RH.

In some embodiments, the one or more SGs in the composition comprise RJ in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RJ or is substantially devoid of RJ.

In some embodiments, the one or more SGs in the composition comprise RK in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RK or is substantially devoid of RK.

In some embodiments, the one or more SGs in the composition comprise RK2 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RK2 or is substantially devoid of RK2.

In some embodiments, the one or more SGs in the composition comprise SG-Unk4 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have SG-Unk4 or is substantially devoid of SG-Unk4.

In some embodiments, the one or more SGs in the composition comprise SG-Unk5 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have SG-Unk5 or is substantially devoid of SG-Unk5.

In some embodiments, the one or more SGs in the composition comprise RI in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RI or is substantially devoid of RI.

In some embodiments, the one or more SGs in the composition comprise RL in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RL or is substantially devoid of RL.

In some embodiments, the one or more SGs in the composition comprise RI3 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RI3 or is substantially devoid of RI3.

In some embodiments, the one or more SGs in the composition comprise SG-Unk6 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have SG-Unk6 or is substantially devoid of SG-Unk6.

In some embodiments, the one or more SGs in the composition comprise RQ in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RQ or is substantially devoid of RQ.

In some embodiments, the one or more SGs in the composition comprise RQ2 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RQ2 or is substantially devoid of RQ2.

In some embodiments, the one or more SGs in the composition comprise RQ3 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RQ3 or is substantially devoid of RQ3.

In some embodiments, the one or more SGs in the composition comprise RT1 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RT1 or is substantially devoid of RT1.

In some embodiments, the one or more SGs in the composition comprise Related SG#4 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have Related SG#4 or is substantially devoid of Related SG#4.

In some embodiments, the one or more SGs in the composition comprise RV2 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RV2 or is substantially devoid of RV2.

In some embodiments, the one or more SGs in the composition comprise RV in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RV or is substantially devoid of RV.

In some embodiments, the one or more SGs in the composition comprise RY in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RY or is substantially devoid of RY.

In some embodiments, the one or more SGs in the composition comprise 15α-OH RM in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have 15α-OH RM or is substantially devoid of 15α-OH RM.

In some embodiments, the one or more SGs in the composition comprise RO2 in an amount of 0-99 wt %, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, 15-30 wt %, 15-25 wt %, 15-20 wt %, 20-30 wt %, 20-25 wt % or 25-30 wt % and combinations thereof. In certain embodiments, the composition does not have RO2 or is substantially devoid of RO2.

In some embodiments, the SG composition comprises RA, RB, RC, RD, RE, RF, rubusoside, steviolbioside, stevioside and ducoside A, wherein the total SG content of these 10 SGs is about 65 wt % or greater, 70 wt % or greater, 75 wt % or greater, 80 wt % or greater, 85 wt % or greater, 90 wt % or greater, 95 wt % or greater, 99 wt % or greater, or any range encompassing any of these integer values.

In some embodiments, the SG composition comprises RA, RB, RC, RD, RE, RF, rubusosid, STB, ST and DA, wherein the total SG content of these 10 SGs is 50 wt % or greater, 55 wt % or greater, 60 wt % or greater, 65 wt % or greater, 70 wt % or greater, 75 wt % or greater, 80 wt % or greater, 85 wt % or greater, 90 wt % or greater, or 95 wt % or greater, of the total SG composition, wherein RA accounts for 20-35 wt % of the total SG content, wherein RB accounts for 1-4 wt % of the total SG content, wherein RC accounts for 5-15 wt % of the total SG content, wherein RD accounts for 1-10 wt % of the total SG content, wherein RE accounts for 0.1-2 wt % of the total SG content, wherein RF accounts for 1-4 wt % of the total SG content, wherein rubusoside accounts for 0.1-2 wt % of the total SG content, wherein steviolbioside accounts for 1-5 wt % of the total SG content, wherein stevioside accounts for 14-40 wt % of the total SG content, and wherein DA accounts for 0.1-2 wt % of the total SG content. In some embodiments, the total SG content of these 10 SGs is 50-90 wt %, 55-85 wt %, 60-80 wt % or 65-75 wt % of the total SG composition.

In some embodiments, the SG composition comprises RA, RC, RD, RF, RM, RN, rubusoside, stevioside and ducoside A, wherein the total SG content of these 9 SGs is 50 wt % or greater, 55 wt % or greater, 60 wt % or greater, 65 wt % or greater, 70 wt % or greater, 75 wt % or greater, 80 wt % or greater, 85 wt % or greater, 90 wt % or greater, or 95 wt % or greater, of the total SG composition, wherein RA accounts for 20-35 wt % of the total SG content, wherein RB accounts for 0-4 wt % of the total SG content, wherein RC accounts for 5-15 wt % of the total SG content, wherein RD accounts for 1-10 wt % of the total SG content, wherein RE accounts for 0.1-2 wt % of the total SG content, wherein RF accounts for 1-4 wt % of the total SG content, wherein rubusoside accounts for 0.1-2 wt % of the total SG content, wherein steviolbioside accounts for 1-5 wt % of the total SG content, wherein stevioside accounts for 14-40 wt % of the total SG content, and wherein Dulcoside A accounts for 0.1-2 wt % of the total SG content. In some embodiments, the total SG content of these 9 SGs is 35-90 wt %, 40-85 wt %, 45-80 wt %, 50-75 wt %, 50-70 wt %, 55-75 wt % or 55-70% of the total SG composition.

In some embodiments, the SG composition comprises RA, RB, RC, RD, RE, RF, rubusoside, steviolbioside, stevioside and ducoside A, wherein the total SG content of these 10 SGs is 70 wt % or greater by weight, wherein RA accounts for 20-35 wt % of the total SG content, wherein RB accounts for 0-4 wt % of the total SG content, wherein RC accounts for 5-15 wt % of the total SG content, wherein RD accounts for 1-10 wt % of the total SG content, wherein RE accounts for 0.1-2 wt % of the total SG content, wherein RF accounts for 1-4 wt % of the total SG content, wherein rubusoside accounts for 0.1-2 wt % of the total SG content, wherein steviolbioside accounts for 1-5 wt % of the total SG content, wherein stevioside accounts for 14-40 wt % of the total SG content, and wherein Dulcoside A accounts for 0.1-2 wt % of the total SG content.

In certain embodiments, the SG composition comprises RD and RM, wherein RD and RM account for less than 70% of the total SG content by weight, less than 65% of the total SG content by weight, less than 60% of the total SG content by weight, less than 50% of the total SG content by weight, less than 45% of the total SG content by weight, less than 40% of the total SG content by weight, less than 35% of the total SG content by weight, less than 30% of the total SG content by weight, less than 25% of the total SG content by weight, less than 20% of the total SG content by weight, less than 15% of the total SG content by weight, less than 10% of the total SG content by weight, or less than 5% of the total SG content by weight.

In certain embodiments, the SG composition comprises RA, RB, RC, RD, RE, RF, RebF1, RG, RebG1, RH, RI, RebI3, RJ, RK, RL, RM, RN, RO, RR, RebR1, RS, RU, RV, RebV2, RY, rubusoside, steviolbioside, stevioside, stevioside B, dulcoside A, and dulcoside B.

In some embodiments, the SG composition of the present disclosure comprises one or more SG having a molecular weight equal to, or greater than, 803 daltons.

In some embodiments, the SG composition comprises one or more SG having a molecular weight equal to, or great than 803 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=803 or is substantially devoid of it.

In some embodiments, the SG composition of the present disclosure comprises one or more SG having a molecular weight equal to, or greater than 935 daltons.

In some embodiments, the SG composition comprises one or more SG having a molecular weight equal to, or great than 935 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=935 or is substantially devoid of it.

In some embodiments, the SG composition of the present disclosure comprises one or more SG having a molecular weight equal to, or greater than 949 daltons.

In some embodiments, the SG composition comprises one or more SG having a molecular weight equal to, or great than 949 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=949 or is substantially devoid of it.

In some embodiments, the SG composition of the present disclosure comprises one or more SG having a molecular weight equal to, or greater than 965 daltons.

In some embodiments, the SG composition comprises one or more SG having a molecular weight equal to, or great than 965 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=965 or is substantially devoid of it.

In some embodiments, the SG composition of the present disclosure comprises one or more SG having a molecular weight equal to, or greater than 981 daltons.

In some embodiments, the SG composition comprises one or more SG having a molecular weight equal to, or great than 981 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=981 or is substantially devoid of it.

In some embodiments, the SG composition of the present disclosure comprises one or more SG having a molecular weight equal to, or greater than 1097 daltons.

In some embodiments, the SG composition comprises one or more SG having a molecular weight equal to, or great than 1097 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=1097 or is substantially devoid of it.

In some embodiments, the SG composition of the present disclosure comprises one or more SG having a molecular weight equal to, or greater than 1111 daltons.

In some embodiments, the SG composition comprises one or more SG having a molecular weight equal to, or great than 1111 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=1111 or is substantially devoid of it.

In some embodiments, the SG composition of the present disclosure comprises one or more SG having a molecular weight equal to, or greater than 1127 daltons.

In some embodiments, the SG composition comprises one or more SG having a molecular weight equal to, or great than 1127 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=1127 or is substantially devoid of it.

In some embodiments, the SG composition of the present disclosure comprises one or more SG having a molecular weight equal to, or greater than 1259 daltons.

In some embodiments, the SG composition comprises one or more SG having a molecular weight equal to, or great than 1259 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=1259 or is substantially devoid of it.

In some embodiments, the SG composition of the present disclosure comprises one or more SG having a molecular weight equal to, or greater than 1273 daltons.

In some embodiments, the SG composition comprises one or more SG having a molecular weight equal to, or great than 1273 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=1273 or is substantially devoid of it.

In some embodiments, the SG composition of the present disclosure comprises one or more SG having a molecular weight equal to, or greater than 1289 daltons.

In some embodiments, the SG composition comprises one or more SG having a molecular weight equal to, or great than 1289 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=1289 or is substantially devoid of it.

In some embodiments, the SG composition of the present disclosure comprises one or more SG having a molecular weight equal to, or greater than 1305 daltons.

In some embodiments, the SG composition comprises one or more SG having a molecular weight equal to, or great than 1305 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=1305 or is substantially devoid of it.

In some embodiments, the SG composition of the present disclosure comprises one or more SG having a molecular weight equal to, or greater than 1435 daltons.

In some embodiments, the SG composition comprises one or more SG having a molecular weight equal to, or great than 1435 daltons in amount of 0-99%, 0-30 wt %, 0-25 wt %, 0-20 wt %, 0-15 wt %, 0-10 wt %, 0-8 wt %, 0-5 wt %, 0-2 wt %, 0-1 wt %, 0-0.5 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1 wt %, 0.1-0.5 wt %, 0.5-30 wt %, 0.5-25 wt %, 0.5-20 wt %, 0.5-15 wt %, 0.5-10 wt %, 0.5-8 wt %, 0.5-5 wt %, 0.5-2 wt %, 0.5-1 wt %, 1-30 wt %, 1-25 wt %, 1-20 wt %, 1-15 wt %, 1-10 wt %, 1-8 wt %, 1-5 wt %, 1-2 wt %, 1.5-30 wt %, 1.5-25 wt %, 1.5-20 wt %, 1.5-15 wt %, 1.5-10 wt %, 1.5-8 wt %, 1.5-5 wt %, 2-30 wt %, 2-25 wt %, 2-20 wt %, 2-15 wt %, 2-10 wt %, 2-8 wt %, 2-5 wt %, 3-30 wt %, 3-25 wt %, 3-20 wt %, 3-15 wt %, 3-10 wt %, 3-8 wt %, 3-5 wt %, 5-30 wt %, 5-25 wt %, 5-20 wt %, 5-15 wt %, 5-10 wt %, 5-8 wt %, 10-30 wt %, 10-25 wt %, 10-20 wt %, 10-15 wt %, and combinations thereof. In certain embodiments, the composition does not have one or more SG with MW>=1435 or is substantially devoid of it.

Even though the SGs or SG compositions are directed to having long term solubility at ambient temperature, the current embodiments can cover temperatures that range from 0° C. to 25° C. Even though the range of stability of the current embodiments is directed to stability between 0° C. to 25° C., good stability outside this range can also be expected especially at temperatures above this range.

Generally, an individual stevia glycoside has poor solubility. In one embodiment, the solubility of a first SG is improved by adding a second SG, solubilizing the SGs as a composition at elevated temperature, and then lowering the temperature to ambient temperature in an aqueous solution.

In yet another embodiment, the solubility of two SGs in a SG starter composition can be further improved, by adding at least a third SG, solubilizing the SGs at elevated temperature and then lowering the temperature to ambient temperature in an aqueous solution.

One aspect of the present embodiments provides a treated SG or SG composition with improved solubility in an aqueous solution in comparison with an untreated SG or SG composition comprising rebaudioside A, B, and D individually, and mixtures thereof. For example, the solubility of the treated SG or SG composition in an aqueous solution is about ≥1 g/100 g water, preferably about ≥3 g/100 g water, more preferably about ≥5 g/100 g water, more preferably about ≥10 g/100 g water, more preferably about ≥15 g/100 g water, more preferably about ≥20 g/100 g water, more preferably about ≥25 g/100 g water, more preferably about ≥30 g/100 g water, more preferably about ≥35 g/100 g water, more preferably about ≥40 g/100 g water 1, more preferably about ≥45 g/100 g water, more preferably about ≥50 g/100 g water, more preferably about ≥55 g/100 g water, and most preferably ≥60 g/100 g water, and all ranges between 1 g/100 g water and 60 g/100 g water, for example, from about 1 g/100 g water to about 5 g/100 g water, from about 1 g/100 g water to about 10 g/100 g water, from about 2 g/100 g water to about 5 g/100 g water, from about 2 g/100 g water to about 10 g/100 g water, from about 3 g/100 g water to about 10 g/100 g water, from about 3 g/100 g water to about 15 g/100 g water, from about 5 g/100 g water to about 10 g/100 g water, from about 5 g/100 g water to about 15 g/100 g water, from about 5 g/100 g water to about 20 g/100 g water, from about 7 g/100 g water to about 10 g/100 g water, from about 7 g/100 g water to about 15 g/100 g water, from about 7 g/100 g water to about 20 g/100 g water, from about 10 g/100 g water to about 15 g/100 g water, from about 10 g/100 g water to about 20 g/100 g from about 10 g/100 g water to about 25 g/100 g water, from about 10 g/100 g water to about 30 g/100 g from about 12 g/100 g water to about 20 g/100 g from about 12 g/100 g water to about 25 g/100 g water, from about 12 g/100 g water to about 30 g/100 g water, from about 15 g/100 g water to about 20 g/100 g water, from about 15 g/100 g water to about 25 g/100 g water, from about 17 g/100 g water to about 20 g/100 g water, from about 17 g/100 g water to about 25 g/100 g, from about 17 g/100 g water to about 30 g/100 g water, from about 20 g/100 g water to about 25 g/100 g water, from about 20 g/100 g water to about 30 g/100 g water, from about 20 g/100 g water to about 40 g/100 g water, from about 20 g/100 g water to about 50 g/100 g water, from about 25 g/100 g water to about 30 g/100 g water, from about 25 g/100 g water to about 40 g/100 g water, from about 25 g/100 g water to about 50 g/100 g water at ambient temperature.

In certain embodiments, the SG or the SG compositions of the present embodiments are described with reference to their stability in a water or water/alcohol solution. As described herein, stability of the SG or SG compositions of the present embodiments refers to the solubility of the material without precipitation or crystallization or very minimal precipitation or crystallization measured in the range of between 0° C. and 25° C. This lower limit of the temperature range is not to be limiting and should be understood that the SG or the SG composition, once dissolved, can remain solubilized above 25° C.

The SG or the SGs in the SG composition can each individually be in an amorphous form, each individually in a polymorphic from, or mixtures thereof.

Preferably, the SG or the SGs in the SG composition according to one embodiment is in an amorphous form, but it may also be in a polymorph form.

In a further aspect, one embodiment provides a concentrated aqueous sweetener solution comprising treated SG or SG composition, wherein the total solubility of the SGs is improved in comparison with the maximum total content of untreated SGs wt/wt in water or water/alcohol under identical conditions. For example, the total content of the SGs in a concentrated aqueous sweetener solution comprising a SG or a SG composition according to the present application is ≥1% wt/wt in water, preferably ≥5% wt/wt in water, more preferably ≥10% wt/wt in water, more preferably ≥15% wt/wt in water, more preferably ≥20% wt/wt in water, more preferably ≥25% wt/wt in water, more preferably ≥30% wt/wt in water, more preferably ≥35% wt/wt in water, more preferably ≥40% wt/wt in water, more preferably ≥45% wt/wt in water, and preferably ≥50% wt/wt in water, and most preferably about 60% wt/wt in water, and all ranges between 1% wt/wt in water and 100% wt/wt in water, for example from about 1% wt/wt in water to about 99% wt/wt in water, from about 5% wt/wt in water to about 95% wt/wt in water, from about 10% wt/wt in water to about 90% wt/wt in water, from about 15% wt/wt in water to about 85% wt/wt in water, from about 20% wt/wt in water to about 80% wt/wt in water, from about 25% wt/wt in water to about 80% wt/wt in water, from about 30% wt/wt in water to about 80% wt/wt in water, from about 35% wt/wt in water to about 80% wt/wt in water, from about 40% wt/wt in water to about 80% wt/wt in water, from about 45% wt/wt in water to about 75% wt/wt in water, from about 50% wt/wt in water to about 75% wt/wt in water, from about 55% wt/wt in water to about 75% wt/wt in water, from about 55% wt/wt in water to about 70% wt/wt in water, and from about 55% wt/wt in water to about 65% wt/wt in water.

In one aspect, in an exemplary composition having two different SGs, the components can have ratios of from 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51 and 50:50, and all ranges therebetween wherein the ratios are from 1:99 and vice versa, e.g., a ratio of from 1:99 to 50:50, from 30:70 to 42:58, etc.

In another aspect, in an exemplary composition having three different SGs, the components can have ratios of from 1:1:98, 1:2:97, 1:3:96, 1:4:95, 1:5:94, 1:6:93, 1:7:92, 1:8:91, 1:9:90, 1:10:89, 1:11:88, 1:12:87, 1:13:86, 1:14:85, 1:15:84, 1:16:83, 1:17:82, 1:18:81, 1:19:80, 1:20:79, 1:21:78, 1:22:77, 1:23:76, 1:24:75, 1:25:74, 1:26:73, 1:27:72, 1:28:71, 1:29:70, 1:30:69, 1:31:68, 1:32:67, 2:3:95, 2:4:94, 2:5:93, 2:6:92, 2:7:91, 2:8:90, 2:9:89, 2:10:88, 2:11:87, 2:12:86, 2:13:85, 2:14:84, 2:15:83, 2:16:82, 2:17:81, 2:18:80, 2:19:79, 2:20:78, 2:21:77, 2:22:76, 2:23:75, 2:24:74, 2:25:73, 2:26:72, 2:27:71, 2:28:70, 2:29:69, 2:30:68, 2:31:67, 2:32:66, 2:3:95, 3:3:94, 3:4:93, 3:5:92, 3:6:91, 3:7:90, 3:8:89, 3:9:88, 3:10:87, 3:11:86, 3:12:85, 3:13:84, 3:14:83, 3:15:82, 3:16:81, 2:17:80, 3:18:79, 3:19:78, 3:20:77, 3:21:76, 3:22:75, 3:23:74, 3:24:73, 3:25:72, 3:26:71, 3:27:70, 3:28:69, 3:29:68, 3:30:67, 3:31:66, 3:32:65, 4:4:92, 4:5:91, 4:6:90, 4:7:89, 4:8:88, 4:9:87, 4:10:86, 4:11:85, 4:12:84, 4:13:83, 4:14:82, 4:15:81, 4:16:80, 4:17:79, 4:18:78, 4:19:77, 4:20:76, 4:21:75, 4:22:74, 4:23:73, 4:24:72, 4:25:71, 4:26:70, 4:27:69, 4:28:68, 4:29:67, 4:30:66, 4:31:65, 4:32:64, 5:5:90, 5:6:89, 5:7:88, 5:8:87, 5:9:86, 5:10:85, 5:11:84, 5:12:83, 5:13:82, 5:14:81, 5:15:80, 5:16:79, 5:17:78, 5:18:77, 5:19:76, 5:20:75, 5:21:74, 5:22:73, 5:23:72, 5:24:71, 5:25:70, 5:26:69, 5:27:68, 5:28:67, 5:29:66, 5:30:65, 5:31:64, 5:32:63, 6:6:88, 6:7:87, 6:8:86, 6:9:85, 6:10:84, 6:11:83, 6:12:82, 6:13:81, 6:14:80, 6:15:79, 6:16:78, 6:17:77, 6:18:76, 6:19:75, 6:20:74, 6:21:73, 6:22:72, 6:23:71, 6:24:70, 6:25:69, 6:26:68, 6:27:67, 6:28:66, 6:29:65, 6:30:64, 6:31:63, 6:32:62, 7:7:86, 7:8:85, 7:9:84, 7:10:83, 7:11:82, 7:12:81, 7:13:80, 7:14:79, 7:15:78, 7:16:77, 7:17:76, 7:18:75, 7:19:74, 7:20:73, 7:21:72, 7:22:71, 7:23:70, 7:24:69, 7:25:68, 7:26:67, 7:27:66, 7:28:65, 7:29:64, 7:30:63, 7:31:62, 7:32:61, 8:8:84, 8:9:83, 8:10:82, 8:11:81, 8:12:80, 8:13:79, 8:14:78, 8:15:77, 8:16:76, 8:17:75, 8:18:74, 8:19:73, 8:20:72, 8:21:71, 8:22:70, 8:23:69, 8:24:68, 8:25:67, 8:26:66, 8:27:65, 8:28:64, 8:29:63, 8:30:62, 8:31:61, 8:32:60, 9:9:82, 9:10:81, 9:11:80, 9:12:79, 9:13:78, 9:14:77, 9:15:76, 9:16:75, 9:17:74, 9:18:73, 9:19:72, 9:20:71, 9:21:70, 9:22:69, 9:23:68, 9:24:67, 9:25:66, 9:26:65, 9:27:64, 9:28:63, 9:29:62, 9:30:61, 9:31:60, 9:32:59, 10:10:80, 10:11:79, 10:12:78, 10:13:77, 10:14:76, 10:15:75, 10:16:74, 10:17:73, 10:18:72, 10:19:71, 10:20:70, 10:21:69, 10:22:68, 10:23:67, 10:24:66, 10:25:65, 10:26:64, 10:27:63, 10:28:62, 10:29:61, 10:30:60, 10:31:59, 10:32:58, 11:11:78, 11:12:77, 11:13:76, 11:14:75, 11:15:74, 11:16:73, 11:17:72, 11:18:71, 11:19:70, 11:20:69, 11:21:68, 11:22:67, 11:23:66, 11:24:65, 11:25:64, 11:26:63, 11:27:62, 11:28:61, 11:29:60, 11:30:59, 11:31:58, 11:32:57, 12:12:76, 12:13:75, 12:14:74, 12:15:73, 12:16:72, 12:17:71, 12:18:70, 12:19:69, 12:20:68, 12:21:67, 12:22:66, 12:23:65, 12:24:64, 12:25:63, 12:26:62, 12:27:61, 12:28:60, 12:29:59, 12:30:58, 12:31:57, 12:32:56, 13:13:74, 13:14:73, 13:15:72, 13:16:71, 13:17:70, 13:18:69, 13:19:68, 13:20:67, 13:21:66, 13:22:65, 13:23:64, 13:24:63, 13:25:62, 13:26:61, 13:27:60, 13:28:59, 13:29:58, 13:30:57, 13:31:56, 13:32:55, 14:14:72, 14:15:71, 14:16:70, 14:17:69, 14:18:68, 14:19:67, 14:20:66, 14:21:65, 14:22:64, 14:23:63, 14:24:62, 14:25:61, 14:26:60, 14:27:59, 14:28:58, 14:29:57, 14:30:56, 14:31:55, 14:32:54, 15:15:70, 15:16:69, 15:17:68, 15:18:67, 15:19:66, 15:20:65, 15:21:64, 15:22:63, 15:23:62, 15:24:61, 15:25:60, 15:26:59, 15:27:58, 17:28:57, 15:29:56, 15:30:55, 15:31:54, 15:32:53, 16:16:68, 16:17:67, 16:18:66, 16:19:65, 16:20:64, 16:21:63, 16:22:62, 16:23:61, 16:24:60, 16:25:59, 16:26:58, 16:27:57, 16:28:56, 16:29:55, 16:30:54, 16:31:53, 16:32:52, 17:17:66, 17:18:65, 17:19:64, 17:20:63, 17:21:62, 17:22:61, 17:23:60, 17:24:59, 17:25:58, 17:26:57, 17:27:56, 17:28:55, 17:29:54, 17:30:53, 17:31:52, 17:32:51, 18:18:64, 18:19:63, 18:20:62, 18:21:61, 18:22:60, 18:23:59, 18:24:58, 18:25:57, 18:26:56, 18:27:55, 18:28:54, 18:29:53, 18:30:52, 18:31:51, 18:32:50, 19:19:62, 19:20:61, 19:21:60, 19:22:59, 19:23:58, 19:24:57, 19:25:56, 19:26:55, 19:27:54, 19:28:53, 19:29:52, 19:30:51, 19:31:50, 19:32:49, 20:20:60, 20:21:59, 20:22:58, 20:23:57, 20:24:56, 20:25:55, 20:26:54, 20:27:53, 20:28:52, 20:29:51, 20:30:50, 20:31:49, 20:32:48, 21:21:58, 21:22:57, 21:23:56, 21:24:55, 21:25:54, 21:26:53, 21:27:52, 21:28:51, 21:29:50, 21:30:49, 21:31:48, 21:32:47, 22:22:56, 22:23:55, 22:24:54, 22:25:53, 22:26:52, 22:27:51, 22:28:50, 22:29:49, 22:30:48, 22:31:47, 22:32:46, 23:23:54, 23:24:53, 23:25:52, 23:26:51, 23:27:50, 23:28:49, 23:29:48, 23:30:47, 23:31:46, 23:32:45, 24:24:52, 24:25:51, 24:26:50, 24:27:49, 24:28:48, 24:29:47, 24:30:46, 24:31:45, 24:32:44, 25:25:50, 25:26:49, 25:27:48, 25:28:47, 25:29:46, 25:30:45, 25:31:44, 25:32:43, 26:26:48, 26:27:47, 26:28:46, 26:29:45, 26:30:44, 26:31:43, 26:32:42, 27:27:46, 27:28:45, 27:29:44, 27:30:43, 27:31:42, 27:32:41, 28:28:44, 28:29:43, 28:30:42, 28:31:41, 28:32:40, 29:29:42, 29:30:41, 29:31:40, 29:32:39, 30:30:40, 30:31:39, 30:32:38, 31:31:38, 31:32:37, 32:32:36, 32:33:35, and 33.3:33.3:33.3, and all ranges therebetween wherein the ratios are from 1:1:98 and vice versa, e.g., a ratio of from 1:1:98 to 33.3:33.3:33.3, from 10:30:70 to 15:40:45, etc.

It is noted that the present disclosure is not limited to compositions having only two or three different SG components therein, and that the exemplary ratios are non-limiting. Rather, the same formula can be followed for establishing ratios of as many different SG components as are contained within a given composition. As a further example, in a composition that comprises 20 different SG components, the components can have ratios of from 1:1:1:1:1:1:1:1:1:1:1:1:1:1:1:1:1:1:1:81 to 5:5:5:5:5:5:5:5:5:5:5:5:5:5:5:5:5:5:5:5, and all possible combinations of ratios therebetween. In some embodiments, a composition of the present disclosure may have up to and including a combination of all compounds in Table A.

C. Non-SG Sweeteners

In another aspect, a sweetener composition of the present application includes one or more treated SGs with improved solubility in an aqueous solution in comparison to untreated SGs comprising either of rebaudiosides A, B, D individually or a mixture thereof, under identical conditions, and optionally, containing other sweeteners and/or additional additives as further described below.

The one or more non-SG sweeteners in the SG composition of the present application include, but are not limited to, natural sweeteners, natural high potency sweeteners, synthetic sweeteners, or a combination thereof.

As used herein, a “natural sweetener” refers to any sweetener found naturally in nature, excluding SGs. The phrase “natural high potency sweetener” refers to any sweetener found naturally in nature having a sweetness potency greater than sucrose, fructose, or glucose, yet has less calories. The phrase “synthetic sweetener” refers to any composition which is not found naturally in nature having a sweetness potency greater than sucrose, fructose, or glucose, yet has less calories. As used herein, the terms “natural sweeteners,” “natural high potency sweeteners” and “synthetic sweeteners” do not include SGs.

In certain embodiments, the non-SG sweetener includes at least one carbohydrate sweetener. Exemplary carbohydrate sweeteners are selected from, but not limited to, the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

Other suitable non-SG sweeteners include mogroside IV, mogroside V, Luo han guo, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I, sugar alcohols, such as erythritol, sucralose, acesulfame acid and salts thereof, such as acesulfame-K and potassium acesulfame; L-α-aspartyl-L-phenylalanine methylester (Aspartame), N—[N-[3-(3-hydroxy-4-methoxyphenyl) propyl]-α-aspartyl]-L-phenylalanine (Advantame), N—[N-[3-(3-hydroxy-4-methoxyphenyl) propyl]-α-aspartyl]-L-phenylalanine 1-methyl ester (ANS9801), alitame, saccharin and salts thereof, neohesperidin dihydrochalcone, cyclamate, cyclamic acid and salts thereof, neotame, trehalose, raffinose, cellobiose, tagatose, DOLCIA PRIMA™, allulose, inulin, and combinations thereof.

The non-SG sweetener may be a caloric sweetener or mixture of caloric sweeteners. Caloric sweeteners include sucrose, fructose, glucose, high fructose corn/starch syrup, a beet sugar, a cane sugar, and combinations thereof.

In certain embodiments, the non-SG sweetener is a rare sugar selected from sorbose, lyxose, ribulose, xylose, xylulose, D-allose, L-ribose, D-tagatose, L-glucose, L-fucose, L-arabinose, turanose and combinations thereof. The rare sugars can be present in the sweetener compositions in an amount from about 0.5 wt % to about 10.0 wt %, such as, for example, about 0.5 wt % to about 2.5 wt %, about 0.5 wt % to about 2.0 wt %, about 0.5 wt % to about 1.5 wt %, about 0.5 wt % to about 1.0 wt %, about 1.0 wt % to about 3.0 wt %, about 1.0 wt % to about 2.5 wt %, about 1.0 wt % to about 2.0 wt %, about 1.0 wt % to about 1.5 wt %, about 2.0 wt % to about 3.0 wt %, about 2.0 wt % to about 2.5 wt %, about 2.0 wt % to about 4.0 wt %, about 4.0 wt % to about 6.0 wt %, about 6.0 wt % to about 8.0 wt %, or about 8.0 wt % to about 10.0 wt %.

The one or more non-SG sweeteners of the SG composition of the present application can make up anywhere from about 0.1 wt. % of the SG composition to about 50 wt. % of the SG composition, specifically about 0.01 wt. %, about 0.02 wt %, about 0.05 wt %, about 0.07 wt %, about 0.1 wt %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, about 66 wt. %, about 67 wt. %, about 68 wt. %, about 69 wt. %, about 70 wt. %, about 71 wt. %, about 72 wt. %, about 73 wt. %, about 74 wt. %, about 75 wt. %, about 76 wt. %, about 77 wt. %, about 78 wt. %, about 79 wt. %, about 80 wt. %, and all ranges therebetween, including for example from about 0.01 wt % to about 20 wt %, about 0.03 wt % to about 20 wt %, about 0.05 wt % to about 20 wt %, about 0.07 wt % to about 20 wt %, about 0.1 wt % to about 20 wt %, about 0.3 wt % to about 20 wt %, about 0.5 wt % to about 20 wt %, about 0.7 wt % to about 20 wt %, about 1 wt % to about 20 wt %, about 3 wt % to about 20 wt %, about 5 wt % to about 20 wt %, about 7 wt % to about 20 wt %, about 10 wt % to about 20 wt %, about 15 wt % to about 20 wt %, about 0.01 wt % to about 10 wt %, about 0.03 wt % to about 10 wt %, about 0.05 wt % to about 10 wt %, about 0.07 wt % to about 10 wt %, about 0.1 wt % to about 10 wt %, about 0.3 wt % to about 10 wt %, about 0.5 wt % to about 10 wt %, about 0.7 wt % to about 10 wt %, about 1 wt % to about 10 wt %, about 3 wt % to about 10 wt %, about 5 wt % to about 10 wt %, about 7 wt % to about 10 wt %, about 0.01 wt % to about 5 wt %, about 0.03 wt % to about 5 wt %, about 0.05 wt % to about 5 wt %, about 0.07 wt % to about 5 wt %, about 0.1 wt % to about 5 wt %, about 0.3 wt % to about 5 wt %, about 0.5 wt % to about 5 wt %, about 0.7 wt % to about 5 wt %, about 1 wt % to about 5 wt %, about 3 wt % to about 5 wt %, about 0.01 wt % to about 2.5 wt %, about 0.03 wt % to about 2.5 wt %, about 0.05 wt % to about 2.5 wt %, about 0.07 wt % to about 2.5 wt %, about 0.1 wt % to about 2.5 wt %, about 0.3 wt % to about 2.5 wt %, about 0.5 wt % to about 2.5 wt %, about 0.7 wt % to about 2.5 wt %, about 1 wt % to about 2.5 wt %, about 5 wt. % to about 30 wt. %, from about 10 wt. % to about 30 wt. %, from about 20 wt. % to about 40 wt. %, or from about 30 wt. % to about 50 wt. %.

D. Additional Additives

In other embodiments, the SG composition of the present application further includes one or more additional additives selected from the group consisting of flavoring agents, salts, minerals, organic acids and inorganic acids, polyols, nucleotides, bitter compounds, astringent compounds, proteins or protein hydrolysates, surfactants, gums and waxes, antioxidants, polymers, fatty acids, vitamins, preservatives, hydration agents and combinations thereof, as further described below.

i. Flavoring Agents

As used herein, a “flavoring agent” or “flavorant” herein refers to a compound or an ingestibly acceptable salt or solvate thereof that induces a flavor or taste in an animal or a human. The flavoring agent can be natural, semi-synthetic, or synthetic. Suitable flavorants and flavoring ingredient additives for use in the SG compositions of the present application include, but are not limited to, vanillin, vanilla extract, mango extract, cinnamon, citrus, coconut, ginger, viridiflorol, almond, bay, thyme, cedar leaf, nutmeg, allspice, sage, mace, menthol (including menthol without mint), an essential oil, such as an oil derived from a plant or a fruit, such as peppermint oil, spearmint oil, other mint oils, clove oil, cinnamon oil, oil of wintergreen, or an oil of almonds; a plant extract, fruit extract or fruit essence from grape skin extract, grape seed extract, apple, banana, watermelon, pear, peach, grape, strawberry, raspberry, cherry, plum, pineapple, apricot, a flavoring agent comprising a citrus flavor, such as an extract, essence, or oil of lemon, lime, orange, tangerine, grapefruit, citron, kumquat, and combinations thereof.

Non-limiting examples of proprietary flavorants include Dohler™ Natural Flavoring Sweetness Enhancer K14323 (Dohler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, N.J., U.S.A.), and Sucramask™ (Creative Research Management, Stockton, Calif., U.S.A.).

In some embodiments, the flavoring agent is present in the SG composition of the present application in a concentration from about 0.1 ppm to about 4,000 ppm.

ii. Salts

One or more salts may be included in the SG composition of the present application. The salts may be organic salts or inorganic salts. As used herein, the term “salt” refers to salts that retain the desired chemical activity of the SG compositions of the present application and are safe for human or animal consumption in a generally acceptable range.

In some embodiments, the one or more salts are salts formed with metal cations such as calcium, bismuth, barium, magnesium, aluminum, copper, cobalt, nickel, cadmium, sodium, potassium, and the like, or with a cation formed from ammonia, N,N-dibenzylethylenediamine, D-glucosamine, ethanolamine, diethanolamine, triethanolamine, N-methylglucamine tetraethylammonium, or ethylenediamine.

In some embodiments, the one or more salts are formed with inorganic acids, such as hydrochloric acid, hydrobromic acid, sulfuric acid, nitric acid, phosphoric acid, and the like; or formed with organic acids, such as acetic acid, propionic acid, hexanoic acid, cyclopentanepropionic acid, glycolic acid, pyruvic acid, lactic acid, malonic acid, succinic acid, malic acid, maleic acid, fumaric acid, tartaric acid, citric acid, benzoic acid, 3-(4-hydroxybenzoyl)benzoic acid, cinnamic acid, mandelic acid, methanesulfonic acid, ethanesulfonic acid, 1,2-ethane-disulfonic acid, 2-hydroxyethanesulfonic acid, benzenesulfonic acid, 4-chlorobenzenesulfonic acid, 2-naphthalenesulfonic acid, 4-toluenesulfonic acid, camphorsulfonic acid, 4-methylbicyclo[2.2.2]-oct-2-ene-1-carboxylic acid, glucoheptonic acid, 3-phenylpropionic acid, trimethylacetic acid, tertiary butylacetic acid, lauryl sulfuric acid, gluconic acid, glutamic acid, hydroxynaphthoic acid, salicylic acid, stearic acid and muconic acid.

In particular embodiments, inorganic salts include, but are not limited to, sodium chloride, sodium carbonate, sodium bicarbonate, sodium acetate, sodium sulfide, sodium sulfate, sodium phosphate, potassium chloride, potassium citrate, potassium carbonate, potassium bicarbonate, potassium acetate, europium chloride (EuCl3), gadolinium chloride (GdCl3), terbium chloride (TbCl3), magnesium sulfate, alum, magnesium chloride, mono-, di-, tri-basic sodium or potassium salts of phosphoric acid (e.g., inorganic phosphates), salts of hydrochloric acid (e.g., inorganic chlorides), sodium carbonate, sodium bisulfate, and sodium bicarbonate. Suitable organic salts include, but are not limited to, choline chloride, alginic acid sodium salt (sodium alginate), glucoheptonic acid sodium salt, gluconic acid sodium salt (sodium gluconate), gluconic acid potassium salt (potassium gluconate), guanidine HCl, glucosamine HCl, amiloride HCl, monosodium glutamate (MSG), adenosine monophosphate salt, magnesium gluconate, potassium tartrate (monohydrate), and sodium tartrate (dihydrate).

In certain embodiments, the salt is a metal or metal alkali halide, a metal or metal alkali carbonate or bicarbonate, or a metal or metal alkali phosphate, biphosphate, pyrophosphate, triphosphate, metaphosphate, or metabisulfate thereof. In certain particular embodiments, the salt is an inorganic salt that comprises sodium, potassium, calcium, or magnesium. In some embodiments, the salt is a sodium salt or a potassium salt.

The salt forms can be added to the sweetener compositions in the same amounts as their acid or base forms.

Alternative salts include various chloride or sulfate salts, such as sodium chloride, potassium chloride, magnesium chloride, sodium sulfate, magnesium sulfate, and potassium sulfate, or any edible salt. In some embodiments, the one or more salts comprise one or more SG salts. In some further embodiments, the one or more SG salts comprise a salt of RB and/or STB.

In some embodiments, the one or more salts comprises one or more amino acid salts. In some embodiments, the one or more salts comprises one or more poly-amino acid salts.

In some embodiments, the one or more salts comprises one or more sugar acid salts.

The one or more salts can make up anywhere from about 0.01 wt. % of the SG composition to about 30 wt. % of the SG composition, specifically about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, and all ranges therebetween, including for example from about 0.01 wt % to about 10 wt %, about 0.03 wt % to about 10 wt %, about 0.05 wt % to about 10 wt %, about 0.07 wt % to about 10 wt %, about 0.1 wt % to about 10 wt %, about 0.3 wt % to about 10 wt %, about 0.5 wt % to about 10 wt %, about 0.7 wt % to about 10 wt %, about 1 wt % to about 10 wt %, about 3 wt % to about 10 wt %, about 5 wt % to about 10 wt %, about 7 wt % to about 10 wt %, about 0.01 wt % to about 3 wt %, about 0.03 wt % to about 3 wt %, about 0.05 wt % to about 3 wt %, about 0.07 wt % to about 3 wt %, about 0.1 wt % to about 3 wt %, about 0.3 wt % to about 3 wt %, about 0.5 wt % to about 3 wt %, about 0.7 wt % to about 3 wt %, about 1 wt % to about 3 wt %, about 0.01 wt % to about 1 wt %, about 0.03 wt % to about 1 wt %, about 0.05 wt % to about 1 wt %, about 0.07 wt % to about 1 wt %, about 0.1 wt % to about 1 wt %, about 0.3 wt % to about 1 wt %, about 0.5 wt % to about 1 wt %, about 0.7 wt % to about 1 wt %, about 0.01 wt % to about 0.3 wt %, about 0.03 wt % to about 0.3 wt %, about 0.05 wt % to about 0.3 wt %, about 0.07 wt % to about 0.3 wt %, about 0.1 wt % to about 0.3 wt %, about 0.01 wt % to about 0.1 wt %, about 0.03 wt % to about 0.1 wt %, about 0.05 wt % to about 0.1 wt %, about 0.07 wt % to about 0.1 wt %, about 0.01 wt % to about 0.03 wt %, about 0.01 wt % to about 0.05 wt %, about 0.01 wt % to about 0.07 wt %, about 5 wt. % to about 30 wt. %, from about 10 wt. % to about 30 wt. %, or from about 20 wt. % to about 30 wt. %.

Regardless of the salt used in the present compositions, the salt content in a composition is calculated based on the weight of sodium chloride. More specifically, the salt content (based on weight of NaCl) may be determined by determining the total ash content of a sample according to the general method for determining total ash content as set forth in FAO JECFA MONOGRAPHS, vol. 4, 2007. The weight of sodium chloride is determined from the weight of sodium oxide multiplied by a factor of 1.89. For example, if the total ash content of 100 g SG composition is 1 g, the SG composition has a salt content of 1.89 wt %.

iii. Minerals

Minerals, in accordance with the teachings of this application, comprise inorganic chemical elements required by living organisms. Minerals are comprised of a broad range of compositions (e.g., elements, simple salts, and complex silicates) and also vary broadly in crystalline structure. They may naturally occur in foods and beverages, may be added as a supplement, or may be consumed or administered separately from foods or beverages.

Minerals may be categorized as either bulk minerals, which are required in relatively large amounts, or trace minerals, which are required in relatively small amounts. Bulk minerals generally are required in amounts greater than or equal to about 100 mg per day and trace minerals are those that are required in amounts less than about 100 mg per day.

In particular embodiments of the present application, the mineral is chosen from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral.

In certain particular embodiments, the mineral is a trace mineral, believed to be necessary for human nutrition, non-limiting examples of which include bismuth, boron, lithium, nickel, rubidium, silicon, strontium, tellurium, tin, titanium, tungsten, and vanadium.

The minerals embodied herein may be in any form known to those of ordinary skill in the art. For example, in a particular embodiment the minerals may be in their ionic form, having either a positive or negative charge. In another particular embodiment the minerals may be in their molecular form. For example, sulfur and phosphorous often are found naturally as sulfates, sulfides, and phosphates.

iv. Organic Acids and Inorganic Acids

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato. In particular embodiments, the organic acid additive is present in the sweetener composition in an amount effective to provide a concentration from about 10 ppm to about 5,000 ppm when present in an orally consumable composition, such as, for example, a beverage.

Organic acids also include amino acids such as, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid (α-, β-, and/or δ-isomers), glutamine, hydroxyproline, taurine, norvaline and sarcosine. The amino acid may be in the D- or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids.

As used herein, amino acids also encompass both peptides and polypeptides (e.g., dipeptides, tripeptides, tetrapeptides, and pentapeptides) such as glutathione and L-alanyl-L-glutamine. Suitable polyamino acid additives include poly-L-aspartic acid, poly-L-lysine (e.g., poly-L-α-lysine or poly-L-γ-lysine), poly-L-ornithine (e.g., poly-L-α-ornithine or poly-L-γ-ornithine), poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-α-lysine with a MW of 1,500, MW of 6,000, MW of 25,200, MW of 63,000, MW of 83,000, or MW of 300,000.

In particular embodiments, the amino acid is present in the SG composition in an amount effective to provide a concentration from about 10 ppm to about 50,000 ppm when present in an orally consumable composition, such as, for example, a beverage. In another embodiment, the amino acid is present in the sweetener composition in an amount effective to provide a concentration from about 1,000 ppm to about 10,000 ppm when present in an orally consumable composition, such as, for example, from about 2,500 ppm to about 5,000 ppm or from about 250 ppm to about 7,500 ppm.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

The inorganic acid additive is present in the sweetener composition in an amount effective to provide a concentration from about 25 ppm to about 25,000 ppm when present in an orally consumable composition, such as, for example, a beverage.

v. Polyols

The term “polyol,” as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group.

Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

In certain embodiments, the polyol is present in the SG compositions in an amount effective to provide a concentration from about 100 ppm to about 250,000 ppm when present in an orally consumable composition. In other embodiments, the polyol is present in the sweetener compositions in an amount effective to provide a concentration from about 400 ppm to about 80,000 ppm when present in an orally consumable composition, such as, for example, from about 5,000 ppm to about 40,000 ppm.

vi. Nucleotides

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

The nucleotide is present in the SG composition in an amount effective to provide a concentration from about 5 ppm to about 1,000 ppm when present in an orally consumable composition, such as, for example, a beverage.

vii. Bitter Compounds

Suitable bitter compound additives include, but are not limited to, caffeine, quinine, urea, bitter orange oil, naringin, quassia, and salts thereof.

When present in a consumable, such as, for example, a beverage, the bitter compound is present in the sweetener composition in an amount effective to provide a concentration from about 25 ppm to about 25,000 ppm.

viii. Astringent Compounds

Suitable astringent compound additives include, but are not limited to, tannic acid, europium chloride (EuCl3), gadolinium chloride (GdCl3), terbium chloride (TbCl3), alum, tannic acid, and polyphenols (e.g., tea polyphenols). The astringent additive is present in the sweetener composition in an amount effective to provide a concentration from about 10 ppm to about 5,000 ppm when present in a consumable, such as, for example, a beverage.

ix. Proteins or Protein Hydrolysates

Suitable protein or protein hydrolysate additives include, but are not limited to, bovine serum albumin (BSA), whey protein (including fractions or concentrates thereof such as 90% instant whey protein isolate, 34% whey protein, 50%>hydrolyzed whey protein, and 80%>whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

The protein hydrolysate is present in the sweetener composition in an amount effective to provide a concentration from about 200 ppm to about 50,000 ppm when present in a consumable, such as, for example, a beverage.

x. Surfactants

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltnmethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

The surfactant additive is present in the SG composition in an amount effective to provide a concentration from about 30 ppm to about 2,000 ppm when present in an orally consumable composition, such as, for example, a beverage.

xi. Gums and Waxes

Gums and mucilages represent a broad array of different branched structures. Guar gum, derived from the ground endosperm of the guar seed, is a galactomannan. Guar gum is commercially available (e.g., Benefiber by Novartis AG). Other gums, such as gum arabic and pectins, have still different structures. Still other gums include xanthan gum, gellan gum, tara gum, psyllium seed husk gum, and locust bean gum.

Waxes are esters of ethylene glycol and two fatty acids, generally occurring as a hydrophobic liquid that is insoluble in water.

xii. Antioxidants

As used herein “antioxidant” refers to any substance which inhibits, suppresses, or reduces oxidative damage to cells and biomolecules. Without being bound by theory, it is believed that antioxidants inhibit, suppress, or reduce oxidative damage to cells or biomolecules by stabilizing free radicals before they can cause harmful reactions. As such, antioxidants may prevent or postpone the onset of some degenerative diseases.

Examples of suitable antioxidants for embodiments of this application include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, α-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this application include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. A variety of health benefits may be derived from polyphenols, including prevention of cancer, heart disease, and chronic inflammatory disease and improved mental strength and physical strength, for example. Suitable polyphenols for embodiments of this application include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In particular embodiments, the antioxidant is a catechin such as, for example, epigallocatechin gallate (EGCG). Suitable sources of catechins for embodiments of this application include, but are not limited to, green tea, white tea, black tea, oolong tea, chocolate, cocoa, red wine, grape seed, red grape skin, purple grape skin, red grape juice, purple grape juice, berries, pycnogenol, and red apple peel.

In some embodiments, the antioxidant is chosen from proanthocyanidins, procyanidins or combinations thereof. Suitable sources of proanthocyanidins and procyanidins for embodiments of this application include, but are not limited to, red grapes, purple grapes, cocoa, chocolate, grape seeds, red wine, cacao beans, cranberry, apple peel, plum, blueberry, black currants, choke berry, green tea, sorghum, cinnamon, barley, red kidney bean, pinto bean, hops, almonds, hazelnuts, pecans, pistachio, pycnogenol, and colorful berries.

In particular embodiments, the antioxidant is an anthocyanin. Suitable sources of anthocyanins for embodiments of this application include, but are not limited to, red berries, blueberries, bilberry, cranberry, raspberry, cherry, pomegranate, strawberry, elderberry, choke berry, red grape skin, purple grape skin, grape seed, red wine, black currant, red currant, cocoa, plum, apple peel, peach, red pear, red cabbage, red onion, red orange, and blackberries.

In some embodiments, the antioxidant is chosen from quercetin, rutin or combinations thereof. Suitable sources of quercetin and rutin for embodiments of this application include, but are not limited to, red apples, onions, kale, bog whortleberry, lingonberrys, chokeberry, cranberry, blackberry, blueberry, strawberry, raspberry, black currant, green tea, black tea, plum, apricot, parsley, leek, broccoli, chili pepper, berry wine, and ginkgo.

In some embodiments, the antioxidant is reservatrol. Suitable sources of reservatrol for embodiments of this application include, but are not limited to, red grapes, peanuts, cranberry, blueberry, bilberry, mulberry, Japanese Itadori tea, and red wine.

In particular embodiments, the antioxidant is an isoflavone. Suitable sources of isoflavones for embodiments of this application include, but are not limited to, soy beans, soy products, legumes, alfalfa sprouts, chickpeas, peanuts, and red clover.

In some embodiments, the antioxidant is curcumin. Suitable sources of curcumin for embodiments of this application include, but are not limited to, turmeric and mustard.

In particular embodiments, the antioxidant is chosen from punicalagin, ellagitannin or combinations thereof. Suitable sources of punicalagin and ellagitannin for embodiments of this application include, but are not limited to, pomegranate, raspberry, strawberry, walnut, and oak-aged red wine.

In some embodiments, the antioxidant is a citrus flavonoid, such as hesperidin or naringin. Suitable sources of citrus flavonoids, such as hesperidin or naringin, for embodiments of this application include, but are not limited to, oranges, grapefruits, and citrus juices.

In particular embodiments, the antioxidant is chlorogenic acid. Suitable sources of chlorogenic acid for embodiments of this application include, but are not limited to, green coffee, yerba mate, red wine, grape seed, red grape skin, purple grape skin, red grape juice, purple grape juice, apple juice, cranberry, pomegranate, blueberry, strawberry, sunflower, Echinacea, pycnogenol, and apple peel.

xiii. Polymers

Suitable polymer additives include, but are not limited to, chitosan, pectin, pectic, pectinic, polyuronic, polygalacturonic acid, starch, food hydrocolloid or crude extracts thereof (e.g., gum acacia Senegal (Fibergum™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

The polymer is present in the sweetener composition in an amount effective to provide a concentration from about 30 ppm to about 2,000 ppm when present in an orally consumable composition, such as, for example, a beverage.

xiv. Fatty Acids

As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” refers to any polyunsaturated fatty acid having a first double bond as the sixth carbon-carbon bond from the terminal methyl end of its carbon chain.

Suitable omega-3 fatty acids for use in embodiments of the present application can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils, such as Microalgae DHA oil (from Martek, Columbia, Md.), OmegaPure (from Omega Protein, Houston, Tex.), Marinol C-38 (from Lipid Nutrition, Channahon, Ill.), Bonito oil and MEG-3 (from Ocean Nutrition, Dartmouth, NS), Evogel (from Symrise, Holzminden, Germany), Marine Oil, from tuna or salmon (from Arista Wilton, Conn.), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present application may include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

xv. Vitamins

Vitamins are organic compounds that the human body needs in small quantities for normal functioning. The body uses vitamins without breaking them down, unlike other nutrients such as carbohydrates and proteins. To date, thirteen vitamins have been recognized, and one or more can be used in the compositions herein. Suitable vitamins and their alternative chemical names are provided in the accompanying parentheses which follow include, vitamin A (retinol, retinaldehyde), vitamin D (calciferol, cholecalciferol, lumisterol, ergocalciferol, dihydrotachysterol, 7-dehydrocholesterol), vitamin E (tocopherol, tocotrienol), vitamin K (phylloquinone, naphthoquinone), vitamin B1 (thiamin), vitamin B2 (riboflavin, vitamin G), vitamin B3 (niacin, nicotinic acid, vitamin PP), vitamin B5 (pantothenic acid), vitamin B6 (pyridoxine, pyridoxal, pyridoxamine), vitamin B7 (biotin, vitamin H), vitamin B9 (folic acid, folate, folacin, vitamin M, pteroyl-L-glutamic acid), vitamin B12 (cobalamin, cyanocobalamin), and vitamin C (ascorbic acid).

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins.

In some embodiments, the vitamin is a fat-soluble vitamin chosen from vitamin A, D, E, K and combinations thereof. In other embodiments, the vitamin is a water-soluble vitamin chosen from vitamin B1, vitamin B2, vitamin B3, vitamin B6, vitamin B12, folic acid, biotin, pantothenic acid, vitamin C and combinations thereof.

xvi. Preservatives

In particular embodiments of this application, the preservative is chosen from antimicrobials, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone.

According to a particular embodiment, the preservative is a sulfite. Sulfites include, but are not limited to, sulfur dioxide, sodium bisulfite, and potassium hydrogen sulfite.

According to another particular embodiment, the preservative is a propionate. Propionates include, but are not limited to, propionic acid, calcium propionate, and sodium propionate.

According to yet another particular embodiment, the preservative is a benzoate. Benzoates include, but are not limited to, sodium benzoate and benzoic acid.

In another particular embodiment, the preservative is a sorbate. Sorbates include, but are not limited to, potassium sorbate, sodium sorbate, calcium sorbate, and sorbic acid.

In still another particular embodiment, the preservative is a nitrate and/or a nitrite. Nitrates and nitrites include, but are not limited to, sodium nitrate and sodium nitrite.

In yet another particular embodiment, the at least one preservative is a bacteriocin, such as, for example, nisin.

In another particular embodiment, the preservative is ethanol or ozone.

Non-limiting examples of antienzymatics suitable for use as preservatives in particular embodiments of the application include ascorbic acid, citric acid, and metal chelating agents such as ethylenediaminetetraacetic acid (EDTA).

xvii. Hydration Agents

Hydration products help the body to replace fluids that are lost through excretion. For example, fluid is lost as sweat in order to regulate body temperature, as urine in order to excrete waste substances, and as water vapor in order to exchange gases in the lungs. Fluid loss can also occur due to a wide range of external causes, non-limiting examples of which include physical activity, exposure to dry air, diarrhea, vomiting, hyperthermia, shock, blood loss, and hypotension. Diseases causing fluid loss include diabetes, cholera, gastroenteritis, shigellosis, and yellow fever. Forms of malnutrition that cause fluid loss include the excessive consumption of alcohol, electrolyte imbalance, fasting, and rapid weight loss.

In a particular embodiment, the hydration product is a composition that helps the body replace fluids that are lost during exercise. Accordingly, in a particular embodiment, the hydration product is an electrolyte, non-limiting examples of which include sodium, potassium, calcium, magnesium, chloride, phosphate, bicarbonate, and combinations thereof. Suitable electrolytes for use in particular embodiments of this application are also described in U.S. Pat. No. 5,681,569, the disclosure of which is expressly incorporated herein by reference. In particular embodiments, the electrolytes are obtained from their corresponding water-soluble salts. Non-limiting examples of salts for use in particular embodiments include chlorides, carbonates, sulfates, acetates, bicarbonates, citrates, phosphates, hydrogen phosphates, tartrates, sorbates, citrates, benzoates, or combinations thereof. In other embodiments, the electrolytes are provided by juice, fruit extracts, vegetable extracts, tea, or teas extracts.

In particular embodiments of this application, the hydration product is a carbohydrate to supplement energy stores burned by muscles. Suitable carbohydrates for use in particular embodiments of this application are described in U.S. Pat. Nos. 4,312,856, 4,853,237, 5,681,569, and 6,989,171, the disclosures of which are expressly incorporated herein by reference. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, a beet sugar, a cane sugar, a juice, or a tea.

In another particular embodiment, the hydration agent is a flavanol that provides cellular rehydration. Flavanols are a class of natural substances present in plants, and generally comprise a 2-phenylbenzopyrone molecular skeleton attached to one or more chemical moieties. Non-limiting examples of suitable flavanols for use in particular embodiments of this application include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. Several common sources of flavanols include tea plants, fruits, vegetables, and flowers. In preferred embodiments, the flavanol is extracted from green tea.

In a particular embodiment, the hydration product is a glycerol solution to enhance exercise endurance. The ingestion of a glycerol containing solution has been shown to provide beneficial physiological effects, such as expanded blood volume, lower heart rate, and lower rectal temperature.

### 2. Orally Consumable Compositions Comprising an SG Composition

Another aspect of the present application is directed to an orally consumable composition comprising a SG composition of the present application. In some embodiments, the composition comprises one or more SGs having a molecular weight of grater than 965 daltons. In some further embodiments, the one or more SGs having a molecular weight of grater than 965 daltons are selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, AND RO2.

In one embodiment, the orally consumable composition comprises the SG composition of the present application, a sweetener composition comprising the SG composition of the present application, or a flavoring agent comprising the SG composition of the present application. The SG composition can be added to the consumable or consumable matrix to provide a sweetened consumable or a flavored consumable.

“Orally consumable composition,” as used herein, refer to substances which are contacted with the mouth of man or animal, including substances which are taken into and subsequently ejected from the mouth and substances which are drunk, eaten, swallowed or otherwise ingested, and are safe for human or animal consumption when used in a generally acceptable range.

Exemplary orally consumable compositions include, but are not limited to, confections, condiments, chewing compositions, cereal composition, baked goods, dairy products, and sweetener compositions, beverages and beverage products, medicinal compositions, smoking compositions, and oral hygiene compositions. Consumables can be sweetened or unsweetened.

Orally consumable compositions Consumable can optionally include additives, sweeteners, functional ingredients and combinations thereof, as described herein. Any of the additive, sweeteners and other ingredients described above can be present in the orally consumable compositions.

Consumables employing the SG compositions of the present application are also suitable for use in processed agricultural products, livestock products or seafood; processed meat products such as sausage and the like; retort food products, pickles, preserves boiled in soy sauce, delicacies, side dishes; soups; snacks, such as potato chips, cookies, or the like; as shredded filler, leaf, stem, stalk, homogenized leaf cured and animal feed.

### A. Confections

In some embodiments, the orally consumable composition comprising the SG composition of the present application is a confection. As referred to herein, “confection” can mean a sweet, a lollie, a confectionery, or similar term. The confection generally contains a base composition component and a sweetener component. A “base composition” refers to any composition which can be a food item and provides a matrix for carrying the sweetener component. The SG composition of the present application or a sweetener composition comprising the same can serve as the sweetener component. The confection may be in the form of any food that is typically perceived to be rich in sugar or is typically sweet.

According to particular embodiments of the present application, the confections may be bakery products such as pastries; desserts such as yogurt, jellies, drinkable jellies, puddings, Bavarian cream, blancmange, cakes, brownies, mousse and the like, sweetened food products eaten at tea time or following meals; frozen foods; cold confections, e.g., types of ice cream such as ice cream, ice milk, lacto-ice and the like (food products in which sweeteners and various other types of raw materials are added to milk products, and the resulting mixture is agitated and frozen), and ice confections such as sherbets, dessert ices and the like (food products in which various other types of raw materials are added to a sugary liquid, and the resulting mixture is agitated and frozen); general confections, e.g., baked confections or steamed confections such as crackers, biscuits, buns with bean-jam filling, halvah, alfajor, and the like; rice cakes and snacks; table top products; general sugar confections such as chewing gum (e.g. including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans, fudge, toffee, taffy, Swiss milk tablet, licorice candy, chocolates, gelatin candies, marshmallow, marzipan, divinity, cotton candy, and the like; sauces including fruit flavored sauces, chocolate sauces and the like; edible gels; cremes including butter cremes, flour pastes, whipped cream and the like; jams including strawberry jam, marmalade and the like; and breads including sweet breads and the like or other starch products, and combinations thereof.

Suitable base compositions for embodiments of this application may include flour, yeast, water, salt, butter, eggs, milk, milk powder, liquor, gelatin, nuts, chocolate, citric acid, tartaric acid, fumaric acid, natural flavors, artificial flavors, colorings, polyols, sorbitol, isomalt, maltitol, lactitol, malic acid, magnesium stearate, lecithin, hydrogenated glucose syrup, glycerine, natural or synthetic gum, starch, and the like, and combinations thereof. Such components generally are recognized as safe (GRAS) and/or are U.S. Food and Drug Administration (FDA)-approved. According to particular embodiments of the application, the base composition is present in the confection in an amount ranging from about 0.1 to about 99 weight percent of the confection.

The base composition of the confection may optionally include other artificial or natural sweeteners, bulk sweeteners, or combinations thereof. Bulk sweeteners include both caloric and non-caloric compounds. Non-limiting examples of bulk sweeteners include sucrose, dextrose, maltose, dextrin, dried invert sugar, fructose, high fructose corn syrup, levulose, galactose, corn syrup solids, tagatose, polyols (e.g., sorbitol, mannitol, xylitol, lactitol, erythritol, and maltitol), hydrogenated starch hydrolysates, isomalt, trehalose, and mixtures thereof. Generally, the amount of bulk sweetener present in the confection ranges widely depending on the particular embodiment of the confection and the desired degree of sweetness. Those of ordinary skill in the art will readily ascertain the appropriate amount of bulk sweetener.

In a particular embodiment, a confection comprises a SG composition of the present application or a sweetener composition comprising the same and a base composition. Generally, the amount of SG composition of the present application or sweetener composition comprising the same in the confection ranges widely depending on the particular embodiment of the confection and the desired degree of sweetness.

### B. Condiments

In some embodiments, the consumable comprising a SG composition of the present application or a sweetener composition comprising the same is a condiment. Condiments, as used herein, are compositions used to enhance or improve the flavor of a food or beverage. Non-limiting examples of condiments include ketchup (catsup); mustard; barbecue sauce; butter; chili sauce; chutney; cocktail sauce; curry; dips; fish sauce; horseradish; hot sauce; jellies, jams, marmalades, or preserves; mayonnaise; peanut butter; relish; remoulade; salad dressings (e.g., oil and vinegar, Caesar, French, ranch, bleu cheese, Russian, Thousand Island, Italian, and balsamic vinaigrette), salsa; sauerkraut; soy sauce; steak sauce; syrups; tartar sauce; and Worcestershire sauce.

Condiment bases generally comprise a mixture of different ingredients, non-limiting examples of which include vehicles (e.g., water and vinegar); spices or seasonings (e.g., salt, pepper, garlic, mustard seed, onion, paprika, turmeric, and combinations thereof); fruits, vegetables, or their products (e.g., tomatoes or tomato-based products (paste, puree), fruit juices, fruit juice peels, and combinations thereof); oils or oil emulsions, particularly vegetable oils; thickeners (e.g., xanthan gum, food starch, other hydrocolloids, and combinations thereof); and emulsifying agents (e.g., egg yolk solids, protein, gum arabic, carob bean gum, guar gum, gum karaya, gum tragacanth, carageenan, pectin, propylene glycol esters of alginic acid, sodium carboxymethyl-cellulose, polysorbates, and combinations thereof). Recipes for condiment bases and methods of making condiment bases are well known to those of ordinary skill in the art.

Generally, condiments also comprise caloric sweeteners, such as sucrose, high fructose corn syrup, molasses, honey, or brown sugar. In exemplary embodiments of the condiments provided herein, the SG composition of the present application or a sweetener composition comprising the same is used instead of traditional caloric sweeteners. Accordingly, a condiment composition desirably comprises a SG composition of the present application or a sweetener composition comprising the same and a condiment base.

The condiment composition optionally may include other natural and/or synthetic high-potency sweeteners, bulk sweeteners, pH modifying agents (e.g., lactic acid, citric acid, phosphoric acid, hydrochloric acid, acetic acid, and combinations thereof), fillers, functional agents (e.g., pharmaceutical agents, nutrients, or components of a food or plant), flavorings, colorings, or combinations thereof.

### C. Chewing Compositions

In some embodiments, the consumable comprising the steviol composition of the present application is a chewing composition. The term “chewing compositions” include chewing gum compositions, chewing tobacco, smokeless tobacco, snuff, chewing gum and other compositions which are masticated and subsequently expectorated.

Chewing gum compositions generally comprise a water-soluble portion and a water-insoluble chewable gum base portion. The water soluble portion, which typically includes a SG composition of the present application or a sweetener composition comprising the same, dissipates with a portion of the flavoring agent over a period of time during chewing while the insoluble gum base portion is retained in the mouth. The insoluble gum base generally determines whether a gum is considered chewing gum, bubble gum, or a functional gum.

The insoluble gum base, which is generally present in the chewing gum composition in an amount in the range of about 15 to about 35 weight percent of the chewing gum composition, generally comprises combinations of elastomers, softeners (plasticizers), emulsifiers, resins, and fillers. Such components generally are considered food grade, recognized as safe (GRA), and/or are U.S. Food and Drug Administration (FDA)-approved.

Elastomers, the primary component of the gum base, provide the rubbery, cohesive nature to gums and can include one or more natural rubbers (e.g., smoked latex, liquid latex, or guayule); natural gums (e.g., jelutong, perillo, sorva, massaranduba balata, massaranduba chocolate, nispero, rosindinha, chicle, and gutta hang kang); or synthetic elastomers (e.g., butadiene-styrene copolymers, isobutylene-isoprene copolymers, polybutadiene, polyisobutylene, and vinyl polymeric elastomers). In a particular embodiment, the elastomer is present in the gum base in an amount in the range of about 3 to about 50 weight percent of the gum base.

Resins are used to vary the firmness of the gum base and aid in softening the elastomer component of the gum base. Non-limiting examples of suitable resins include a rosin ester, a terpene resin (e.g., a terpene resin from α-pinene, β-pinene and/or D-limonene), polyvinyl acetate, polyvinyl alcohol, ethylene vinyl acetate, and vinyl acetate-vinyl laurate copolymers. Non-limiting examples of rosin esters include a glycerol ester of a partially hydrogenated rosin, a glycerol ester of a polymerized rosin, a glycerol ester of a partially dimerized rosin, a glycerol ester of rosin, a pentaerythritol ester of a partially hydrogenated rosin, a methyl ester of rosin, or a methyl ester of a partially hydrogenated rosin. In a particular embodiment, the resin is present in the gum base in an amount in the range of about 5 to about 75 weight percent of the gum base.

Softeners, which also are known as plasticizers, are used to modify the ease of chewing and/or mouthfeel of the chewing gum composition. Generally, softeners comprise oils, fats, waxes, and emulsifiers. Non-limiting examples of oils and fats include tallow, hydrogenated tallow, large, hydrogenated or partially hydrogenated vegetable oils (e.g., soybean, canola, cottonseed, sunflower, palm, coconut, corn, safflower, or palm kernel oils), cocoa butter, glycerol monostearate, glycerol triacetate, glycerol abietate, lecithin, monoglycerides, diglycerides, triglycerides acetylated monoglycerides, and free fatty acids. Non-limiting examples of waxes include polypropylene/polyethylene/Fisher-Tropsch waxes, paraffin, and microcrystalline and natural waxes (e.g., candelilla, beeswax and carnauba). Microcrystalline waxes, especially those with a high degree of crystallinity and a high melting point, also may be considered as bodying agents or textural modifiers. In a particular embodiment, the softeners are present in the gum base in an amount in the range of about 0.5 to about 25 weight percent of the gum base.

Emulsifiers are used to form a uniform dispersion of the insoluble and soluble phases of the chewing gum composition and also have plasticizing properties. Suitable emulsifiers include glycerol monostearate (GMS), lecithin (phosphatidyl choline), polyglycerol polyricinoleic acid (PPGR), mono and diglycerides of fatty acids, glycerol distearate, tracetin, acetylated monoglyceride, glycerol triacetate, and magnesium stearate. In a particular embodiment, the emulsifiers are present in the gum base in an amount in the range of about 2 to about 30 weight percent of the gum base.

The chewing gum composition also may comprise adjuvants or fillers in either the gum base and/or the soluble portion of the chewing gum composition. Suitable adjuvants and fillers include lecithin, inulin, polydextrin, calcium carbonate, magnesium carbonate, magnesium silicate, ground limestone, aluminum hydroxide, aluminum silicate, talc, clay, alumina, titanium dioxide, and calcium phosphate. In particular embodiments, lecithin can be used as an inert filler to decrease the stickiness of the chewing gum composition. In other particular embodiments, lactic acid copolymers, proteins (e.g., gluten and/or zein) and/or guar can be used to create a gum that is more readily biodegradable. The adjuvants or fillers are generally present in the gum base in an amount up to about 20 weight percent of the gum base. Other optional ingredients include coloring agents, whiteners, preservatives, and flavors.

In particular embodiments of the chewing gum composition, the gum base comprises about 5 to about 95 weight percent of the chewing gum composition, more desirably about 15 to about 50 weight percent of the chewing gum composition, and even more desirably from about 20 to about 30 weight percent of the chewing gum composition.

The soluble portion of the chewing gum composition may optionally include other artificial or natural sweeteners, bulk sweeteners, softeners, emulsifiers, flavoring agents, coloring agents, adjuvants, fillers, functional agents (e.g., pharmaceutical agents or nutrients), or combinations thereof. Suitable examples of softeners and emulsifiers are described above.

Bulk sweeteners include both caloric and non-caloric compounds. Non-limiting examples of bulk sweeteners include sucrose, dextrose, maltose, dextrin, dried invert sugar, fructose, high fructose corn syrup, levulose, galactose, corn syrup solids, tagatose, polyols (e.g., sorbitol, mannitol, xylitol, lactitol, erythritol, and maltitol), hydrogenated starch hydrolysates, isomalt, trehalose, and mixtures thereof. In particular embodiments, the bulk sweetener is present in the chewing gum composition in an amount in the range of about 1 to about 75 weight percent of the chewing gum composition.

Flavoring agents may be used in either the insoluble gum base or soluble portion of the chewing gum composition. Such flavoring agents may be natural or artificial flavors. In a particular embodiment, the flavoring agent comprises an essential oil, such as an oil derived from a plant or a fruit, peppermint oil, spearmint oil, other mint oils, clove oil, cinnamon oil, oil of wintergreen, bay, thyme, cedar leaf, nutmeg, allspice, sage, mace, and almonds. In another particular embodiment, the flavoring agent comprises a plant extract or a fruit essence such as apple, banana, watermelon, pear, peach, grape, strawberry, raspberry, cherry, plum, pineapple, apricot, and mixtures thereof. In still another particular embodiment, the flavoring agent comprises a citrus flavor, such as an extract, essence, or oil of lemon, lime, orange, tangerine, grapefruit, citron, or kumquat.

In a particular embodiment, a chewing gum composition comprises a SG composition of the present application or a sweetener composition comprising the same and a gum base.

### D. Cereal Compositions

In some embodiments, the consumable comprising the steviol composition of the present application is a cereal composition. Cereal compositions typically are eaten either as staple foods or as snacks. Non-limiting examples of cereal compositions for use in particular embodiments include ready-to-eat cereals as well as hot cereals. Ready-to-eat cereals are cereals which may be eaten without further processing (i.e., cooking) by the consumer. Examples of ready-to-eat cereals include breakfast cereals and snack bars. Breakfast cereals typically are processed to produce a shredded, flaky, puffy, or extruded form. Breakfast cereals generally are eaten cold and are often mixed with milk and/or fruit. Snack bars include, for example, energy bars, rice cakes, granola bars, and nutritional bars. Hot cereals generally are cooked, usually in either milk or water, before being eaten. Non-limiting examples of hot cereals include grits, porridge, polenta, rice, and rolled oats.

Cereal compositions generally comprise at least one cereal ingredient. As used herein, the term “cereal ingredient” denotes materials such as whole or part grains, whole or part seeds, and whole or part grass. Non-limiting examples of cereal ingredients for use in particular embodiments include maize, wheat, rice, barley, bran, bran endosperm, bulgur, sorghums, millets, oats, rye, triticale, buckwheat, fonio, quinoa, bean, soybean, amaranth, teff, spelt, and kaniwa.

In a particular embodiment, the cereal composition comprises a SG composition of the present application or a sweetener composition comprising the same and at least one cereal ingredient. The SG composition of the present application or sweetener composition comprising the same may be added to the cereal composition in a variety of ways, such as, for example, as a coating, as a frosting, as a glaze, or as a matrix blend (i.e., added as an ingredient to the cereal formulation prior to the preparation of the final cereal product).

Accordingly, in a particular embodiment, the SG composition of the present application or sweetener composition comprising the same is added to the cereal composition as a matrix blend. In one embodiment, the SG composition of the present application or sweetener composition comprising the same is blended with a hot cereal prior to cooking to provide a sweetened hot cereal product. In another embodiment, the SG composition of the present application or sweetener composition comprising the same is blended with the cereal matrix before the cereal is extruded.

In another particular embodiment, the SG composition of the present application or sweetener composition comprising the same is added to the cereal composition as a coating, such as, for example, by combining with a food grade oil and applying the mixture onto the cereal. In a different embodiment, the SG composition of the present application or sweetener composition comprising the same and the food grade oil may be applied to the cereal separately, by applying either the oil or the sweetener first. Non-limiting examples of food grade oils for use in particular embodiments include vegetable oils such as corn oil, soybean oil, cottonseed oil, peanut oil, coconut oil, canola oil, olive oil, sesame seed oil, palm oil, palm kernel oil, and mixtures thereof. In yet another embodiment, food grade fats may be used in place of the oils, provided that the fat is melted prior to applying the fat onto the cereal.

In another embodiment, the SG composition of the present application or sweetener composition comprising the same is added to the cereal composition as a glaze. Non-limiting examples of glazing agents for use in particular embodiments include corn syrup, honey syrups and honey syrup solids, maple syrups and maple syrup solids, sucrose, isomalt, polydextrose, polyols, hydrogenated starch hydrolysate, aqueous solutions thereof, and mixtures thereof. In another such embodiment, the SG composition of the present application or sweetener composition comprising the same is added as a glaze by combining with a glazing agent and a food grade oil or fat and applying the mixture to the cereal. In yet another embodiment, a gum system, such as, for example, gum acacia, carboxymethyl cellulose, or algin, may be added to the glaze to provide structural support. In addition, the glaze also may include a coloring agent, and also may include a flavor.

In another embodiment, the SG composition of the present application or sweetener composition comprising the same is added to the cereal composition as a frosting. In one such embodiment, the SG composition of the present application or sweetener composition comprising the same is combined with water and a frosting agent and then applied to the cereal. Non-limiting examples of frosting agents for use in particular embodiments include maltodextrin, sucrose, starch, polyols, and mixtures thereof. The frosting also may include a food grade oil, a food grade fat, a coloring agent, and/or a flavor.

Generally, the amount of the SG composition of the present application or sweetener composition comprising the same in a cereal composition varies widely depending on the particular type of cereal composition and its desired sweetness. Those of ordinary skill in the art can readily discern the appropriate amount of sweetener to put in the cereal composition.

### E. Baked Goods

In some embodiments, the consumable comprising the steviol composition of the present application is bakes goods. Baked goods, as used herein, include ready to eat and all ready to bake products, flours, and mixes requiring preparation before serving. Non-limiting examples of baked goods include cakes, crackers, cookies, brownies, muffins, rolls, bagels, donuts, strudels, pastries, croissants, biscuits, bread, bread products, and buns.

Preferred baked goods in accordance with embodiments of this application can be classified into three groups: bread-type doughs (e.g., white breads, variety breads, soft buns, hard rolls, bagels, pizza dough, and flour tortillas), sweet doughs (e.g., danishes, croissants, crackers, puff pastry, pie crust, biscuits, and cookies), and batters (e.g., cakes such as sponge, pound, devil's food, cheesecake, and layer cake, donuts or other yeast raised cakes, brownies, and muffins). Doughs are generally characterized as being flour-based, whereas batters are more water-based.

Baked goods in accordance with particular embodiments of this application generally comprise a combination of sweetener, water, and fat. Baked goods made in accordance with many embodiments of this application also contain flour in order to make a dough or a batter. The term “dough” as used herein is a mixture of flour and other ingredients stiff enough to knead or roll. The term “batter” as used herein consists of flour, liquids such as milk or water, and other ingredients, and is thin enough to pour or drop from a spoon. Desirably, in accordance with particular embodiments of the application, the flour is present in the baked goods in an amount in the range of about 15 to about 60% on a dry weight basis, more desirably from about 23 to about 48% on a dry weight basis.

The type of flour may be selected based on the desired product. Generally, the flour comprises an edible non-toxic flour that is conventionally utilized in baked goods. According to particular embodiments, the flour may be a bleached bake flour, general purpose flour, or unbleached flour. In other particular embodiments, flours also may be used that have been treated in other manners. For example, in particular embodiments flour may be enriched with additional vitamins, minerals, or proteins. Non-limiting examples of flours suitable for use in particular embodiments of the application include wheat, corn meal, whole grain, fractions of whole grains (wheat, bran, and oatmeal), and combinations thereof. Starches or farinaceous material also may be used as the flour in particular embodiments. Common food starches generally are derived from potato, corn, wheat, barley, oat, tapioca, arrow root, and sago. Modified starches and pregelatinized starches also may be used in particular embodiments of the application.

The type of fat or oil used in particular embodiments of the application may comprise any edible fat, oil, or combination thereof that is suitable for baking. Non-limiting examples of fats suitable for use in particular embodiments of the application include vegetable oils, tallow, lard, marine oils, and combinations thereof. According to particular embodiments, the fats may be fractionated, partially hydrogenated, and/or intensified. In another particular embodiment, the fat desirably comprises reduced, low calorie, or non-digestible fats, fat substitutes, or synthetic fats. In yet another particular embodiment, shortenings, fats, or mixtures of hard and soft fats also may be used. In particular embodiments, shortenings may be derived principally from triglycerides derived from vegetable sources (e.g., cotton seed oil, soybean oil, peanut oil, linseed oil, sesame oil, palm oil, palm kernel oil, rapeseed oil, safflower oil, coconut oil, corn oil, sunflower seed oil, and mixtures thereof). Synthetic or natural triglycerides of fatty acids having chain lengths from 8 to 24 carbon atoms also may be used in particular embodiments. Desirably, in accordance with particular embodiments of this application, the fat is present in the baked good in an amount in the range of about 2 to about 35% by weight on a dry basis, more desirably from about 3 to about 29% by weight on a dry basis.

Baked goods in accordance with particular embodiments of this application also comprise water in amounts sufficient to provide the desired consistency, enabling proper forming, machining and cutting of the baked good prior or subsequent to cooking. The total moisture content of the baked good includes any water added directly to the baked good as well as water present in separately added ingredients (e.g., flour, which generally includes about 12 to about 14% by weight moisture). Desirably, in accordance with particular embodiments of this application, the water is present in the baked good in an amount up to about 25% by weight of the baked good.

Baked goods in accordance with particular embodiments of this application also may comprise a number of additional conventional ingredients such as leavening agents, flavors, colors, milk, milk by-products, egg, egg by-products, cocoa, vanilla or other flavoring, as well as inclusions such as nuts, raisins, cherries, apples, apricots, peaches, other fruits, citrus peel, preservative, coconuts, flavored chips such a chocolate chips, butterscotch chips, and caramel chips, and combinations thereof. In particular embodiments, the baked goods may also comprise emulsifiers, such as lecithin and monoglycerides.

According to particular embodiments of this application, leavening agents may comprise chemical leavening agents or yeast leavening agents. Non-limiting examples of chemical leavening agents suitable for use in particular embodiments of this application include baking soda (e.g., sodium, potassium, or aluminum bicarbonate), baking acid (e.g., sodium aluminum phosphate, monocalcium phosphate, or dicalcium phosphate), and combinations thereof.

In accordance with another particular embodiment of this application, cocoa may comprise natural or “Dutched” chocolate from which a substantial portion of the fat or cocoa butter has been expressed or removed by solvent extraction, pressing, or other means. In a particular embodiment, it may be necessary to reduce the amount of fat in a baked good comprising chocolate because of the additional fat present in cocoa butter. In particular embodiments, it may be necessary to add larger amounts of chocolate as compared to cocoa in order to provide an equivalent amount of flavoring and coloring.

Baked goods generally also comprise caloric sweeteners, such as sucrose, high fructose corn syrup, erythritol, molasses, honey, or brown sugar. In exemplary embodiments of the baked goods provided herein, the caloric sweetener is replaced partially or totally with a SG composition of the present application or a sweetener composition comprising the same. Accordingly, in one embodiment a baked good comprises a SG composition of the present application or a sweetener composition comprising the same in combination with a fat, water, and optionally flour. In a particular embodiment, the baked good optionally may include other natural and/or synthetic high-potency sweeteners and/or bulk sweeteners.

### F. Dairy Products

In some embodiments, the consumable comprising the steviol composition of the present application is a dairy product. Dairy products and processes for making dairy products suitable for use with the SG compositions of the present application are well known to those of ordinary skill in the art. Dairy products, as used herein, comprise milk or foodstuffs produced from milk. Non-limiting examples of dairy products suitable for use in embodiments of this application include milk, milk cream, sour cream, creme fraiche, buttermilk, cultured buttermilk, milk powder, condensed milk, evaporated milk, butter, cheese, cottage cheese, cream cheese, yogurt, ice cream, frozen custard, frozen yogurt, gelato, via, piima, filmjolk, kajmak, kephir, viili, kumiss, airag, ice milk, casein, ayran, lassi, khoa, or combinations thereof.

Milk is a fluid secreted by the mammary glands of female mammals for the nourishment of their young. The female ability to produce milk is one of the defining characteristics of mammals and provides the primary source of nutrition for newborns before they are able to digest more diverse foods. In particular embodiments, the dairy products are derived from the raw milk of cows, goats, sheep, horses, donkeys, camels, water buffalo, yaks, reindeer, moose, or humans.

In particular embodiments, the processing of the dairy product from raw milk generally comprises the steps of pasteurizing, creaming, and homogenizing. Although raw milk may be consumed without pasteurization, it usually is pasteurized to destroy harmful microorganisms such as bacteria, viruses, protozoa, molds, and yeasts. Pasteurizing generally comprises heating the milk to a high temperature for a short period of time to substantially reduce the number of microorganisms, thereby reducing the risk of disease.

Creaming traditionally follows pasteurization step, and involves the separation of milk into a higher-fat cream layer and a lower-fat milk layer. Milk will separate into milk and cream layers upon standing for twelve to twenty-four hours. The cream rises to the top of the milk layer and may be skimmed and used as a separate dairy product. Alternatively, centrifuges may be used to separate the cream from the milk. The remaining milk is classified according to the fat content of the milk, non-limiting examples of which include whole, 2%, 1%, and skim milk.

After removing the desired amount of fat from the milk by creaming, milk is often homogenized. Homogenization prevents cream from separating from the milk and generally involves pumping the milk at high pressures through narrow tubes in order to break up fat globules in the milk. Pasteurization, creaming, and homogenization of milk are common but are not required to produce consumable dairy products. Accordingly, suitable dairy products for use in embodiments of this application may undergo no processing steps, a single processing step, or combinations of the processing steps described herein. Suitable dairy products for use in embodiments of this application may also undergo processing steps in addition to or apart from the processing steps described herein.

Particular embodiments of this application comprise dairy products produced from milk by additional processing steps. As described above, cream may be skimmed from the top of milk or separated from the milk using machine-centrifuges. In a particular embodiment, the dairy product comprises sour cream, a dairy product rich in fats that is obtained by fermenting cream using a bacterial culture. The bacteria produce lactic acid during fermentation, which sours and thickens the cream. In another particular embodiment, the dairy product comprises creme fraiche, a heavy cream slightly soured with bacterial culture in a similar manner to sour cream. Creme fraiche ordinarily is not as thick or as sour as sour cream. In yet another particular embodiment, the dairy product comprises cultured buttermilk. Cultured buttermilk is obtained by adding bacteria to milk. The resulting fermentation, in which the bacterial culture turns lactose into lactic acid, gives cultured buttermilk a sour taste. Although it is produced in a different manner, cultured buttermilk generally is similar to traditional buttermilk, which is a byproduct of butter manufacture.

According to other particular embodiments of this application, the dairy products comprise milk powder, condensed milk, evaporated milk, or combinations thereof. Milk powder, condensed milk, and evaporated milk generally are produced by removing water from milk. In a particular embodiment, the dairy product comprises a milk powder comprising dried milk solids with a low moisture content. In another particular embodiment, the dairy product comprises condensed milk. Condensed milk generally comprises milk with a reduced water content and added sweetener, yielding a thick, sweet product with a long shelf-life. In yet another particular embodiment, the dairy product comprises evaporated milk. Evaporated milk generally comprises fresh, homogenized milk from which about 60% of the water has been removed, that has been chilled, fortified with additives such as vitamins and stabilizers, packaged, and finally sterilized. According to another particular embodiment of this application, the dairy product comprises a dry creamer and a SG composition of the present application or a sweetener composition comprising the same.

In another particular embodiment, the dairy product provided herein comprises butter. Butter generally is made by churning fresh or fermented cream or milk. Butter generally comprises butterfat surrounding small droplets comprising mostly water and milk proteins. The churning process damages the membranes surrounding the microscopic globules of butterfat, allowing the milk fats to conjoin and to separate from the other parts of the cream. In yet another particular embodiment, the dairy product comprises buttermilk, which is the sour-tasting liquid remaining after producing butter from full-cream milk by the churning process.

In still another particular embodiment, the dairy product comprises cheese, a solid foodstuff produced by curdling milk using a combination of rennet or rennet substitutes and acidification. Rennet, a natural complex of enzymes produced in mammalian stomachs to digest milk, is used in cheese-making to curdle the milk, causing it to separate into solids known as curds and liquids known as whey. Generally, rennet is obtained from the stomachs of young ruminants, such as calves; however, alternative sources of rennet include some plants, microbial organisms, and genetically modified bacteria, fungus, or yeast. In addition, milk may be coagulated by adding acid, such as citric acid. Generally, a combination of rennet and/or acidification is used to curdle the milk. After separating the milk into curds and whey, some cheeses are made by simply draining, salting, and packaging the curds. For most cheeses, however, more processing is needed. Many different methods may be used to produce the hundreds of available varieties of cheese. Processing methods include heating the cheese, cutting it into small cubes to drain, salting, stretching, cheddaring, washing, molding, aging, and ripening. Some cheeses, such as the blue cheeses, have additional bacteria or molds introduced to them before or during aging, imparting flavor and aroma to the finished product. Cottage cheese is a cheese curd product with a mild flavor that is drained but not pressed so that some whey remains. The curd is usually washed to remove acidity. Cream cheese is a soft, mild-tasting, white cheese with a high fat content that is produced by adding cream to milk and then curdling to form a rich curd. Alternatively, cream cheese can be made from skim milk with cream added to the curd. It should be understood that cheese, as used herein, comprises all solid foodstuff produced by the curdling milk.

In another particular embodiment, the dairy product comprises yogurt. Yogurt generally is produced by the bacterial fermentation of milk. The fermentation of lactose produces lactic acid, which acts on proteins in milk to give the yogurt a gel-like texture and tartness. In particularly desirable embodiments, the yogurt may be sweetened with a sweetener and/or flavored. Non-limiting examples of flavorings include, but are not limited to, fruits (e.g., peach, strawberry, banana), vanilla, and chocolate. Yogurt, as used herein, also includes yogurt varieties with different consistencies and viscosities, such as dahi, dadih or dadiah, labneh or labaneh, bulgarian, kefir, and matsoni. In another particular embodiment, the dairy product comprises a yogurt-based beverage, also known as drinkable yogurt or a yogurt smoothie. In particularly desirable embodiments, the yogurt-based beverage may comprise sweeteners, flavorings, other ingredients, or combinations thereof.

Other dairy products beyond those described herein may be used in particular embodiments of this application. Such dairy products are well known to those of ordinary skill in the art, non-limiting examples of which include milk, milk and juice, coffee, tea, via, piima, filmjolk, kajmak, kephir, viili, kumiss, airag, ice milk, casein, ayran, lassi, and khoa.

According to particular embodiments of this application, the dairy compositions also may comprise other additives. Non-limiting examples of suitable additives include sweeteners and flavorants such as chocolate, strawberry, and banana. Particular embodiments of the dairy compositions provided herein also may comprise additional nutritional supplements such as vitamins (e.g., vitamin D) and minerals (e.g., calcium) to improve the nutritional composition of the milk.

In a particularly desirable embodiment, the dairy composition comprises a SG composition of the present application or a sweetener composition comprising the same in combination with a dairy product.

### G. Sweetener Compositions

In some embodiments, the consumable comprising the steviol composition of the present application is a sweetener composition. In some embodiments, the sweetener composition is a tabletop sweetener composition. In some embodiments, the tabletop sweetener composition may further include at least one bulking agent, additive, anti-caking agent, functional ingredient or combination thereof.

Suitable “bulking agents” include, but are not limited to, maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, and mixtures thereof. Additionally, in accordance with still other embodiments of the application, granulated sugar (sucrose) or other caloric sweeteners such as crystalline fructose, other carbohydrates, or sugar alcohol can be used as a bulking agent due to their provision of good content uniformity without the addition of significant calories.

As used herein, the phrase “anti-caking agent” and “flow agent” refer to any composition which assists in content uniformity and uniform dissolution. In accordance with particular embodiments, non-limiting examples of anti-caking agents include cream of tartar, calcium silicate, silicon dioxide, microcrystalline cellulose (Avicel, FMC BioPolymer, Philadelphia, Pa.), and tricalcium phosphate. In one embodiment, the anti-caking agents are present in the tabletop sweetener composition in an amount from about 0.001 to about 3% by weight of the tabletop sweetener composition.

The tabletop sweetener compositions can be packaged in any form known in the art. Non-limiting forms include, but are not limited to, powder form, granular form, packets, tablets, sachets, pellets, cubes, solids, and liquids.

In one embodiment, the tabletop sweetener composition is a single-serving (portion control) packet comprising a dry-blend. Dry-blend formulations generally may comprise powder or granules. Although the tabletop sweetener composition may be in a packet of any size, an illustrative non-limiting example of conventional portion control tabletop sweetener packets are approximately 2.5 by 1.5 inches and hold approximately 1 gram of a sweetener composition having a sweetness equivalent to 2 teaspoons of granulated sugar (˜8 g). The amount of the SG composition of the present application or a sweetener composition comprising the same in a dry-blend tabletop sweetener formulation can vary. In a particular embodiment, a dry-blend tabletop sweetener formulation may contain SG composition in an amount from about 1% (w/w) to about 10% (w/w) of the tabletop sweetener composition.

Solid tabletop sweetener embodiments include cubes and tablets. Non-limiting examples of conventional cubes are equivalent in size to a standard cube of granulated sugar, which is approximately 2.2×2.2×2.2 cm3 and weigh approximately 8 g. In one embodiment, a solid tabletop sweetener is in the form of a tablet or any other form known to those skilled in the art.

A tabletop sweetener composition also may be embodied in the form of a liquid, wherein a SG composition of the present application or a sweetener composition comprising the same is combined with a liquid carrier. Suitable non-limiting examples of carrier agents for liquid tabletop sweeteners include water, alcohol, polyol, glycerin base or citric acid base dissolved in water, and mixtures thereof. The sweetness equivalent of a tabletop sweetener composition for any of the forms described herein or known in the art may be varied to obtain a desired sweetness profile. For example, a tabletop sweetener composition may comprise a sweetness comparable to that of an equivalent amount of standard sugar. In another embodiment, the tabletop sweetener composition may comprise a sweetness of up to 100 times that of an equivalent amount of sugar. In another embodiment, the tabletop sweetener composition may comprise a sweetness of up to 90 times, 80 times, 70 times, 60 times, 50 times, 40 times, 30 times, 20 times, 10 times, 9 times, 8 times, 7 times, 6 times, 5 times, 4 times, 3 times, and 2 times that of an equivalent amount of sugar.

### H. Beverages and Beverage Products

In one embodiment, a beverage or beverage product comprises a SG composition of the present application or a sweetener composition comprising the same. The beverage may be sweetened or unsweetened. The SG composition, or sweetener composition comprising the same, may be added to a beverage to sweeten the beverage or enhance its existing sweetness or flavor profile.

“Beverage product,” as used herein, is a ready-to-drink beverage, a beverage concentrate, a beverage syrup, or a powdered beverage. Suitable ready-to-drink beverages include carbonated and non-carbonated beverages. Carbonated beverages include, but are not limited to, frozen carbonated beverages, enhanced sparkling beverages, cola, fruit-flavored sparkling beverages (e.g. lemon-lime, orange, grape, strawberry and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, cafe au lait, milk tea, fruit milk beverages), beverages containing cereal extracts and smoothies.

Beverage concentrates and beverage syrups are prepared with an initial volume of liquid matrix (e.g., water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water.

Beverages comprise a matrix, i.e., the basic ingredient in which the ingredients—including the compositions of the present application—are dissolved. In one embodiment, a beverage comprises water of beverage quality as the matrix, such as, for example deionized water, distilled water, reverse osmosis water, carbon-treated water, purified water, demineralized water and combinations thereof, can be used. Additional suitable matrices include, but are not limited to phosphoric acid, phosphate buffer, citric acid, citrate buffer and carbon-treated water.

In one embodiment, a beverage comprises SG composition of the present application. In another embodiment, a beverage product comprises a sweetener composition of the present application.

The beverage concentrations below can be provided by the SG composition or sweetener composition of the present application.

In one embodiment, the total concentration of SGs in the beverage is from about 50 ppm to about 900 ppm, such as, for example, from about 50 ppm to about 600 ppm, from about 50 ppm to about 500 ppm, from about 50 ppm to about 400 ppm, from about 50 ppm to about 300 ppm, from about 50 ppm to about 200 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm and from about 500 ppm to about 600 ppm.

### I. Medical Compositions

The term “medicinal composition” includes solids, gases and liquids which are ingestible materials having medicinal value, such as cough syrups, cough drops, medicinal sprays, vitamins, and chewable medicinal tablets.

### J. Oral Hygiene Compositions

The term “oral hygiene compositions” includes mouthwashes, mouth rinses, toothpastes, tooth polishes, dentifrices, mouth sprays, and mouth refreshers.

### K. Smoking Compositions

The term “smoking composition,” as used herein, includes cigarette, pipe and cigar tobacco, and all forms of tobacco such as shredded filler, leaf, stem, stalk, homogenized leaf cured, reconstituted binders, and reconstituted tobacco from tobacco dust, fines, or other sources in sheet, pellet or other forms. “Smoking compositions” also include tobacco substitutes formulated from non-tobacco materials, such as representative tobacco substitutes described in U.S. Pat. Nos. 3,529,602, 3,703,177 and 4,079,742 and references cited therein.

### 3. Methods of Making the SG Composition

Another aspect of the present application is directed to methods of making the SG composition of the present application.

In some embodiments, the starting material for the methods of making the SG composition are selected from the group consisting of SGs in a pure form, extracted from Stevia plant leaves, intermediates or liquid preparations.

In some embodiments, a process for preparing a treated SG composition with improved solubility in an aqueous solution in comparison with untreated SGs comprises the steps of: (1) mixing a SG or a SG composition with water, (2) heating the mixture while stirring, until the mixture was completely dissolved to obtain a clear solution, (3) further stirring the solution at the elevated temperature, (4) cooling to ambient temperature, and (5) subjecting the solution to spray drying. In step (2), the mixture can be heated to 30-200° C., preferably 40-120° C., more preferably 50-90° C., most preferably 60-70° C. Alternatively, step (5) can be replaced by crystallization of the SG or the SG composition.

In other embodiments, a process for preparing a treated SG composition with improved or desired taste profile in comparison with untreated SGs comprises removing or reducing the amount of non-SG off-taste compounds.

A spray dried composition described herein can be prepared as a mixture first and then spray dried or as individual components that are spray dried first and then combined. It should also be understood that when two or more components are in a mixture, the amount of the components can be varied amongst the components from 1% wt/wt to 99% wt/wt, and that a total of 100% wt/wt is achieved.

The SG(s) or SG composition may be solubilized in a water/alcohol solution. The alcohol can be methanol, ethanol, propanol, isopropanol, n-butanol, isobutanol, sec-butanol, tert-butanol, n-pentanol, isopentanol, neopentanol, or combinations thereof.

The water alcohol solution can be less than 60% alcohol, less than 50% alcohol, less than 40% alcohol, less than 30% alcohol, less than 20% alcohol, less than 10% alcohol, less than 5% alcohol, less than 2% alcohol, or less than 1% alcohol by volume.

In some embodiments, the SG composition of the present application is prepared by mixing individual components together. Individual components of the SG composition can be purchased or be made by processes known to those of ordinary skill in the art, and then combined (e.g., precipitation/co-precipitation, mixing, blending, grounding, mortar and pestal, microemulsion, solvothermal, sonochemical, etc.).

In some embodiments, a mixture of rebaudiosides A and B is solubilized in an aqueous temperature at an elevated temperature, followed by lowering the temperature to ambient temperature.

In other embodiments, a mixture of rebaudiosides A and D is solubilized in an aqueous temperature at an elevated temperature, followed by lowering the temperature to ambient temperature.

In still other embodiments, a mixture of rebaudiosides A, B, and D is solubilized in an aqueous temperature at an elevated temperature, followed by lowering the temperature to ambient temperature.

In yet other embodiments, a mixture of rebaudiosides A, B, and D is solubilized in an aqueous temperature at an elevated temperature, followed by lowering the temperature to ambient temperature, and then followed by drying the solution to provide a highly soluble stevia based sweetener, e.g., a dried SG composition. In some embodiments, the process of drying the solution utilizes spray drying the solution.

Taste modifying moieties, such as galactosides, may be added to the SG compositions of the present disclosure to modify the perceived sweetness of the SG composition. For instance, β-1,4-galactosyl can be substituted on the SG composition using a 0-1,4-galactosyl transferase enzyme in reactions known in the art.

A SG composition of the present disclosure, in its purified state after spray drying, is generally a fine powder, having a particle size in the range of about 1 to 100 microns. Fine powders are difficult to handle and difficult to admix with consumable compositions, such as tea leaves, tobacco products, herb leaves, coffees and other orally consumable compositions. Also, generally, only a relatively small amount of SG composition is used with a consumable composition when the SG composition is used as a flavor modifier or enhancer, sweetener, or co-sweetener.

### 4. Methods of Using the SG Composition

Another aspect of the present application is directed to methods of using the SG composition of the present application.

In accordance with another embodiment, a process for adding Product to an orally consumable composition comprises admixing a SG composition with a carrier to form a SG composition-carrier mixture. Preferred carriers include water, ethanol, other alkanols used in food processing, or mixtures thereof. A SG composition solution so formed may be contacted with an orally consumable composition, the carrier is removed from the orally consumable composition by evaporation, or other means, and the SG composition residues deposited with the orally consumable composition. This process is particularly useful for adding SG composition to tea leaves, herbal plant leaves, and other sweeteners, particularly granular sucrose (table sugar).

In some embodiments, the SG composition of the present application is used in an effective amount as a sweetener with improved solubility and and/or sensory profiles.

In some embodiments, the SG composition of the present application is used an effective amount as a co-sweetener with improved solubility and and/or sensory profiles.

In other embodiments, the SG composition of the present application is used an effective amount as a flavoring agent.

The term “iso-sweet” as used herein is intended to mean that the subject composition has a sweetness equal to that of sugar.

For use as a co-sweetener, the Product can be used in ways known in the art of sweeteners (e.g., steam, ethanol, or alkanol aerosolized Product vapor-deposited on a co-sweetener) to coat or permeate other solid sweeteners, such granular and powdered sugar and artificial sweeteners, to be mixed as a separate powder with such solid sweeteners, to be co-crystallized with other solid sweeteners, or to be suspended or dissolved in liquid sweeteners, such as corn syrup and honey. Commercially available spray dryers used in the ethanol purge and drying stage of the industrial embodiment can typically be configured to produce a particulate size of Product appropriate for an intended use.

In some embodiments, the SG composition of the present application is used as a sweetener or a flavoring agent in an orally consumable composition.

In some embodiments, the SG composition of the present application is used as a flavoring agent that enhances or modifies the flavor of a consumable. In some embodiments, the SG composition of the present application, when used in an effective amount, modifies or enhances flavor characteristics that are sweet, fruity, floral, herbaceous, spicy, aromatic, pungent, “nut-like” (e.g., almond, pecan), “spicy” (e.g., cinnamon, clove, nutmeg, anise and wintergreen), “non-citrus fruit” flavor (e.g., strawberry, cherry, apple, grape, currant, tomato, gooseberry and blackberry), “citrus fruit” flavor (e.g., orange, lemon and grapefruit), and other useful flavors, including coffee, cocoa, peppermint, spearmint, vanilla and maple.

In some embodiments, the SG composition of the present application is used in an amount effective to sweeten or to modify or enhance the taste, odor and/or texture of an orally consumable composition.

The terminology “amount effective” or “effective amount” means an amount that produces a sensory perception. The use of an excessive amount of a SG composition will produce sweetness that may not be desired for flavor modification or enhancement, just as too much sugar can be added to a foodstuff or beverage. The amount of SG composition employed can vary over a relatively wide range, depending upon the desired sensory effect to be achieved with the orally consumable composition and the nature of the initial composition.

The SG composition can be added to a consumable composition by admixing the SG composition with the consumable composition or admixing the SG composition with a component of the consumable composition.

The SG composition can be used in tobacco and tobacco-related products selected from the group comprising cigarettes, cigars, snuffs, chewing tobacco, other tobacco goods, filters, smoking papers, and other smoking compositions. A smoking composition having a sweetened, enhanced, or modified flavor comprises a smoking filler material selected from the group consisting of tobacco, reconstituted tobacco, non-tobacco substitutes and mixtures thereof, and containing an effective amount of SG composition. “Containing” means both being included as an ingredient and being adsorbed to a material. In one variation of this embodiment, the smoking composition comprises a filter means containing a SG composition. The term “filter means”, as used herein, includes a smoking device means such as a cigar or cigarette holder having a filtering or flavoring module incorporated therein and includes acetate, cotton, charcoal and other fiber, flake or particle filtering means. In another variation of this embodiment, the smoking composition comprises a wrapper means containing a SG composition. In one variation of this embodiment, 0.003 to 0.30 parts by weight of a SG composition is added to 100 parts by weight of the smoking filler material. In a preferred variation of this embodiment, 0.015 to 0.30 parts by weight of a Product is added to 100 parts of a weight of a smoking filler material.

Those skilled in the art of flavoring tobacco understand that the effective amount of the Product added to a smoking composition may depend upon the method in which the Product is added to the smoking composition and to which portion of the smoking composition Product is added. Product can be added directly to the smoking filler material, to the filter means, or to the wrapper means of a smoking composition. Product can be added to a filter means of a smoking composition by any manner known to those skilled in the art of flavoring filter means, including but not limited to, incorporating the Product among the fibers, flakes or particles of a filter means, filling the Product between two or more layers of fibers of a fiber filter means to form a triple filter means, or inserting the Product into a smoking device means, such as a cigarette holder.

It is apparent to those skilled in the art that only a portion of the smoking filler material or filter means need be treated with a SG composition, since blending or other operations may be used to adjust the final or ultimate smoking composition within the effective or desired ranges of concentration of the SG composition. In addition to the SG composition, other flavorings or aroma additives known in the smoking composition flavoring art may be used with the SG composition and added along with Product to the smoking composition. Representative flavorings used in the smoking composition flavoring art include ethyl acetate, isoamyl acetate, propyl isobutyrate, isobutyl butyrate, ethyl butyrate, ethyl valerate, benzyl formate, menthol, limonene, cymene, pinene, linalool, geraniol, citroneilol, citral, peppermint oil, orange oil, coriander oil, lemon oil, borneol, cocoa extract, tobacco extract, licorice extract and fruit extractives.

### 5. Specific Embodiments

The following paragraphs enumerated consecutively from 1 through 192 provide for various aspects of the present application. In one embodiment, in a first paragraph (1), the present application provides:

1. A composition comprising one or more SGs from Table A.

2. The composition of Paragraph 1, comprising RA as 15-35% by weight of the total SGs in the composition and one or more SGs having a molecular weight of greater than 965 daltons as greater than 1% by weight of the total SGs in the composition.

3. The composition of Paragraph 2, wherein RA is 20-30% by weight of the total SGs in the composition.

4. The composition of any one of Paragraphs 1-3, further comprising ST.

5. The composition of Paragraph 4, wherein ST is 14-40% by weight of the total SGs in the composition.

6. The composition of Paragraph 4, wherein ST is 15-30% by weight of the total SGs in the composition.

7. The composition of Paragraph 4, wherein ST is 20-35% by weight of the total SGs in the composition.

8. The composition of any one of Paragraphs 2-7, wherein the one or more SGs having a molecular weight of greater than 965 daltons is selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, AND RO2.

9. The composition of any one of Paragraphs 2-8, wherein the one or more SGs having a molecular weight of greater than 965 daltons comprise RM.

10. The composition of Paragraph 9, wherein RM is 0-0.4% by weight of the total SGs in the composition.

11. The composition of any one of Paragraphs 1-10, wherein the one or more SGs having a molecular weight of greater than 965 daltons comprise RN.

12. The composition of Paragraph 11, wherein RN is 0-2% by weight of the total SGs in the composition.

13. The composition of any one of Paragraphs 1-12, wherein the one or more SGs having a molecular weight of greater than 965 daltons comprise RO.

14. The composition of Paragraph 13, wherein RO is 0.2-1.5% by weight of the total SGs in the composition.

15. The composition of any one of Paragraphs 1-14, wherein the one or more SGs having a molecular weight of greater than 965 daltons comprise RH.

16. The composition of Paragraph 15, wherein RH is 0-0.3% by weight of the total SGs in the composition.

17. The composition of any one of Paragraphs 1-16, wherein the one or more SGs having a molecular weight of greater than 965 daltons comprise RI.

18. The composition of Paragraph 17, wherein RI is 0-0.6% by weight of the total SGs in the composition.

19. The composition of any one of Paragraphs 1-18, wherein the one or more SGs having a molecular weight of greater than 965 daltons comprise RI3.

20. The composition of Paragraph 19, wherein RI3 is 0.4-1% by weight of the total SGs in the composition.

21. The composition of any one of Paragraphs 1-20, wherein the one or more SGs having a molecular weight of greater than 965 daltons comprise RJ.

22. The composition of Paragraph 21, wherein RJ is 0-0.7% by weight of the total SGs in the composition.

23. The composition of any one of Paragraphs 1-22, wherein the one or more SGs having a molecular weight of greater than 965 daltons comprise RK.

24. The composition of Paragraph 23, wherein RK is 1-5% by weight of the total SGs in the composition.

25. The composition of any one of Paragraphs 1-24, wherein the one or more SGs having a molecular weight of greater than 965 daltons comprise RL.

26. The composition of Paragraph 25, wherein RL is 0-0.4% by weight of the total SGs in the composition.

27. The composition of any one of Paragraphs 1-26, wherein the one or more SGs having a molecular weight of greater than 965 daltons comprise RU.

28. The composition of Paragraph 27, wherein RU is 0.1-0.5% by weight of the total SGs in the composition.

29. The composition of any one of Paragraphs 1-28, wherein the one or more SGs having a molecular weight of greater than 965 daltons comprise RV.

30. The composition of Paragraph 29, wherein RV is 0-0.6% by weight of the total SGs in the composition.

31. The composition of any one of Paragraphs 1-30, f wherein the one or more SGs having a molecular weight of greater than 965 daltons comprise RV2.

32. The composition of Paragraph 31, wherein RV2 is 0-0.6% by weight of the total SGs in the composition.

33. The composition of any one of Paragraphs 1-32, wherein the one or more SGs having a molecular weight of greater than 965 daltons comprise RY.

34. The composition of Paragraph 33, wherein RY is 0-0.4% by weight of the total SGs in the composition.

35. The composition of Paragraph 1, comprising one or more SGs having a molecular weight equal to or greater than 966 daltons.

36. The composition of Paragraph 35, wherein the percentage by weight of SGs in the composition having a molecular weight equal to or greater than 966 daltons is greater than 1% by weight of the total SGs in the composition.

37. The composition of Paragraph 35, wherein the percentage by weight of SGs in the composition having a molecular weight equal to or greater than 966 daltons is between 30 and 50%.

38. The composition of any one of Paragraphs 35-37, wherein the one or more SGs having a molecular weight equal to or greater than 966 daltons are selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, AND RO2.

39. The composition of Paragraph 1, comprising one or more SGs having a molecular weight equal to or greater than 981 daltons.

40. The composition of Paragraph 39, wherein the percentage by weight of SGs in the composition having a molecular weight equal to or greater than 981 daltons is between 30 and 50%.

41. The composition of any one of Paragraphs 39-40, wherein the one or more SGs having a molecular weight equal to or greater than 981 daltons are selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, AND RO2.

42. The composition of Paragraph 1, comprising one or more SGs having a molecular weight equal to or greater than 1097 daltons.

43. The composition of Paragraph 42, wherein the percentage by weight of SGs in the composition having a molecular weight equal to or greater than 1097 daltons is between 5 and 20%.

44. The composition of any one of Paragraphs 42-43, wherein the one or more SGs having a molecular weight equal to or greater than 1097 daltons are selected from the group consisting of RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, AND RO2.

45. The composition of Paragraph 1, comprising one or more SGs having a molecular weight equal to or greater than 1111 daltons.

46. The composition of Paragraph 45, wherein the percentage by weight of SGs in the composition having a molecular weight equal to or greater than 1111 daltons is between 4 and 20%.

47. The composition of any one of Paragraphs 45-46, wherein the one or more SGs having a molecular weight equal to or greater than 1111 daltons are selected from the group consisting of SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, AND RO2.

48. The composition of Paragraph 1, comprising one or more SGs having a molecular weight equal to or greater than 1127 daltons.

49. The composition of Paragraph 48, wherein the percentage by weight of SGs in the composition having a molecular weight equal to or greater than 1127 daltons is between 2 and 15%.

50. The composition of any one of Paragraphs 48-49, wherein the one or more SGs having a molecular weight equal to or greater than 1127 daltons are selected from the group consisting of RD, RI, RL, RI3, SG-Unk6, RQ, RI2, RQ2, RQ3, RT1, Related SG#4, RV2, RV, RY, RN, RM, 15α-OH RM, RO, AND RO2.

51. The composition of Paragraph 1, comprising one or more SGs having a molecular weight equal to or greater than 1259 daltons.

52. The composition of Paragraph 51, wherein the percentage by weight of SGs in the composition having a molecular weight equal to or greater than 1259 daltons is between 2 and 15%.

53. The composition of any one of Paragraphs 51-52, wherein the one or more SGs having a molecular weight equal to or greater than 1259 daltons are selected from the group consisting of RV2, RV, RY, RN, RM, 15α-OH RM, RO, AND RO2.

54. The composition of Paragraph 1, comprising one or more SGs having a molecular weight equal to or greater than 1273 daltons.

55. The composition of Paragraph 54, wherein the percentage by weight of SGs in the composition having a molecular weight equal to or greater than 1273 daltons is between 0.3 and 2%.

56. The composition of any one of Paragraphs 54-55, wherein the one or more SGs having a molecular weight equal to or greater than 1273 daltons are selected from the group consisting of RN, RM, 15α-OH RM, RO, AND RO2.

57. The composition of Paragraph 1, comprising one or more SGs having a molecular weight equal to or greater than 1289 daltons.

58. The composition of Paragraph 57, wherein the percentage by weight of SGs in the composition having a molecular weight equal to or greater than 1289 daltons is between 0.3 and 2%.

59. The composition of any one of Paragraphs 57-58, wherein the one or more SGs having a molecular weight equal to or greater than 1289 daltons are selected from the group consisting of RM, 15α-OH RM, RO, AND RO2.

60. The composition of Paragraph 1, comprising one or more SGs having a molecular weight equal to or greater than 1305 daltons.

61. The composition of Paragraph 60, wherein the percentage by weight of SGs in the composition having a molecular weight equal to or greater than 1305 daltons is between 0.2 and 1.5%.

62. The composition of any one of Paragraphs 60-61, wherein the one or more SGs having a molecular weight equal to or greater than 1305 daltons are selected from the group consisting of 15α-OH RM, RO, AND RO2.

63. The composition of Paragraph 1, comprising one or more SGs having a molecular weight equal to or greater than 1435 daltons.

64. The composition of Paragraph 63, wherein the percentage by weight of SGs in the composition having a molecular weight equal to or greater than 1435 daltons is 0.2 and 1.5%.

65. The composition of any one of Paragraphs 63-64, wherein the one or more SGs having a molecular weight equal to or greater than 1435 daltons are selected from the group consisting of RO and RO2.

### Other Ingredients

66. The composition of any one of Paragraphs 1-65, further comprising one or more non-SG sweeteners.

67. The composition of Paragraph 66, wherein the non-SG sweeteners comprise one or more sweeteners selected from the group consisting of cyclamates and salts thereof, sucralose, aspartame, saccharin and salts thereof, stevia (Truvia™), rebaudioside A, xylitol, acesulfame-K, neotame, N—[N-[3-(3-hydroxy-4-methoxyphenyl) propyl]-alpha-aspartyl]-L-phenylalanine 1-methyl ester (hereinafter abbreviated as “ANS9801”), glycyrrhizin, thaumatin, monellin, and combinations thereof.

68. The composition of Paragraph 66, wherein the non-SG sweeteners comprise one or more carbohydrate sweeteners and/or one or more non-carbohydrate sweeteners.

69. The composition of Paragraph 68, wherein the one or more carbohydrate sweeteners are selected from the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

70. The composition of any one of Paragraphs 1-69, further comprising one or more salts.

71. The composition of Paragraph 70, wherein the salts comprise one or more SG salts.

72. The composition of Paragraph 71, wherein the one or more SG salts comprise a salt of STB.

73. The composition of Paragraph 71, wherein the one or more SG salts comprise a sodium salt of RB.

74. The composition of any one of Paragraphs 70-73, wherein the salts comprise NaCl and/or KCl.

75. The composition of any one of Paragraphs 1-74, wherein the composition has improved solubility in a water or water/alcohol solution, wherein the compositions are stable in the water or water/alcohol solution for greater than 1, 2, 5, 10, 15, 20, 25, or 30 days.

76. The composition according to Paragraph 75, wherein the solubility is ≥1, ≥2, ≥3, ≥5, ≥10, ≥15, ≥20, ≥25, ≥30, ≥35, ≥40, ≥45, ≥50, ≥55, or ≥60 g/100 g water or water/alcohol solution.

77. The composition according to any one of Paragraphs 75-76, wherein the alcohol is selected from the group consisting of methanol, ethanol, propanol, isopropanol, n-butanol, sec-butanol, isobutanol, tert-butanol, n-pentanol, sec-pentanol, isopentanol, and neopentanol.

78. The composition according to any one of Paragraphs 75-77, wherein the water or water/alcohol solution is less than 60%, less than 50%, less than 40%, less than 30%, less than 20%, less than 10%, less than 5%, less than 2%, or less than 1% alcohol by volume.

79. The composition according to any one of Paragraphs 1-78, wherein the composition is stable in water or water/alcohol solution between 0° C. and 25° C., between 5° C. and 24° C., between 10° C. and 23° C., or between 15° C. and 22° C.

80. The composition according to any one of Paragraphs 1-79, wherein the composition is stable in water or water/alcohol solution at room or ambient temperature.

81. The composition according to any one of Paragraphs 1-80, wherein the composition is in an amorphous form, a crystal form, or mixtures thereof.

82. The composition according to any one of Paragraphs 1-81, wherein the composition contains trace or undetectable amounts of non-SG off-taste components.

### Consumables

83. An orally consumable composition comprising the composition of any one of Paragraphs 1-82.

84. The orally consumable composition of Paragraph 83, wherein the orally consumable composition is a sweetener.

85. The orally consumable composition of Paragraph 83, wherein the orally consumable composition is a flavoring agent.

### Method of Making

86. A process for the preparation of a composition according to any one of Paragraphs 1-82 with increased solubility in an aqueous solution as compared to a nontreated composition comprising the steps: mixing a SG or a composition with water to form a mixture; heating the mixture until the mixture provides a solution; cooling the solution to ambient temperature; and subjecting the solution to spray drying.

87. The process according to paragraph 86, wherein the mixture is heated to 40-100° C.

### Method of Using

88. A method for increasing the sweetness of an orally consumable composition, comprising the step of: adding an effective amount of a composition of any one of Paragraphs 1-82 to the orally consumable composition.

89. A method for increasing a taste or flavor of an orally consumable composition, comprising the step of: adding an effective amount of a composition of any one of Paragraphs 1-82 to the orally consumable composition.

90. A composition comprising one or more SGs, wherein the SG has a parent structure of formula II or formula III; wherein R1 and R2 are substituent groups individually selected from the group consisting of glucosyl (G), rhamnosyl (R), xylosyl (X), deoxy-glucosyl (dG), frucosyl (F), arabinosyl (A), galactosyl (Ga) group, and any combination thereof, and wherein the number of the glucosyl group is equal to or greater than 4.

91. The composition of Paragraph 90, wherein the number of the rhamnosyl group is equal to or greater than 1.

92. The composition of Paragraph 90, wherein the number of the xylosyl group is equal to or greater than 1.

93. The composition of Paragraph 90, wherein the number of the deoxy-glucosyl group is equal to or greater than 1.

94. The composition of Paragraph 90, wherein the number of the frucosyl group is equal to or greater than 1.

95. The composition of Paragraph 90, wherein the number of the arabinosyl group is equal to or greater than 1.

96. The composition of Paragraph 90, wherein the number of the galactosyl group is equal to or greater than 1.

97. The composition of any of Paragraphs 90-96, wherein the one or more SGs are selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, and RO2.

98. The composition of any of Paragraphs 90-97, wherein the total SGs are present at an amount of over 80% by weight of the composition.

99. The composition of any of Paragraphs 90-97, wherein the total SGs are present at an amount of over 90% by weight of the composition.

100. The composition of any of Paragraphs 90-99, wherein the one or more SGs are present at an amount of 0.1-99.9% by weight of the total SGs in the composition.

111. The composition of any of Paragraphs 90-99, wherein the one or more SGs are present at an amount of 1-30% by weight of the total SGs in the composition.

112. The composition of any of Paragraphs 90-99, wherein the one or more SGs are present at an amount of 6-23% by weight of the total SGs in the composition.

113. The composition of any of Paragraphs 90-112, wherein RD is 1.0-10.0% by weight of the total SGs in the composition.

114. The composition of any of Paragraphs 90-112, wherein RD is 2.0-8.0% by weight of the total SGs in the composition.

115. The composition of any of Paragraphs 90-112, wherein RO is 0.2-1.5% by weight of the total SGs in the composition.

116. The composition of any of Paragraphs 90-112, wherein RK is 1-5% by weight of the total SGs in the composition.

117. The composition of any of Paragraphs 90-112, wherein RV is 0-0.6% by weight of the total SGs in the composition.

118. The composition of any of Paragraphs 90-112, wherein RT is 0-0.9% by weight of the total SGs in the composition.

119. The composition of any of Paragraphs 90-112, wherein RN is 0-0.3% by weight of the total SGs in the composition.

120. The composition of any of Paragraphs 90-112, wherein RM is 0-0.4% by weight of the total SGs in the composition.

121. The composition of any of Paragraphs 90-112, wherein RJ is 0-0.3% by weight of the total SGs in the composition.

122. The composition of any of Paragraphs 90-112, wherein RW is 0-0.4% by weight of the total SGs in the composition.

123. The composition of any of Paragraphs 90-112, wherein RU2 is 0-0.5% by weight of the total SGs in the composition.

124. The composition of any of Paragraphs 90-112, wherein RY is 0-0.3% by weight of the total SGs in the composition.

125. The composition of any of Paragraphs 90-112, wherein RI is 0-0.3% by weight of the total SGs in the composition.

126. The composition of any of Paragraphs 90-112, wherein RV2 is 0-0.5% by weight of the total SGs in the composition.

127. The composition of any of Paragraphs 90-112, wherein RK2 is 0-0.5% by weight of the total SGs in the composition

128. The composition of any of Paragraphs 90-112, wherein RH is 0-0.3% by weight of the total SGs in the composition.

129. A composition comprising RA and the composition of any of Paragraphs 90-128.

130. The composition of Paragraph 129, wherein RA is 15-50 wt % of the total SGs in the composition.

131. The composition of Paragraph 129, wherein RA is 25-35 wt % of the total SGs in the composition.

132. The composition of any of Paragraphs 129-131, further comprising ST.

133. The composition of Paragraph 132, wherein the ST is 20-70 wt % of the total SGs in the composition.

134. The composition of Paragraph 132, wherein the ST is 20-45 wt % of the total SGs in the composition.

135. A sweetener composition comprising the composition of any of Paragraphs 90-134.

136. The sweetener composition of Paragraph 135, wherein the sweetener composition is dissolved in a water solution.

137. The sweetener composition of Paragraph 136, wherein the sweetener composition is present in the solution at a concentration of less than 1500 ppm, less than 1000 ppm, less than 700 ppm, less than 400 ppm or less than 200 ppm.

138. The sweetener composition of Paragraph 137, wherein the sweetener composition is present in the solution at a concentration of at least 100 ppm.

139. The sweetener composition of any of Paragraphs 135-138, wherein the sweetener composition has an improved property including lingering and upfront sweetness.

140. A flavor composition comprising the composition of any of Paragraphs 90-134.

141. The flavor composition of any of Paragraphs 140, wherein the flavor composition is dissolved in a water solution.

142. The flavor composition of Paragraph 141, wherein the flavor composition is present in the solution at a concentration of 5-10 ppm.

143. The flavor composition of any of Paragraphs 140-142, wherein the flavor composition increases the degree of sweetness.

144. A flavor composition comprising one or more SGs of any of Paragraphs 90-97.

145. The flavor composition of Paragraph 144, wherein the total SGs are present at an amount of 50-90% by weight of the flavor composition.

146. The flavor composition of Paragraph 144 or Paragraph 145, wherein RD is present at an amount of 0.2-9% by weight of the flavor composition.

147. The flavor composition of Paragraph 144 or Paragraph 145, wherein RM is present at an amount of 0.1-4.0% by weight of the flavor composition.

148. The flavor composition of Paragraph 144 or Paragraph 145, wherein RU is present at an amount of 0.1-3.0% by weight of the flavor composition

149. The flavor composition of any of Paragraphs 144-148, further comprising RA and STV.

150. The flavor composition of Paragraph 149, wherein RA is present at an amount of 20-30% by weight of the flavor composition.

151. The flavor composition of Paragraph 149, wherein STV is present at an amount of 8-40% by weight of the flavor composition.

152. The flavor composition of any of Paragraphs 144-151, further comprising RF, RC, Dulc A, RB and STB.

153. The flavor composition of any of Paragraphs 144-152, wherein the flavor composition is dissolved in a water solution.

154. The flavor composition of Paragraph 153, wherein the flavor composition is present in the solution at a concentration of less than 60 ppm, less than 70 ppm, less than 75 ppm, less than 100 ppm, less than 200 ppm or less than 300 ppm.

155. The flavor composition of any of Paragraphs 144-154, wherein the flavor composition increases the degree of sweetness.

156. A composition comprising two groups of SGs, the first group of SGs comprises one or more SGs selected from any of Paragraphs 90-97, and the second group of SGs comprises one or more SGs selected from the groups essentially consist of RA, RB, Stevioside, RC, RD, RM or the combination thereof.

157. The composition of Paragraph 156, wherein the ratio of the weight of the first group and the second group of SG is 1:99, 2:98, 3:97, 4:96; 5:95; 6:94; 7:93; 8:94; 9:91; 10:90; 11:89; 12:88; 13:87; 14:86; 15:85; 16:84; 17:83; 18:82; 19:81; 20:80; 21:79; 22:78; 23:77; 24:76; 25:75; 26:74; 27:73; 28:72; 29:71; 30:70; 31:69; 32:68; 33:67; 34:66; 35:65; 36:64; 37:63; 38:62; 39:61; 40:60; 41:59; 42:58; 43:57; 44:56; 45:55; 46:54; 47:53; 48:52; 49:51; 50:50; 51:49; 52:48; 53:47; 54:45; 55:45; 56:44; 57:43; 58:42; 59:41; 60:40; 61:39; 62:38; 63:37; 64:36; 65:35; 66:37; 67:33; 68:32; 69:31; 70:30; 71:29; 72:28; 73:27; 74:26; 75:25; 76:24; 77:23; 78:22; 79:21; 80:20; 81:19; 82:18; 83:17; 84:16; 85:15; 86:14; 87:13; 88:12; 89:11; 90:10; 91:9; 92:8; 93:7; 94:6; 95:5; 96:4; 97:3; 98:2 or 99:1.

158. A composition comprising the SGs listed in Table 16, wherein the amount of each SG in the composition is within 50, 40, 30, 10, 5, 4, 3, 2, or 1% of the amount listed in the table.

159. A composition comprising the SGs listed in Table 17, wherein the amount of each SG in the composition is within 50, 40, 30, 10, 5, 4, 3, 2, or 1% of the amount listed in the table.

160. A composition comprising the SGs listed in Table 18, wherein the amount of each SG in the composition is within 50, 40, 30, 10, 5, 4, 3, 2, or 1% of the amount listed in the table.

161. A composition comprising the SGs listed in Table 19, wherein the amount of each SG in the composition is within 50, 40, 30, 10, 5, 4, 3, 2, or 1% of the amount listed in the table.

162. A composition comprising the SGs listed in Table 20, wherein the amount of each SG in the composition is within 50, 40, 30, 10, 5, 4, 3, 2, or 1% of the amount listed in the table.

163. A composition comprising the SGs listed in Table 21, wherein the amount of each SG in the composition is within 50, 40, 30, 10, 5, 4, 3, 2, or 1% of the amount listed in the table.

164. A composition comprising the SGs listed in Table 22, wherein the amount of each SG in the composition is within 50, 40, 30, 10, 5, 4, 3, 2, or 1% of the amount listed in the table.

165. A composition comprising the SGs listed in Table 23, wherein the amount of each SG in the composition is within 50, 40, 30, 10, 5, 4, 3, 2, or 1% of the amount listed in the table.

166. A composition comprising the SGs listed in Table 24, wherein the amount of each SG in the composition is within 50, 40, 30, 10, 5, 4, 3, 2, or 1% of the amount listed in the table.

167. A composition comprising the SGs listed in Table 25, wherein the amount of each SG in the composition is within 50, 40, 30, 10, 5, 4, 3, 2, or 1% of the amount listed in the table.

168. A composition comprising the SGs listed in Table 26, wherein the amount of each SG in the composition is within 50, 40, 30, 10, 5, 4, 3, 2, or 1% of the amount listed in the table.

169. A pooled composition comprising the SGs of Tables 16-23, wherein the amount of each SG in the pooled composition is within 50, 40, 30, 10, 5, 4, 3, 2, or 1% of the pooled amounts combined at a 1:1:1:1:1:1:1:1 ratio.

170. A pooled composition comprising the SGs of Tables 24-26, wherein the amount of each SG in the pooled composition is within 50, 40, 30, 10, 5, 4, 3, 2, or 1% of the pooled amounts combined at a 1:1:1 ratio.

171. A pooled composition comprising SGs A1-1, A1-2, A1-3, A1-4 and A1-5 of Table 52, wherein the amount of each SG in the pooled composition is within 50, 40, 30, 10, 5, 4, 3, 2, or 1% of the pooled amounts combined at a 1:1:1:1:1 ratio.

172. A pooled composition comprising SGs A2-1, A2-2, A2-3, A2-4 and A2-5 of Table 52, wherein the amount of each SG in the pooled composition is within 50, 40, 30, 10, 5, 4, 3, 2, or 1% of the pooled amounts combined at a 1:1:1:1:1 ratio.

173. The composition of any one of the above numbered paragraphs, wherein the one or more SGs having high molecular weight comprise 0.1-99.9% by weight of the total SGs in the composition.

174. The composition of any one of the above numbered paragraphs, wherein the one or more SGs having high molecular weight comprise 4-20% by weight of the total SGs in the composition.

175. The composition of any one of the above numbered paragraphs, wherein the one or more SGs having high molecular weight comprise 3-20% by weight of the total SGs in the composition.

176. The composition of any one of the above numbered paragraphs, wherein the one or more SGs having high molecular weight comprise 0.3-2% by weight of the total SGs in the composition.

177. A composition comprising SGs from table A, wherein the composition comprises RA and the composition of any one of the above numbered paragraphs.

178. The composition of Paragraph 177, wherein RA comprises 15-50 wt % of the total SGs in the composition.

179. The composition of Paragraph 177, wherein the RA comprises 20-30 wt % of the total SGs in the composition.

180. The composition of any one of the above numbered paragraphs, wherein the composition further comprises ST.

181. The composition of any one of the above numbered paragraphs, wherein the ST comprises 15-30 wt % of the total SGs in the composition.

182. The composition of any one of the above numbered paragraphs, wherein the composition has an improved taste profile including aftertaste, bitterness and/or lingering compared to a composition without the composition of any one of the above numbered paragraphs.

183. The composition of any one of the above numbered paragraphs, wherein the composition has an increased solubility in an aqueous solution compared to a composition without the composition of any one of the above numbered paragraphs.

184. The orally consumable composition as recited in the above numbered paragraphs, wherein the one or more SGs having a molecular weight of greater than 965 daltons constitute at least 5 ppm, 10 ppm, 20 ppm, 30 ppm, 40 ppm, 50 ppm, 60 ppm, 70 ppm, 80 ppm, 90 ppm, 100 ppm, 150 ppm, 200 ppm, 300 ppm, 400 ppm, 600 ppm, 800 ppm, 1000 ppm or 1200 ppm of the total orally consumable composition.

185. A method for improving the taste profile including aftertaste, bitterness and/or lingering of a SGs composition, comprising the step of adding an effective amount of the composition of any of the above numbered paragraphs to the SGs composition.

186. A method for increasing the solubility of a SGs composition in an aqueous solution, comprising the step of adding an effective amount of the composition of any of the above numbered paragraphs to the SGs composition.

187. The method of Paragraphs 185 or 186, wherein the SGs composition comprises RA and/or ST.

188. The method of preparation of a SG composition as recited in the above numbered paragraphs, further comprising the step of removing non-steviol off-taste compounds.

189. The method of Paragraph 188, wherein the off-taste compound has a bitter taste.

190. A method of preparing a composition according to any one of claims 1-41, comprising the steps: dissolving the crude extract of stevia with a first ethanol aqueous solution to form a mixture, heating the mixture until the mixture provides a solution; cooling the solution to ambient temperature; separating the supernatant and precipitant from the solution; subjecting the supernatant to drying to form a powder; dissolving the powder with water to form a second solution; treating the second solution with macroporous resin to form a material; and desorbing the material with a second ethanol aqueous solution.

191. The method of Paragraph 190, wherein the concentration of the second ethanol aqueous solution is above 0 to less than 50 wt %, preferably 20-50 wt %, more preferably 25-35 wt %.

192. The method of Paragraph 190, wherein the concentration of the second ethanol aqueous solution is 50-100 wt %, preferably 60-80 wt %, more preferably 65-75 wt %.

193. The composition of any one of the above numbered paragraphs, wherein the composition comprises 20-27 wt % RA, 8-14 wt % RC, 1.5-8 wt % RD, 0.9-4.3% wt % RM, 1.4-2.6 wt % RF, 0.4-1.2 wt % RE, 0.5-1.4 wt % RN, 14-34 wt % ST, 0.4-1.1 wt % Rubusoside, 0.4-1.2 wt % Dulcoside A, wherein the total steviol glycosides are 77-96 wt % of the total composition.

194. The composition of any one of the above numbered paragraphs, wherein the composition comprises 20-35 wt % RA, 5-15 wt % RC, 1-10 wt % RD, 0.5-10% wt % RM, 1-4 wt % RF, 0.1-2 wt % RE, 0.1-2 wt % RN, 14-40 wt % ST, 0.1-2 wt % Rubusoside, 0.1-2 wt % Dulcoside A, wherein the total steviol glycosides are 70-99 wt % of the total composition.

195. The composition of any one of the above numbered paragraphs, wherein the composition comprises 20-30 wt % RA, 5-15 wt % RC, 1-10 wt % RD, 0.5-10% wt % RM, 1-4 wt % RF, 0.1-2 wt % RE, 0.1-2 wt % RN, 14-40 wt % ST, 0.1-2 wt % Rubusoside, 0.1-2 wt % Dulcoside A, wherein the total steviol glycosides are 70-99 wt % of the total composition.

196. The composition of any one of the above numbered paragraphs, wherein the composition comprises 20-30 wt % RA, 5-15 wt % RC, 1-10 wt % RD, 0.5-10% wt % RM, 1-4 wt % RF, 0.3-0.9 wt % RE, 0.1-2 wt % RN, 14-40 wt % ST, 0.1-2 wt % Rubusoside, 0.1-2 wt % Dulcoside A, wherein the total steviol glycosides are 70-99 wt % of the total composition.

197. The composition of any one of the above numbered paragraphs, wherein the composition comprises 20-30 wt % RA, 5-15 wt % RC, 1-10 wt % RD, 0.5-10% wt % RM, 1-4 wt % RF, 0.3-0.9 wt % RE, 0.1-2 wt % RN, 15-30 wt % ST, 0.1-2 wt % Rubusoside, 0.1-2 wt % Dulcoside A, wherein the total steviol glycosides are 70-99 wt % of the total composition.

198. The composition of any one of the above numbered paragraphs, wherein the composition comprises 20-30 wt % RA, 5-15 wt % RC, 1-10 wt % RD, 0.5-10% wt % RM, 1-4 wt % RF, 0.3-0.9 wt % RE, 0.1-2 wt % RN, 20-35 wt % ST, 0.1-2 wt % Rubusoside, 0.1-2 wt % Dulcoside A, wherein the total steviol glycosides are 70-99 wt % of the total composition.

199. The composition of any one of the above numbered paragraphs, wherein the composition comprises 15-40 wt % RA, 1-20 wt % RC, 0.1-15 wt % RD, 0.1-15% wt % RM, 0.1-10 wt % RF, 0.1-3 wt % RE, 0.1-3 wt % RN, 10-45 wt % ST, 0.1-3 wt % Rubusoside, 0.1-3 wt % Dulcoside A, wherein the total steviol glycosides are 70-99 wt % of the total composition.

200. The composition of any one of the above numbered paragraphs, wherein the composition comprises 10-45 wt % RA, 0.1-25 wt % RC, 0.1-20 wt % RD, 0.1-20% wt % RM, 0.1-15 wt % RF, 0.1-4 wt % RE, 0.1-4 wt % RN, 5-50 wt % ST, 0.1-4 wt % Rubusoside, 0.1-4 wt % Dulcoside A, wherein the total steviol glycosides are 70-99 wt % of the total composition.

201. The composition of any one of the above numbered paragraphs, wherein the composition comprises 15-50 wt % RA, 0.1-30 wt % RC, 0.1-25 wt % RD, 0.1-25% wt % RM, 0.1-20 wt % RF, 0.1-5 wt % RE, 0.1-5 wt % RN, 5-55 wt % ST, 0.1-5 wt % Rubusoside, 0.1-5 wt % Dulcoside A, wherein the total steviol glycosides are 70-99 wt % of the total composition.

202. The composition of any one of the above numbered paragraphs, wherein the composition comprises 25-30 wt % RA, 7-12 wt % RC, 5-10 wt % RD, 5-10% wt % RM, 2-4 wt % RF, 1-2 wt % RE, 1-2 wt % RN, 20-35 wt % ST, 1-2 wt % Rubusoside, 1-2 wt % Dulcoside A, wherein the total steviol glycosides are 70-99 wt % of the total composition.

203. The composition of any one of the above numbered paragraphs, wherein the composition comprises 25-30 wt % RA, 7-10 wt % RC, 7-10 wt % RD, 7-10% wt % RM, 3-4 wt % RF, 1-2 wt % RE, 1-2 wt % RN, 25-35 wt % ST, 1-2 wt % Rubusoside, 1-2 wt % Dulcoside A, wherein the total steviol glycosides are 70-99 wt % of the total composition.

204. The composition of any one of the above numbered paragraphs, wherein the composition comprises 20-30 wt % RA, 0.3-0.9 wt % RE, and 15-30 wt % ST or 20-35 wt % ST.

The embodiments of the application will be further described with reference to the following non-limiting Examples. It will be apparent to those skilled in the art that many changes can be made in the embodiments described without departing from the scope of the present application. Thus the scope of the present application should not be limited to the embodiments described in this application, but only by embodiments described by the language of the claims and the equivalents of those embodiments. Unless otherwise indicated, all percentages are by weight.

### EXAMPLES

### Example 1. General Process for Preparing SGs with Improved Solubility

A SG or SGs were mixed with water. The mixture was then heated to 60-70° C. with stirring, until the mixture was completely dissolved to obtain a clear solution. The solution was then stirred for an additional 30 min at 60-70° C., and then was then cooled to ambient temperature. The solution was then spray dried using a L-117 (Beijing Laiheng Scientific Co., Ltd) with inlet temperature: 135° C.; outlet temperature: 90° C.; feeding speed: 200 mL/h; pressure: 1.8 KPa; to obtain the product, in the form of white powders (yield=95 wt %).

Various SGs and SG compositions with improved solubility were prepared by using raw materials listed in Table 1. The materials RA60, RA80 and RA97 are commercially available from Sweet Green Fields. These raw materials are used in the following Examples 2-6 as indicated.

TABLE 1
Raw materials

| | | RA | RB | RD | Total stevia |
|---|---|---|---|---|---|
| Component | Lot | (%) | (%) | (%) | glycosides (%) |
| RA | EPC094-17-03 | 99.56 | — | — | — |
| RB | EPC006-30-03 | — | 99.3 | — | — |
| RD | EPC094-28-11 | — | — | 95.10 | — |
| RA + RD | CT001-131105 | 90.1 | — | 7.0 | 98.4 |
| RA + RB + RD | CT001-131108 | 79.8 | 10.3 | 6.3 | 96.8 |
| RA60 | CT001-120301 | 66.52 | — | 1.40 | 97.34 |
| RA80 | CT001-140203 | 80.2 | 1.22 | 0.88 | 95.8 |
| RA97 | CT001-130602 | 98.0 | — | — | — |

### Example 2. Evaluation of Solubility of the SGs and SG Compositions with Improved Solubility

The solubilities of SGs and SG compositions listed in Table 1 were evaluated according to the following procedure. Raw materials listed in Table 1 were treated and spray dried according to Example 1 and then dissolved in water at a weight ratio of 1:10 and the mixture was heated to 70° C. until the solid was completely dissolved, to obtain an aqueous solution. The solution was cooled to ambient temperature, and the stability (i.e., the period until precipitation) of the solution was observed. The solubility results of the treated SGs and SG compositions are shown in Table 2.

TABLE 2

| Sample | | | | Soluble at | Stability at | |
|---|---|---|---|---|---|---|
| No. | RA (%) | RB (%) | RD (%) | 70° C. | RT | |
| 1 | 70 | 18 | 12 | yes | 20 | h |
| 2 | 90 | 6 | 4 | yes | >5 | days |
| 3 | 88 | 5 | 7 | yes | >5 | days |
| 4 | 78 | 15 | 7 | yes | >5 | days |
| 5 | 87 | 11 | 2 | yes | >5 | days |
| 6 | 76 | 9 | 15 | yes | >5 | days |
| 7 | 90 | 10 | 0 | yes | >15 | days |
| 8 | 78* | 15 | 7 | yes | >5 | days |
| 9 | 78** | 15 | 7 | yes | >5 | days |
| 10 | 78*** | 15 | 7 | yes | >5 | days |
| 11 | 0 | 50 | 50 | no | — | |
| 12 | 0 | 100 | 0 | no | — | |
| 13 | 0 | 0 | 100 | no | — | |
| 14 | 100 | 0 | 0 | yes | 1 | hour |

*RA97,
**RA80,
***RA60

The results of Example 2 show specific pairings of treated SGs (Samples 1-10) that had improved solubility in an aqueous solution in comparison with SGs comprising rebaudioside B and D, and rebaudioside A, B, and D individually (Samples 11-14). RA, RB, RD, and 50:50 RB/RD have poor solubility whereas the SGs mixtures comprising RA, RB, and RD wherein RB is 0-20%, RD is 0-15%, and RB+RD<30% have the most improved solubility.

### Example 3. Evaluation of Solubility of SGs with Improved Solubility

The mixture in Table 2, wherein RA:RB:RD=78/15/7 (Sample 4) that was first heat treated and spray dried according to Example 1 was formulated into aqueous solutions at various concentrations, and the maximum solubility, temperature, and stability were determined and summarized in the Table 3.

TABLE 3

| Content | | |
|---|---|---|
| (g/100 ml water) | Soluble temperature | Stability |
| 15 | soluble at 80° C. | >2.5 days |
| 20 | soluble at 85° C. | >2 days |
| 25 | soluble at 90° C. | >2 days |
| 30 | soluble at 90° C. | >2 days |
| 35 | soluble at 90° C. | >1.5 days |
| | (slightly cloudy) | |

The results show that the solubility of the mixture has an upper limit of 30 g/100 ml, and the stability of the obtained 30% wt/wt solution is more than 2 days at ambient temperature.

### Example 4. Evaluation of Solubility of SG Compositions with Improved Solubility

SGs with further improved solubility that were first heat treated and spray dried according to Example 1 were evaluated for stability in various aqueous concentrations shown in Table 4.

TABLE 4

| | 20 g/100 g | 30 g/100 g | 50 g/100 g | 60 g/100 g |
|---|---|---|---|---|
| Lot | water | water | water | water |
| CT001-131108 | — | >30 days | >30 days | >30 days |
| CT001-131105 | 6 days | 3 days | 3 days | — |

The results demonstrate that Lot CT001-131108, a SG composition comprising RA:RB:RD=80/10/6 is stable in aqueous solution for greater than 30 days at a concentration of 60 g/100 g water.

### Example 5. Powder XRD of the SG Composition with Improved Solubility

SG compositions with improved solubility that were first heat treated and spray dried according to Example 1 were subjected to Powder XRD. The HPLC results are shown in Table 5. HPLC was conducted using a SUPELCOSIL™ LC-NH₂ column at 40° C. with 80:20 ACN/water mobile phase adjusted to pH 3 with 85% phosphoric acid. The flow rate was adjusted so that the retention time of standard RA (Wako Ltd.) was 21 min.

TABLE 5

| | | | RD |
|---|---|---|---|
| Lot | RA (%, by HPLC) | RB (%, by HPLC) | (%, by HPLC) |
| 094-39-01 | 79.83 | 12.66 | 5.36 |
| 094-39-02 | 80.34 | 12.82 | 5.32 |

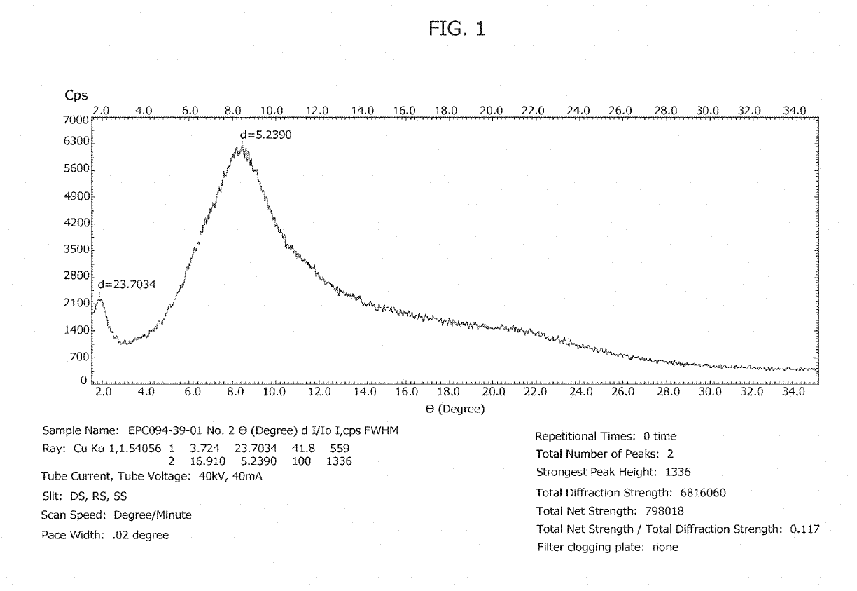

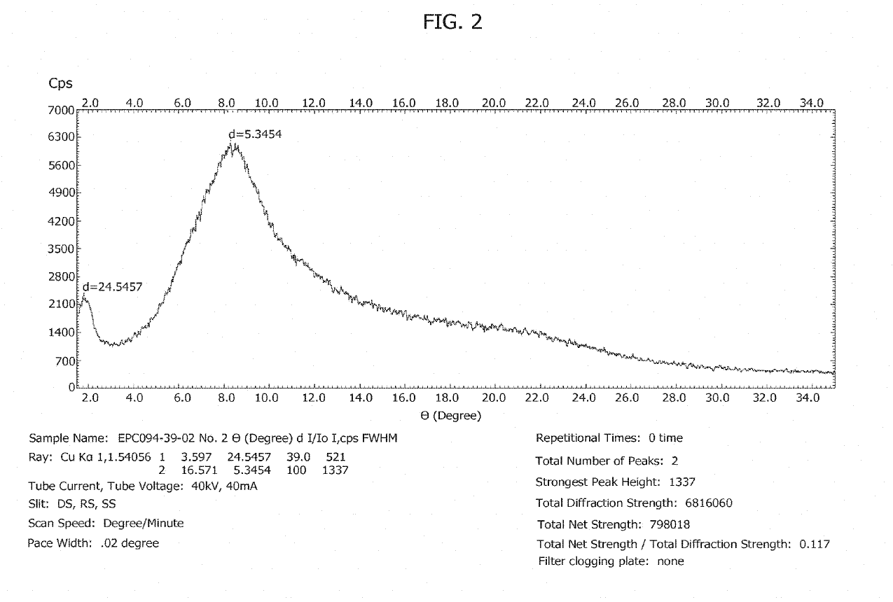

It can be seen from the Powder XRD (FIG. 1 and FIG. 2) that the spectrum of the Stevia glycoside compositions with improved solubility show an amorphous product, not a crystalline polymorph, and thus are different from the soluble forms described in the disclosed references.

### Example 6. Several SGs were Mixed Using High Purity RA, RB, RD, and Stevioside

SGs that have not been heat treated and spray dried according to Example 1 were mixed with water and heated to 70° C. to give the following mixtures, respectively. The composition of each SG, mixture concentration, solubility, and stability are shown in Table 6.

TABLE 6

| | | Concentration | Soluble at | | |
|---|---|---|---|---|---|
| Composition | Ratio | (g/100 mL water) | 70° C. | Stability at RT | |
| RA/RD | 85/15 | 10 | Yes | >6 | days |
| RA/RD | 90/10 | 10 | Yes | 5 | days |
| RA/SS | 90/10 | 10 | Yes | 17 | hours |
| RA/SS | 95/5 | 10 | Yes | 9 | hours |
| RA/RB | 85/15 | 10 | Yes | >6 | days |
| RA/RB | 95/5 | 10 | Yes | 45 | hours |
| RA/RB/RD | 90/6/4 | 20 | Yes | 43 | hours |

| | | | | |
|---|---|---|---|---|
| RB/RD | 70/30 | 5 | No | — |
| RB/SS | 90/10 | 5 | No | — |

SS showed some improvement to the solubility of RA. For the RA/RB system, the solubility of RA was minimized until the ratio of RB reached 10% or greater. For the RA/RD system, the solubility of RA was minimized until the ratio of RD reached 15% or greater.

### Example 7. Additional RA/RB Stability Data

RA-RB-1 and RA-RB-3 were prepared according to the current spray drying process and tested for concentration dependent solubility.

TABLE 7

| Sample | Lot# | RA | RB |
|---|---|---|---|
| RA-RB-1 | EPC116-44-02 | 89.95% | 6.61% |
| RA-RB-3 | EPC137-08-01 | 78.12% | 19.35% |

TABLE 8

| RA-RB-1 | Solid/liquid ratio | | Stability (days) |
|---|---|---|---|
| Spray dried | 5% | Dissolved | >30 days |
| | 1% | at room | >30 days |
| | 0.50% | temperature | >30 days |
| | 10% | | >30 days |
| RA-RB-3 | Solid/liquid ratio | | Stability |
| Spray dried | 1% | Dissolved | 2 hours |
| | 5% | at room | 2 hours |
| | 10% | temperature | 1.5 hours |
| | 20% | | 1 hours |
| | 30% | | Slightly turbid |

As shown above, as the concentration of RA-RB-1 reaches 10%, the solution remains stable for over 30 days. The initial solubility of RA-RB-3 reaches 20%, but is less stable.

### Example 8. Melting Point Determinations

Melting points of untreated and treated SGs and SG compositions were taken and disclosed in Table 9. Melting points were determined using a X-4 (Beijing Tech Instrument Co., Ltd.) with heating speed of 1° C./min.

TABLE 9

| Sample | Lot# | RA | RB | RD | Melting point |
|---|---|---|---|---|---|
| Untreated | | | | | |
| RA | EPC094-17-03 | 99.6% | | | 235-237° C. |
| RB | EPC082-31-03 | | 92.74% | | 224-226° C. |
| RD | EPC094-28-11 | | | 95.10% | 285-287° C. |
| RA/RB/RD | | 79% | 10% | 6% | 233-236° C. |
| RA/RB | | 90% | 6.6% | | 234-236° C. |
| Treated | | | | | |
| RA-RB-1 | EPC116-44-02 | 89.95% | 6.61% | | 224-227° C. |
| RA-RB-2 | EPC116-32-01 | 93.05% | 5.00% | | 223-226° C. |
| RA/RB/RD | EPC130-36-03 | 79.08% | 10.28% | 6.25% | 224-227° C. |
| RA-RB-3 | EPC137-08-01 | 78.12% | 19.35% | | 221-223° C. |
| RA/RD | CT001-130511 | 90.0% | | 6.1% | 224-226° C. |

The melting point of treated samples was lower than the melting points of RA and untreated samples, demonstrating an affirmative change in structure of the treated compositions.

### Example 9

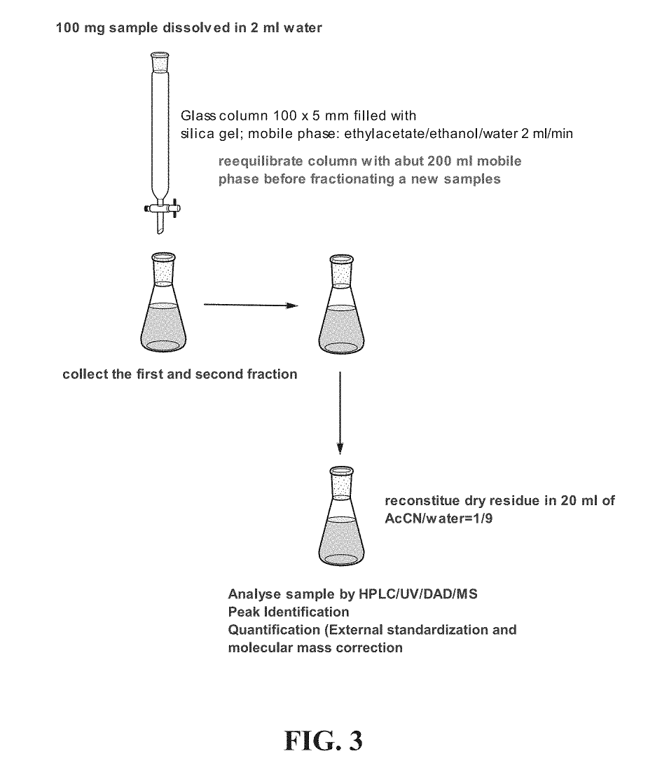

An analytical methodology was carried out to evaluate the SGs present in a number of different mother liquid samples. FIG. 3 is an overview of an analytical methodology for determining the reaction products formed from SG starting materials subjected to hydrolysis.

Materials:

Reference standards for steviolglycosides (Reb A, Reb B, Reb C, Reb D, Reb E, Reb F, Reb G, Reb M, Reb N) were obtained from Chromadex (LGC Germany). Solvents and reagents (HPLC grade) were obtained from VWR (Vienna) or Sigma-Aldrich (Vienna). Davisil Grade 633 (high-purity grade silica gel, pore size 60 Å, 200-425 mesh particle size was obtained from Sigma-Aldrich (Vienna).

Sample Preparation:

300 mg sample was dissolved in 20 ml Acetonitrile/H₂O=9/1 (v/v).

HPLC-Method:

The HPLC system consisted of an Agilent 1100 system (autosampler, ternary gradient pump, column thermostat, VWD-UV/VIS detector, DAD-UV/VIS detector) connected in-line to an Agilent mass spectrometer (ESI-MS quadrupole G1956A VL). For HPLC analysis 150 mg of the corresponding sample was dissolved in Acetonitrile (1 ml) and filled up to 10 ml with H2O.

The samples were separated at 0.8 ml/min on a Phenomenex Synergi Hydro-RP (150×3 mm) followed by a Macherey-Nagel Nucleosil 100-7 C18 (250×4.6 mm) at 45° C. by gradient elution. Mobile Phase A consisted of a 0.01 molar NH4-Acetate buffer (native pH) with 0.1% acetic acid, 0.05% trimethylamine and 0.001% dichloromethane. Mobile Phase B consisted of 0.01 molar NH4-Acetate buffer (native pH) and Acetonitrile (1/9 v/v) with 0.1% acetic acid, 0.05% trimethylamine and 0.001% dichloromethane. The gradient started with 22% B, was increased linearly in 20 minutes to 45% B and kept at this condition for another 15 minutes. Injection volume was set to 10 μl.

The detectors were set to 210 nm (VWD), to 205 and 254 nm (DAD with spectra collection between 200-600 nm) and to ESI negative mode TIC m/z 300-1500, Fragmentor 200, Gain 2 (MS, 300° C., nitrogen 12 l/min, nebulizer setting 50 psig. Capillary voltage 4500 V).

Detection at 210 nm was used to quantify the chromatograms, the MS-spectra were used to determine the molar mass and structural information of individual peaks. Detection at 254 nm was used to identify non-steviolglycoside peaks.

Identification and Quantification:

Steviol-glycosides were identified by comparison of retention times to authentic reference standards and/or by evaluation of the mass spectra obtained (including interpretation of the fragmentation pattern and double charged ions triggered by the presence of dichloromethane).

Steviol-glycosides were quantified against external standards. In case that no reference standard was available quantification was performed against Reb-A.

The maximum calibration range of reference standards was in a range 0.1-50 mg/10 ml (dissolved in Acetonitrile/H2O=9/1 (v/v)).

### Example 10. SG Content Analysis

A series of exemplary compositions were analyzed for their content of various SG compounds. Compositions as described here can be obtained by extraction of leaves, then using the resin for further separation, or by using a composition as a raw material for purification that is a remnant of a purification of RA and/or RA/ST.

Multiple samples of exemplary liquid preparations were subjected to HPLC to determine the SG composition of the preparations. The HPLC was calibrated using standards of RA, RB, RC, RD, RE, RF, RG, RM, and RN.

Materials

Reference standards for steviolglycosides (RA, RB, RC, RD, RE, RF, RG, RM, RN) were obtained from Chromadex (LGC Germany). Solvents and reagents (HPLC grade) were obtained from VWR (Vienna) or Sigma-Aldrich (Vienna).

Davisil Grade 633 (high-purity grade silica gel, pore size 60 Å, 200-425 mesh particle size was obtained from Sigma-Aldrich (Vienna).

Sample Preparation

300 mg sample was dissolved in 20 ml Acetonitrile/H₂O=9/1 (v/v).

HPLC-Method

The HPLC system consisted of an Agilent 1100 system (autosampler, ternary gradient pump, column thermostat, VWD-UV/VIS detector, DAD-UV/VIS detector) connected in-line to an Agilent mass spectrometer (ESI-MS quadrupole G1956A VL). For HPLC analysis 150 mg of the corresponding sample was dissolved in Acetonitrile (1 ml) and filled up to 10 ml with H2O.

Samples were separated at 0.8 ml/min on a Phenomenex Synergi Hydro-RP (150×3 mm) followed by a Macherey-Nagel Nucleosil 100-7 C18 (250×4.6 mm) at 45° C. by gradient elution.

Mobile Phase A consisted of a 0.01 molar NH4-Acetate buffer (native pH) with 0.1% acetic acid, 0.05% trimethylamine and 0.001% dichloromethane. Mobile Phase B consisted of 0.01 molar NH4-Acetate buffer (native pH) and Acetonitrile (1/9 v/v) with 0.1% acetic acid, 0.05% trimethylamine and 0.001% dichloromethane. The gradient started with 22% B, was increased linearly in 20 minutes to 45% B and kept at this condition for another 15 minutes. Injection volume was set to 10 μl.

The detectors were set to 210 nm (VWD), to 205 and 254 nm (DAD with spectra collection between 200-600 nm) and to ESI negative mode TIC m/z 300-1500, Fragmentor 200, Gain 2 (MS, 300° C., nitrogen 12 l/min, nebulizer setting 50 psig. Capillary voltage 4500 V).

Detection at 210 nm was used to quantify the chromatograms, the MS-spectra were used to determine the molar mass and structural information of individual peaks. Detection at 254 nm was used to identify non-SG peaks.

Identification and Quantification

SGs were identified by comparison of retention times to authentic reference standards and/or by evaluation of the mass spectra obtained (including interpretation of the fragmentation pattern and double charged ions triggered by the presence of dichloromethane).

Steviol-glycosides were quantified against external standards. In case that no reference standard was available quantification was performed against Reb-A.

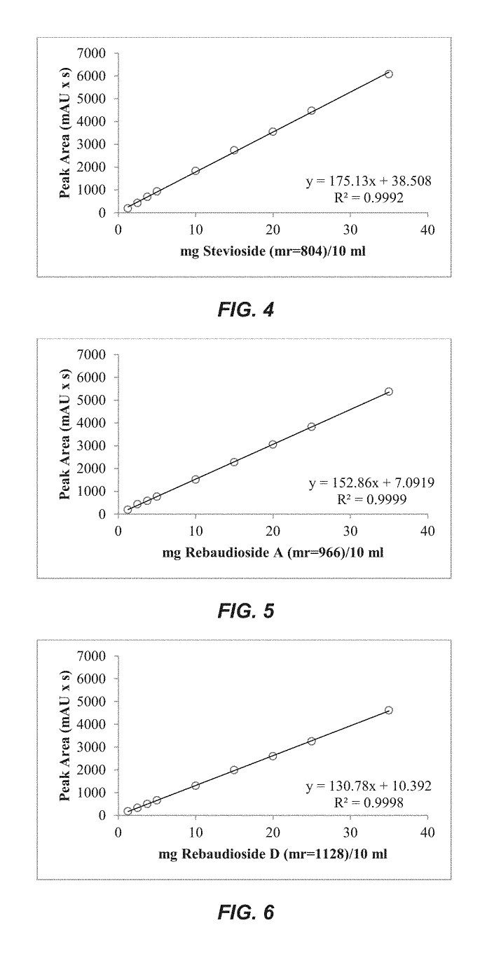

The maximum calibration range of reference standards was in a range 0.1-50 mg/10 ml (dissolved in Acetonitrile/H2O=9/1 (v/v)). FIGS. 4-6 show exemplary standard plots for stevioside (FIG. 4), RA (FIG. 5), and RD (FIG. 6).

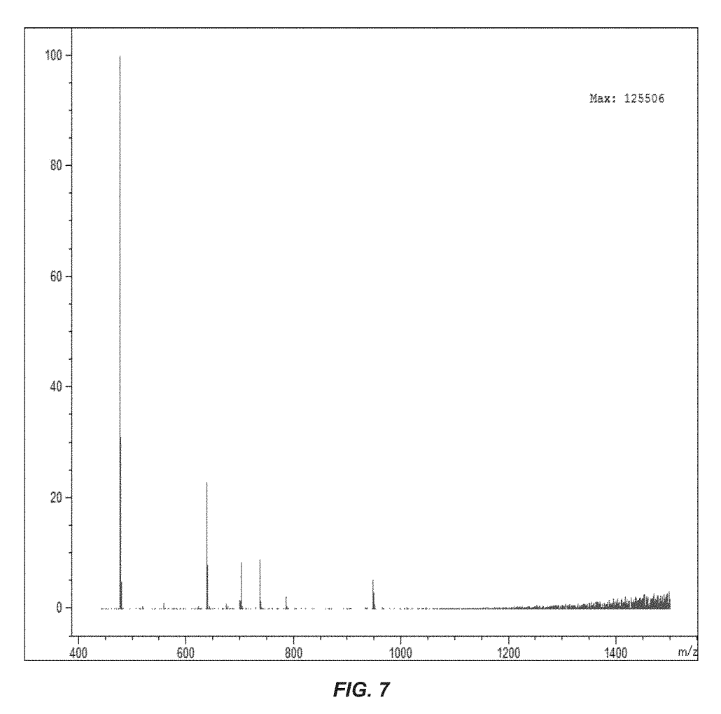

FIG. 7 is an exemplary peak identification plot. In regard to single charged ions: m/z 949=[M-H]-; m/z 787=[M-H-Hexose]-; m/z 641=[M-H-Hexose-Rhamnose/Deoxyhesose]-; and m/z 479=[M-H-Hexose-Rhamnose/Deoxyhesose-Hexose]-. In regard to adduct ions: m/z 701=m/z 641+acetic acid; and m/z 736=m/z 701+Cl−. In regard to peak identification, molar mass 950 (ST plus 3 glucose plus one Rhamnose/Deoxyhesose.

Table 10 shows the SG composition of sample SCJ2017625-26 (Available from Sweet Green Fields. Prepare according to the method described in Example 11. It's the spray-dried powder of 70% ethanol desorption solution). Total SG content was 95.5% (56.7%+24.1%+14.7%=95.5%). The sum percentage of SGs obtained by external standardization using authentic reference standards was 56.7% (including RA, RB, RC, RD, RF, Dulc A, RU, STV and STB). The sum percentage of SGs with qualification of structure by ESI-MS obtained by external standardization using Reb-A as reference standard and mass correction for calculation was 24.1% (including REB O, REB M, REB N etc.). The sum percentage of SGs without qualification of structure obtained by external standardization using Reb-A as reference standard was 14.7%.

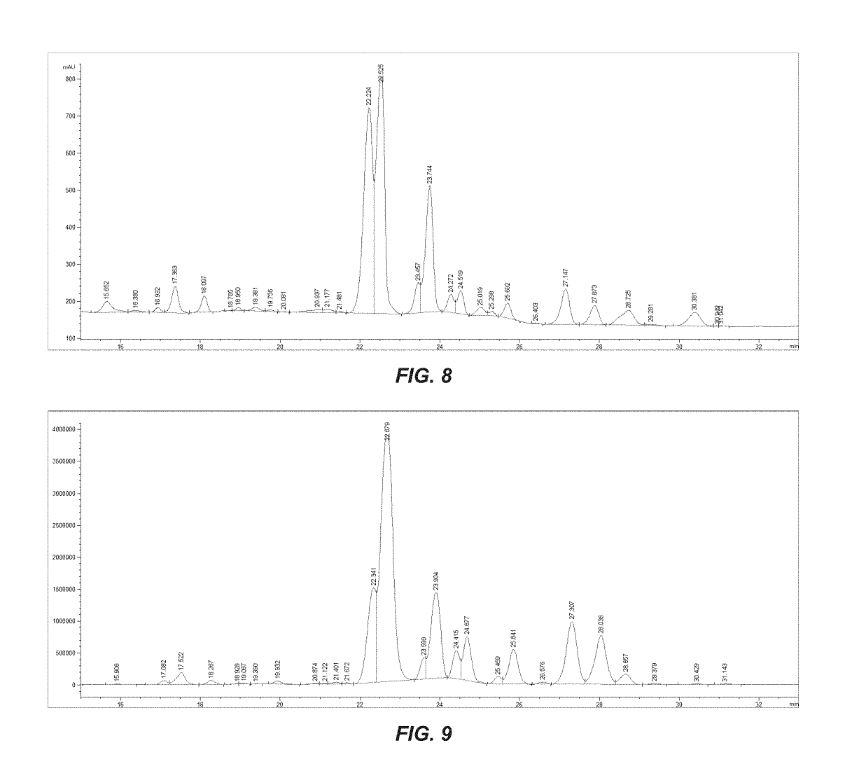

FIG. 8 shows the chromatogram for 150 mg of sample SCJ2017625-26/10 ml. FIG. 9 shows the chromatogram of the total ion current for sample SCJ2017625-26.

TABLE 10
Steviol-glycosides in sample SCJ2017625-26 (sample weight 149.3 mg/10 ml)

| | Area | mg/ | | MS information | | Identified | | |
|---|---|---|---|---|---|---|---|---|
| Rt | 210 nm | 10 ml | % m/m | (m/z) | [M − H]⁻ | compound | R1 (C-19) | R2 (C-13) |
| 15.65 | 580.5 | 2.14 | 1.46 | 1127 803 641 | 1127 | Reb I3 (MS) | [Glcβ(1-2)Glcβ(1-6)] | Glcβ(1-2)Glcβ1- |
| | | | | | | | Glcβ1- | |
| 16.38 | 89.0 | 0.429 | 0.29 | 803 (?) | 803 | SG-EPC01 | | |
| 16.93 | 328.6 | 0.943 | 0.64 | 1435 965 641 | 1435 | Reb-O (MS) | Glcβ(1-3)Rhaα(1- | Glcβ(1-2)[Glcβ(1- |
| | | | | | | | 2)[Glcβ(1-3)]Glcβ1- | 3)]Glcβ1- |
| 17.36 | 1276.4 | 4.74 | 3.22 | 1127 803 | 1127 | Reb-D (Std) | Glcβ(1-2)Glcβ1- | Glcβ(1-2)[Glcβ(1- |
| | | | | | | | | 3)]Glcβ1- |
| 18.10 | 717.6 | 2.32 | 1.58 | 1289 1127 965 | 1289 | Reb-M (Std) | Glcβ(1-2)[Glcβ(1- | Glcβ(1-2)[Glcβ(1- |
| | | | | 803 641 | | | 3)]Glcβ1- | 3)]Glcβ1- |
| 18.77 | 298.7 | 0.964 | 0.66 | 1273 1111 803 | 1273 | Reb-N (Std) | Rhaα(1-2)[Glcβ(1- | Glcβ(1-2)[Glcβ(1- |
| | | | | | | | 3)]Glcβ1- | 3)]Glcβ1- |
| 18.95 | 369.4 | 1.58 | 1.07 | 965 803 641 | 965 | Reb-E (Std) | Glcβ(1-2)Glcβ1- | Glcβ(1-2)Glcβ1- |
| 19.04 | 308.1 | 1.14 | 0.78 | 1111 949 803 | 1111 | Reb-K (MS) | Glcβ(1-2)Glcβ1- | Rhaα(1-2)[Glcβ(1- |
| | | | | 641 | | | | 3)]Glcβ1- |
| 19.38 | 167.2 | 0.535 | 0.36 | 1259 1097 965 | 1259 | Reb-Y (MS) | Glcβ(1-2)[Araβ(1- | Glcβ(1-2)[Glcβ(1- |
| | | | | 803 479 | | | 3)]Glcβ1- | 3)]Glcβ1- |
| 19.76 | 59.7 | 0.199 | 0.14 | 1111 949 803 | 1111 | Reb-J (MS) | Rhaα(1-2)Glcβ1- | Glcβ(1-2)[Glcβ(1- |
| | | | | 641 | | | | 3)]Glcβ1- |
| 20.08 | 14.5 | 0.0248 | 0.02 | 1259 1111 803 | 1259 | Reb-V (MS) | Glcβ(1-2)[Glcβ(1- | Xylβ(1-2)[Glcβ(1-3)]- |
| | | | | 641 | | | 3)]Glcβ1- | Glcβ1- |
| 20.94 | 221.0 | 0.715 | 0.49 | 1259 965 803 | 1259 | Reb-V2 (MS) | Xylβ(1-2)[Glcβ(1-3)]- | Glcβ(1-2)[Glcβ(1- |
| | | | | 641 | | | Glcβ1- | 3)]Glcβ1- |
| 21.04 | 28.6 | 0.0815 | 0.06 | 1111 949 803 | 1111 | Reb-H (MS) | Glcβ1- | Glcβ(1-3)Rhaα(1- |
| | | | | | | | | 2)[Glcβ(1-3)]Glcβ1- |
| 21.10 | 109.1 | 0.381 | 0.26 | 1127 965 803 | 1127 | Reb-I (MS) | Glcβ(1-3)Glcβ1- | Glcβ(1-2)[Glcβ(1- |
| | | | | 641 | | | | 3)]Glcβ1- |
| 21.18 | 150.5 | 0.550 | 0.37 | 1097 965 803 | 1097 | Reb U (MS) | Araα(1-2)-Glcβ1- | Glcβ(1-2)[Glcβ(1- |
| | | | | 641 | | | | 3)]Glcβ1- |
| 21.48 | 45.1 | 0.142 | 0.10 | 1127 965 803 | 1127 | Reb L (MS) | Glcβ1- | Glcβ(1-6)Glcβ(1- |
| | | | | 641 | | | | 2)[Glcβ(1-3)]Glcβ1- |
| 22.22 | 6541.9 | 28.5 | 19.39 | 965 803 641 | 965 | Reb-A (Std) | Glcβ1- | Glcβ(1-2)[Glcβ(1- |
| | | | | | | | | 3)]Glcβ1- |
| 22.53 | 5597.5 | 29.3 | 19.93 | 803 641 | 803 | Stevioside (Std) | Glcβ1- | Glcβ(1-2)Glcβ1- |
| 23.46 | 435.9 | 1.93 | 1.26 | 935 773 625 | 935 | Reb-R (MS) | Glcβ1- | Glcβ(1-2)[Glcβ(1- |
| | | | | | | | | 3)]Xylβ1- |
| 23.61 | 1200.1 | 5.37 | 3.51 | 935 773 625 | 935 | Reb-F (Std) | Glcβ1- | Xylβ(1-2)[Glcβ(1- |
| | | | | | | | | 3)]Glcβ1- |
| 23.74 | 730.9 | 3.21 | 2.18 | 949 787 | 949 | Reb-C (Std) | Glcβ1- | Rhaα(1-2)[Glcβ(1- |
| | | | | | | | | 3)]Glcβ1- |
| 24.27 | 129.8 | 0.656 | 0.45 | 787 625 479 | 787 | Dulcoside A | Glcβ1- | Rhaα(1-2)Glcβ1- |
| | | | | | | (Std) | | |
| 24.52 | 823.7 | 4.28 | 2.91 | 803 641 479 | 803 | Reb-G (Std) | Glcβ1- | Glcβ(1-3)Glcβ1- |
| 25.02 | 431.0 | 1.88 | 1.28 | 949 787 479 | 949 | Reb-S (MS) | H- | Glcβ(1-3)Rhaα(1- |
| | | | | | | | | 2)[Glcβ(1-3)]Glcβ1- |
| 25.30 | 544.7 | 3.53 | 2.40 | 641 479 | 641 | Rubusoside | Glcβ1- | Glcβ1- |
| | | | | | | (Std) | | |
| 26.40 | 16.8 | 0.0519 | 0.04 | 787 625 | 787 | Stevioside B | Glcβ1- | Glcβ(1-2)6-deoxyGlcβ1- |
| | | | | | | (MS) | | |
| 27.15 | 816.1 | 4.24 | 2.88 | 804 | 803 | Reb-B (Std) | H- | Glcβ(1-2)[Glcβ(1- |
| | | | | | | | | 3)]Glcβ1- |
| 27.87 | 813.9 | 5.30 | 3.60 | 641 479 | 641 | Reb G1 (MS) | H- | Glcβ(1-3)Glcβ1- |
| 28.73 | 577.4 | 3.05 | 2.07 | 787 641 | 787 | Dulcoside B | H- | Rhaα(1-2)[Glcβ(1- |
| | | | | | | (MS) | | 3)]Glcβ1- |
| 29.28 | 983.4 | 6.41 | 4.36 | 641 | 641 | Steviolbioside | H- | Glcβ(1-2)Glcβ1- |
| | | | | | | (MS) | | |
| 30.38 | 824.5 | 4.45 | 3.03 | 773 | 773 | Reb-R1 (MS) | H- | Glcβ(1-2)[Glcβ(1- |
| | | | | | | | | 3)]Xylβ1- |
| 30.95 | 9.2 | 0.0115 | 0.01 | 773 625 | 773 | Reb-F1 (MS) | H- | Xylβ(1-2)[Glcβ(1- |
| | | | | | | | | 3)]Glcβ1- |
| 31.04 | 13.418 | 0.0415 | 0.03 | 641 | 641 | Iso- | H- | Glcβ(1-2)Glcβ1- |
| | | | | | | Steviolbioside | | |

Table 11 shows the SG composition of sample SCJ20171008 (Available from Sweet Green Fields. Prepare according to the method described in Example 11. It's the spray-dried powder of 70% ethanol desorption solution). Total SG content was 95.4%. The sum percentage of SGs obtained by external standardization using authentic reference standards was 61.4%. The sum percentage of SGs with qualification of structure by ESI-MS obtained by external standardization using Reb-A as reference standard and mass correction for calculation was 20.0%. The sum percentage of SGs without qualification of structure obtained by external standardization using Reb-A as reference standard was 14.0%.

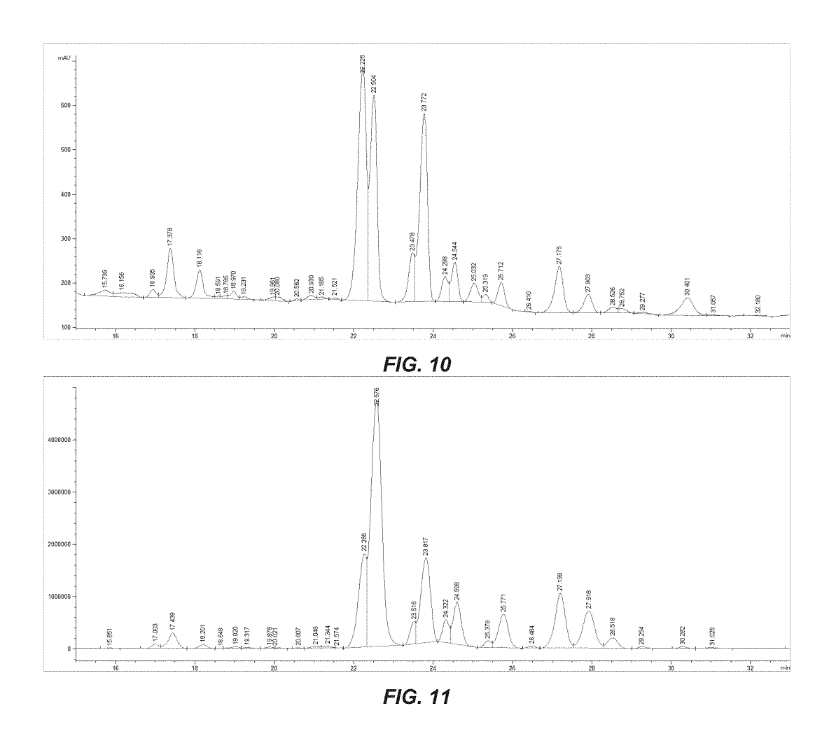

FIG. 10 shows the chromatogram for 150 mg of sample SCJ20171008/10 ml. FIG. 11 shows the chromatogram of the total ion current for sample SCJ20171008.

TABLE 11
Steviol-glycosides in sample SCJ20171008 (sample weight 150.5 mg/10 ml).

| | Area | mg/ | | MS information | | Identified | | |
|---|---|---|---|---|---|---|---|---|
| Rt | 210 nm | 10 ml | % m/m | (m/z) | [M − H]⁻ | compound | R1 (C-19) | R2 (C-13) |
| 15.67 | 218.2 | 0.789 | 0.52 | 1127 803 641 | 1127 | Reb I3 (MS) | [Glcβ(1-2)Glcβ(1-6)] | Glcβ(1-2)Glcβ1- |
| | | | | | | | Glcβ1- | |
| 16.09 | 225.7 | 1.15 | 0.76 | 803 (?) | 803 | SG-EPC01 | | |
| 16.85 | 132.9 | 0.369 | 0.25 | 1435 965 641 | 1435 | Reb-O (MS) | Glcβ(1-3)Rhaα(1- | Glcβ(1-2)[Glcβ(1- |
| | | | | | | | 2)[Glcβ(1-3)]Glcβ1- | 3)]Glcβ1- |
| 17.28 | 1394.2 | 5.18 | 3.44 | 1127 803 | 1127 | Reb-D (Std) | Glcβ(1-2)Glcβ1- | Glcβ(1-2)[Glcβ(1- |
| | | | | | | | | 3)]Glcβ1- |
| 18.02 | 423.6 | 1.36 | 0.90 | 1289 1127 965 | 1289 | Reb-M (Std) | Glcβ(1-2)[Glcβ(1- | Glcβ(1-2)[Glcβ(1- |
| | | | | 803 641 | | | 3)]Glcβ1- | 3)]Glcβ1- |
| 18.40 | 238.5 | 0.765 | 0.51 | 1273 1111 803 | 1273 | Reb-N (Std) | Rhaα(1-2)[Glcβ(1- | Glcβ(1-2)[Glcβ(1- |
| | | | | | | | 3)]Glcβ1- | 3)]Glcβ1- |
| 18.65 | 385.4 | 1.65 | 1.10 | 965 803 641 | 965 | Reb-E (Std) | Glcβ(1-2)Glcβ1- | Glcβ(1-2)Glcβ1- |
| 18.86 | 308.6 | 1.14 | 0.76 | 1111 949 803 | 1111 | Reb-K (MS) | Glcβ(1-2)Glcβ1- | Rhaα(1-2)[Glcβ(1- |
| | | | | 641 | | | | 3)]Glcβ1- |
| 19.15 | 95.4 | 0.295 | 0.20 | 1259 1097 965 | 1259 | Reb-Y (MS) | Glcβ(1-2)[Araβ(1- | Glcβ(1-2)[Glcβ(1- |
| | | | | 803 479 | | | 3)]Glcβ1- | 3)]Glcβ1- |
| 19.83 | 268.5 | 0.990 | 0.66 | 1111 949 803 | 1111 | Reb-J (MS) | Rhaα(1-2)Glcβ1- | Glcβ(1-2)[Glcβ(1- |
| | | | | 641 | | | | 3)]Glcβ1- |
| 20.00 | 152.1 | 0.485 | 0.32 | 1259 1111 803 | 1259 | Reb-V (MS) | Glcβ(1-2)[Glcβ(1- | Xylβ(1-2)[Glcβ(1-3)]- |
| | | | | 641 | | | 3)]Glcβ1- | Glcβ1- |
| 20.20 | 136.9 | 0.434 | 0.29 | 1259 965 803 | 1259 | Reb-V2 (MS) | Xylβ(1-2)[Glcβ(1-3)]- | Glcβ(1-2)[Glcβ(1- |
| | | | | 641 | | | Glcβ1- | 3)]Glcβ1- |
| 20.47 | 15.6 | 0.0322 | 0.02 | 1111 949 803 | 1111 | Reb-H (MS) | Glcβ1- | Glcβ(1-3)Rhaα(1- |
| | | | | | | | | 2)[Glcβ(1-3)]Glcβ1- |
| 20.84 | 137.1 | 0.485 | 0.32 | 1127 965 803 | 1127 | Reb-I (MS) | Glcβ(1-3)Glcβ1- | Glcβ(1-2)[Glcβ(1- |
| | | | | 641 | | | | 3)]Glcβ1- |
| 21.07 | 165.2 | 0.607 | 0.40 | 1097 965 803 | 1097 | Reb U (MS) | Araα(1-2)-Glcβ1- | Glcβ(1-2)[Glcβ(1- |
| | | | | 641 | | | | 3)]Glcβ1- |
| 21.50 | 59.5 | 0.196 | 0.13 | 1127 965 803 | 1127 | Reb L (MS) | Glcβ1- | Glcβ(1-6)Glcβ(1- |
| | | | | 641 | | | | 2)[Glcβ(1-3)]Glcβ1- |
| 22.12 | 7069.2 | 30.8 | 20.47 | 965 803 641 | 965 | Reb-A (Std) | Glcβ1- | Glcβ(1-2)[Glcβ(1- |
| | | | | | | | | 3)]Glcβ1- |
| 22.42 | 7181.1 | 37.6 | 24.98 | 803 641 | 803 | Stevioside (Std) | Glcβ1- | Glcβ(1-2)Glcβ1- |
| 23.37 | 415.9 | 1.84 | 1.22 | 935 773 625 | 935 | Reb-R (MS) | Glcβ1- | Glcβ(1-2)[Glcβ(1- |
| | | | | | | | | 3)]Xylβ1- |
| 23.43 | 280.3 | 1.23 | 0.82 | 935 773 625 | 935 | Reb-F (Std) | Glcβ1- | Xylβ(1-2)[Glcβ(1- |
| | | | | | | | | 3)]Glcβ1- |
| 23.66 | 1308.2 | 5.77 | 3.83 | 949 787 | 949 | Reb-C (Std) | Glcβ1- | Rhaα(1-2)[Glcβ(1- |
| | | | | | | | | 3)]Glcβ1- |
| 24.19 | 98.2 | 0.487 | 0.32 | 787 625 479 | 787 | Dulcoside A | Glcβ1- | Rhaα(1-2)Glcβ1- |
| | | | | | | (Std) | | |
| 24.44 | 579.5 | 3.00 | 1.99 | 803 641 479 | 803 | Reb-G (Std) | Glcβ1- | Glcβ(1-3)Glcβ1- |
| 24.94 | 516.7 | 2.26 | 1.50 | 949 787 479 | 949 | Reb-S (MS) | H- | Glcβ(1-3)Rhaα(1- |
| | | | | | | | | 2)[Glcβ(1-3)]Glcβ1- |
| 25.61 | 537.1 | 3.48 | 2.31 | 641 479 | 641 | Rubusoside | Glcβ1- | Glcβ1- |
| | | | | | | (Std) | | |
| 26.32 | 224.8 | 1.16 | 0.77 | 787 625 | 787 | Stevioside B | Glcβ1- | Glcβ(1-2)6-deoxyGlcβ1- |
| | | | | | | (MS) | | |
| 27.04 | 457.4 | 2.36 | 1.57 | 804 | 803 | Reb-B (Std) | H- | Glcβ(1-2)[Glcβ(1- |
| | | | | | | | | 3)]Glcβ1- |
| 27.76 | 606.9 | 3.94 | 2.62 | 641 479 | 641 | Reb G1 (MS) | H- | Glcβ(1-3)Glcβ1- |
| 28.40 | 465.2 | 2.45 | 1.63 | 787 641 | 787 | Dulcoside B | H- | Rhaα(1-2)[Glcβ(1- |
| | | | | | | (MS) | | 3)]Glcβ1- |
| 28.70 | 360.4 | 2.32 | 1.54 | 641 | 641 | Steviolbioside | H- | Glcβ(1-2)Glcβ1- |
| | | | | | | (MS) | | |
| 29.32 | 103.7 | 0.526 | 0.35 | 773 | 773 | Reb-R1 (MS) | H- | Glcβ(1-2)[Glcβ(1- |
| | | | | | | | | 3)]Xylβ1- |
| 30.27 | 1191.7 | 6.45 | 4.29 | 773 625 | 773 | Reb-F1 (MS) | H- | Xylβ(1-2)[Glcβ(1- |
| | | | | | | | | 3)]Glcβ1- |
| 31.06 | 140.2 | 0.874 | 0.58 | 641 479 | 641 | | | |

Table 12 shows the SG composition of sample SCJ20171105-1 (Available from Sweet Green Fields. Prepare according to the method described in Example 11. It's the spray-dried powder of 30% ethanol desorption solution). Total SG content was 10.2%. The sum percentage of SGs obtained by external standardization using authentic reference standards was 62.8%. The sum percentage of SGs with qualification of structure by ESI-MS obtained by external standardization using Reb-A as reference standard and mass correction for calculation was 25.9%. The sum percentage of SGs without qualification of structure obtained by external standardization using Reb-A as reference standard was 12.7%.

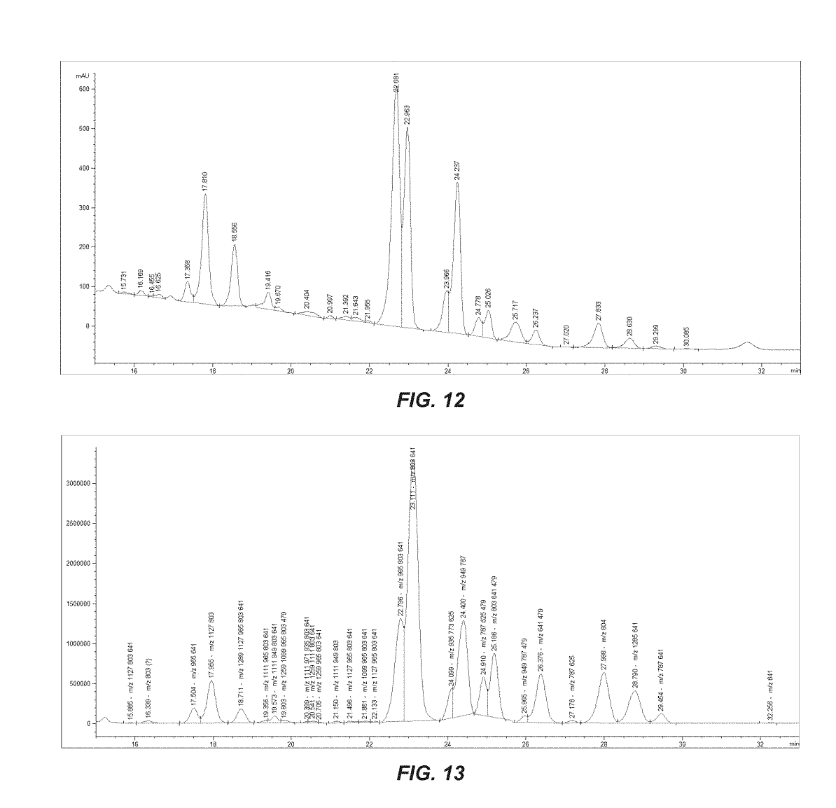

FIG. 12 shows the chromatogram for 150 mg of sample SCJ20171105-1/10 ml. FIG. 13 shows the chromatogram of the total ion current for sample SCJ20171105-1.

TABLE 12
Steviol-glycosides in sample SCJ20171105-1 (sample weight 145.5 mg/10 ml).

| | Area | mg/ | | MS information | | Identified | | |
|---|---|---|---|---|---|---|---|---|
| Rt | 210 nm | 10 ml | % m/m | (m/z) | [M − H]⁻ | compound | R1 (C-19) | R2 (C-13) |
| 15.34 | 363.4 | 1.33 | 0.91 | 1127 803 641 | 1127 | Reb 13 (MS) | [Glcβ(1-2)Glcβ(1- | Glcβ(1-2)Glcβ1- |
| | | | | | | | 6)]Glcβ1- | |
| 16.17 | 123.1 | 0.608 | 0.42 | 803 (?) | 803 | SG-EPC01 | | |
| 17.36 | 567.4 | 1.64 | 1.13 | 1435 965 641 | 1435 | Reb-O (MS) | Glcβ(1-3)Rhaα(1- | Glcβ(1-2)[Glcβ(1- |
| | | | | | | | 2)[Glcβ(1- | 3)]Glcβ1- |
| | | | | | | | 3)]Glcβ1- | |
| 17.81 | 2851.4 | 10.6 | 7.30 | 1127 803 | 1127 | Reb-D (Std) | Glcβ(1-2)Glcβ1- | Glcβ(1-2)[Glcβ(1- |
| | | | | | | | | 3)]Glcβ1- |
| 18.56 | 1840.6 | 5.99 | 4.11 | 1289 1127 965 | 1289 | Reb-M (Std) | Glcβ(1-2)[Glcβ(1- | Glcβ(1-2)[Glcβ(1- |
| | | | | 803 641 | | | 3)]Glcβ1- | 3)]Glcβ1- |
| 19.00 | 459.6 | 1.50 | 1.03 | 1273 1111 803 | 1273 | Reb-N (Std) | Rhaα(1-2)[Glcβ(1- | Glcβ(1-2)[Glcβ(1- |
| | | | | | | | 3)]Glcβ1- | 3)]Glcβ1- |
| 19.36 | 422.0 | 1.81 | 1.24 | 965 803 641 | 965 | Reb-E (Std) | Glcβ(1-2)Glcβ1- | Glcβ(1-2)Glcβ1- |
| 19.42 | 160.9 | 0.583 | 0.40 | 1111 949 803 | 1111 | Reb-K (MS) | Glcβ(1-2)Glcβ1- | Rhaα(1-2)[Glcβ(1- |
| | | | | 641 | | | | 3)]Glcβ1- |
| 19.67 | 107.6 | 0.336 | 0.23 | 1259 1097 965 | 1259 | Reb-Y (MS) | Glcβ(1-2)[Araβ(1- | Glcβ(1-2)[Glcβ(1- |
| | | | | 803 479 | | | 3)]Glcβ1- | 3)]Glcβ1- |
| 20.40 | 94.5 | 0.331 | 0.23 | 1111 949 803 | 1111 | Reb-J (MS) | Rhaα(1-2)Glcβ1- | Glcβ(1-2)[Glcβ(1- |
| | | | | 641 | | | | 3)]Glcβ1- |
| 20.60 | 31.5 | 0.0816 | 0.06 | 1259 1111 803 | 1259 | Reb-V (MS) | Glcβ(1-2)[Glcβ(1- | Xylβ(1-2)[Glcβ(1-3)]- |
| | | | | 641 | | | 3)]Glcβ1- | Glcβ1- |
| 20.74 | 94.5 | 0.292 | 0.20 | 1259 965 803 | 1259 | Reb-V2 (MS) | Xylβ(1-2)[Glcβ(1- | Glcβ(1-2)[Glcβ(1- |
| | | | | 641 | | | 3)]Glcβ1- | 3)]-Glcβ1- |
| 20.98 | 70.0 | 0.238 | 0.16 | 1111 949 803 | 1111 | Reb-H (MS) | Glcβ1- | Glcβ(1-3)Rhaα(1- |
| | | | | | | | | 2)[Glcβ(1-3)]Glcβ1- |
| 21.39 | 140.0 | 0.496 | 0.34 | 1127 965 803 | 1127 | Reb-I (MS) | Glcβ(1-3)Glcβ1- | Glcβ(1-2)[Glcβ(1- |
| | | | | 641 | | | | 3)]Glcβ1- |
| 21.64 | 152.7 | 0.559 | 0.38 | 1097 965 803 | 1097 | Reb U (MS) | Araα(1-2)-Glcβ1- | Glcβ(1-2)[Glcβ(1- |
| | | | | 641 | | | | 3)]Glcβ1- |
| 21.95 | 50.8 | 0.163 | 0.11 | 1127 965 803 | 1127 | Reb L (MS) | Glcβ1- | Glcβ(1-6)Glcβ(1- |
| | | | | 641 | | | | 2)[Glcβ(1-3)]Glcβ1- |
| 22.68 | 6112.1 | 26.6 | 18.30 | 965 803 641 | 965 | Reb-A (Std) | Glcβ1- | Glcβ(1-2)[Glcβ(1- |
| | | | | | | | | 3)]Glcβ1- |
| 22.96 | 4863.3 | 25.5 | 17.49 | 803 641 | 803 | Stevioside (Std) | Glcβ1- | Glcβ(1-2)Glcβ1- |
| 23.97 | 783.0 | 3.49 | 2.40 | 935 773 625 | 935 | Reb-R (MS) | Glcβ1- | Glcβ(1-2)[Glcβ(1- |
| | | | | | | | | 3)]Xylβ1- |
| 23.99 | 692.7 | 3.09 | 2.12 | 935 773 625 | 935 | Reb-F (Std) | Glcβ1- | Xylβ(1-2)[Glcβ(1- |
| | | | | | | | | 3)]Glcβ1- |
| 24.24 | 2949.0 | 13.0 | 8.97 | 949 787 | 949 | Reb-C (Std) | Glcβ1- | Rhaα(1-2)[Glcβ(1- |
| | | | | | | | | 3)]Glcβ1- |
| 24.78 | 580.3 | 3.07 | 2.11 | 787 625 479 | 787 | Dulcoside A | Glcβ1- | Rhaα(1-2)Glcβ1- |
| | | | | | | (Std) | | |
| 25.03 | 822.3 | 4.27 | 2.94 | 803 641 479 | 803 | Reb-G (Std) | Glcβ1- | Glcβ(1-3)Glcβ1- |
| 25.72 | 375.6 | 1.63 | 1.12 | 949 787 479 | 949 | Reb-S (MS) | H- | Glcβ(1-3)Rhaα(1- |
| | | | | | | | | 2)[Glcβ(1-3)]Glcβ1- |
| 26.24 | 998.9 | 6.51 | 4.48 | 641 479 | 641 | Rubusoside | Glcβ1- | Glcβ1- |
| | | | | | | (Std) | | |
| 27.18 | 339.8 | 1.78 | 1.22 | 787 625 | 787 | Stevioside B | Glcβ1- | Glcβ(1-2)6- |
| | | | | | | (MS) | | deoxyGlcβ1- |
| 27.83 | 1075.9 | 5.60 | 3.85 | 804 | 803 | Reb-B (Std) | H- | Glcβ(1-2)[Glcβ(1- |
| | | | | | | | | 3)]Glcβ1- |
| 28.63 | 457.1 | 2.95 | 2.03 | 641 479 | 641 | Reb G1 (MS) | H- | Glcβ(1-3)Glcβ1- |
| 29.45 | 534.0 | 2.82 | 1.94 | 787 641 | 787 | Dulcoside B | H- | Rhaα(1-2)[Glcβ(1- |
| | | | | | | (MS) | | 3)]Glcβ1- |
| 31.63 | 331.8 | 2.13 | 1.47 | 641 | 641 | Steviolbioside | H- | Glcβ(1-2)Glcβ1- |
| | | | | | | (MS) | | |

Table 13 shows the SG composition of sample SCJ20171009 (Available from Sweet Green Fields. Prepare according to the method described in Example 11. It's the spray-dried powder of 70% ethanol desorption solution). Total SG content was 96.4%. The sum percentage of SGs obtained by external standardization using authentic reference standards was 59.8%. The sum percentage of SGs with qualification of structure by ESI-MS obtained by external standardization using Reb-A as reference standard and mass correction for calculation was 22.2%. The sum percentage of SGs without qualification of structure obtained by external standardization using Reb-A as reference standard was 14.4%.

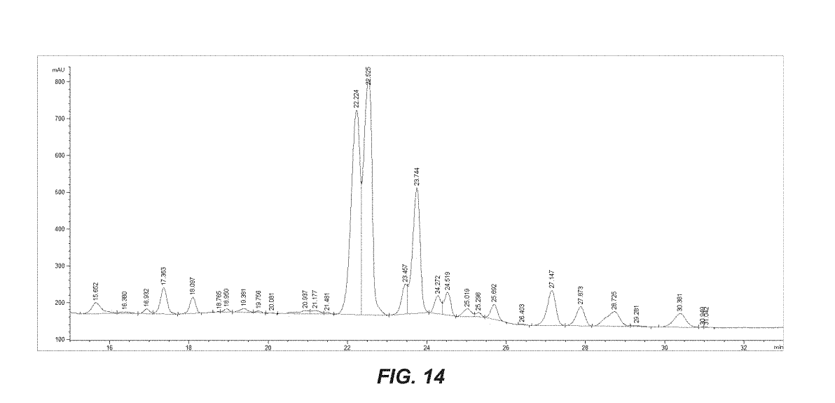

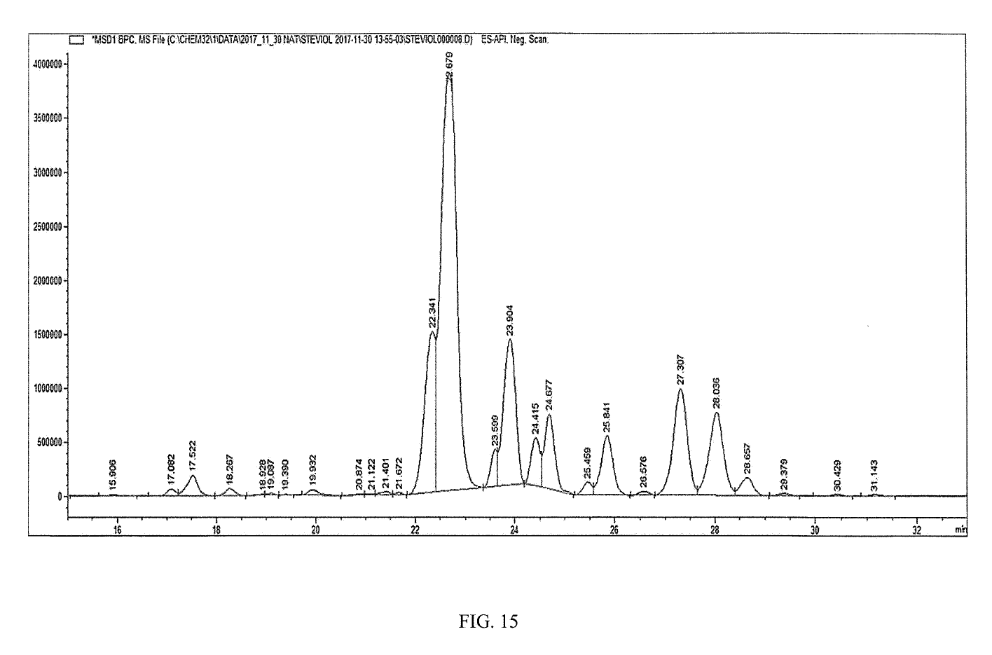

FIG. 14 shows the chromatogram for 150 mg of sample SCJ20171009/10 ml. FIG. 15 shows the chromatogram of the total ion current for sample SCJ20171009.

TABLE 13
Steviol-glycosides in sample SCJ20171009 (sample weight 149.7 mg/10 ml).

| | | | | MS | | | | |
|---|---|---|---|---|---|---|---|---|
| | Area | mg/ | | information | | Identified | | |
| Rt | 210 nm | 10 ml | % m/m | (m/z) | [M − H]⁻ | compound | R1 (C-19) | R2 (C-13) |
| 15.71 | 235.4 | 0.853 | 0.58 | 1127 803 641 | 1127 | Reb I3 (MS) | [Glcβ(1-2)Glcβ(1-6)] | Glcβ(1-2)Glcβ1- |
| | | | | | | | Glcβ1- | |
| 16.13 | 277.8 | 1.42 | 0.97 | 803 (?) | 803 | SG-EPC01 | | |
| 16.44 | 331.0 | 0.950 | 0.65 | 1435 965 641 | 1435 | Reb-O (MS) | Glcβ(1-3)Rhaα(1- | Glcβ(1-2)[Glcβ(1- |
| | | | | | | | 2)[Glcβ(1-3)]Glcβ1- | 3)]Glcβ1- |
| 17.32 | 1313.9 | 4.88 | 3.32 | 1127 803 | 1127 | Reb-D (Std) | Glcβ(1-2)Glcβ1- | Glcβ(1-2)[Glcβ(1- |
| | | | | | | | | 3)]Glcβ1- |
| 18.05 | 344.0 | 1.10 | 0.75 | 1289 1127 | 1289 | Reb-M (Std) | Glcβ(1-2)[Glcβ(1- | Glcβ(1-2)[Glcβ(1- |
| | | | | 965 803 641 | | | 3)]Glcβ1- | 3)]Glcβ1- |
| 18.34 | 266.9 | 0.859 | 0.58 | 1273 1111 | 1273 | Reb-N (Std) | Rhaα(1-2)[Glcβ(1- | Glcβ(1-2)[Glcβ(1- |
| | | | | 803 | | | 3)]Glcβ1- | 3)]Glcβ1- |
| 18.53 | 408.3 | 1.75 | 1.19 | 965 803 641 | 965 | Reb-E (Std) | Glcβ(1-2)Glcβ1- | Glcβ(1-2)Glcβ1- |
| 18.91 | 135.3 | 0.486 | 0.33 | 1111 949 803 | 1111 | Reb-K (MS) | Glcβ(1-2)Glcβ1- | Rhaα(1-2)[Glcβ(1- |
| | | | | 641 | | | | 3)]Glcβ1- |
| 19.17 | 10.7 | 0.0120 | 0.01 | 1259 1097 | 1259 | Reb-Y (MS) | Glcβ(1-2)[Araβ(1- | Glcβ(1-2)[Glcβ(1- |
| | | | | 965 803 479 | | | 3)]Glcβ1- | 3)]Glcβ1- |
| 19.88 | 130.8 | 0.469 | 0.32 | 1111 949 803 | 1111 | Reb-J (MS) | Rhaα(1-2)Glcβ1- | Glcβ(1-2)[Glcβ(1- |
| | | | | 641 | | | | 3)]Glcβ1- |
| 20.06 | 97.0 | 0.300 | 0.20 | 1259 1111 | 1259 | Reb-V (MS) | Glcβ(1-2)[Glcβ(1- | Xylβ(1-2)[Glcβ(1-3)]- |
| | | | | 803 641 | | | 3)]Glcβ1- | Glcβ1- |
| 20.48 | 35.2 | 0.094 | 0.06 | 1259 965 803 | 1259 | Reb-V2 (MS) | Xylβ(1-2)[Glcβ(1-3)]- | Glcβ(1-2)[Glcβ(1- |
| | | | | 641 | | | Glcβ1- | 3)]Glcβ1- |
| 20.89 | 94.7 | 0.332 | 0.23 | 1111 949 803 | 1111 | Reb-H (MS) | Glcβ1- | Glcβ(1-3)Rhaα(1- |
| | | | | | | | | 2)[Glcβ(1-3)]Glcβ1- |
| 21.12 | 160.0 | 0.571 | 0.39 | 1127 965 803 | 1127 | Reb-I (MS) | Glcβ(1-3)Glcβ1- | Glcβ(1-2)[Glcβ(1- |
| | | | | 641 | | | | 3)]Glcβ1- |
| 21.45 | 62.0 | 0.21 | 0.14 | 1097 965 803 | 1097 | Reb U (MS) | Araα(1-2)-Glcβ1- | Glcβ(1-2)[Glcβ(1- |
| | | | | 641 | | | | 3)]Glcβ1- |
| 21.96 | 125.6 | 0.443 | 0.30 | 1127 965 803 | 1127 | Reb L (MS) | Glcβ1- | Glcβ(1-6)Glcβ(1- |
| | | | | 641 | | | | 2)[Glcβ(1-3)]Glcβ1- |
| 22.16 | 6771.1 | 29.5 | 20.07 | 965 803 641 | 965 | Reb-A (Std) | Glcβ1- | Glcβ(1-2)[Glcβ(1- |
| | | | | | | | | 3)]Glcβ1- |
| 22.46 | 6656.4 | 34.9 | 23.71 | 803 641 | 803 | Stevioside (Std) | Glcβ1- | Glcβ(1-2)Glcβ1- |
| 23.40 | 415.9 | 1.84 | 1.20 | 935 773 625 | 935 | Reb-R (MS) | Glcβ1- | Glcβ(1-2)[Glcβ(1- |
| | | | | | | | | 3)]Xylβ1- |
| 23.51 | 280.3 | 1.23 | 0.80 | 935 773 625 | 935 | Reb-F (Std) | Glcβ1- | Xylβ(1-2)[Glcβ(1- |
| | | | | | | | | 3)]Glcβ1- |
| 23.69 | 427.4 | 1.86 | 1.27 | 949 787 | 949 | Reb-C (Std) | Glcβ1- | Rhaα(1-2)[Glcβ(1- |
| | | | | | | | | 3)]Glcβ1- |
| 24.22 | 104.3 | 0.520 | 0.35 | 787 625 479 | 787 | Dulcoside A | Glcβ1- | Rhaα(1-2)Glcβ1- |
| | | | | | | (Std) | | |
| 24.47 | 856.1 | 4.45 | 3.03 | 803 641 479 | 803 | Reb-G (Std) | Glcβ1- | Glcβ(1-3)Glcβ1- |
| 24.97 | 523.5 | 2.29 | 1.56 | 949 787 479 | 949 | Reb-S (MS) | H- | Glcβ(1-3)Rhaα(1- |
| | | | | | | | | 2)[Glcβ(1-3)]Glcβ1- |
| 25.64 | 535.6 | 3.47 | 2.36 | 641 479 | 641 | Rubusoside | Glcβ1- | Glcβ1- |
| | | | | | | (Std) | | |
| 26.38 | 15.2 | 0.0435 | 0.03 | 787 625 | 787 | Stevioside B | Glcβ1- | Glcβ(1-2)6-deoxyGlcβ1- |
| | | | | | | (MS) | | |
| 27.10 | 888.6 | 4.62 | 3.14 | 804 | 803 | Reb-B (Std) | H- | Glcβ(1-2)[Glcβ(1- |
| | | | | | | | | 3)]Glcβ1- |
| 27.82 | 1013.4 | 6.61 | 4.49 | 641 479 | 641 | Reb G1 (MS) | H- | Glcβ(1-3)Glcβ1- |
| 28.41 | 738.2 | 3.91 | 2.66 | 787 641 | 787 | Dulcoside B | H- | Rhaα(1-2)[Glcβ(1- |
| | | | | | | (MS) | | 3)]Glcβ1- |
| 28.77 | 538.6 | 3.5 | 2.37 | 641 | 641 | Steviolbioside | H- | Glcβ(1-2)Glcβ1- |
| | | | | | | (MS) | | |
| 29.32 | 136.9 | 0.707 | 0.48 | 773 | 773 | Reb-R1 (MS) | H- | Glcβ(1-2)[Glcβ(1- |
| | | | | | | | | 3)]Xylβ1- |
| 30.33 | 1161.2 | 6.28 | 4.27 | 773 625 | 773 | Reb-F1 (MS) | H- | Xylβ(1-2)[Glcβ(1- |
| | | | | | | | | 3)]Glcβ1- |
| 31.78 | 36.96929 | 0.196 | 0.13 | 641 | 641 | Iso- | H- | Glcβ(1-2)Glcβ1- |
| | | | | | | Steviolbioside | | |

Table 14 shows the SG composition of sample SCJ20170220-24 (Available from Sweet Green Fields. Prepare according to the method described in Example 11. It's the spray-dried powder of 70% ethanol desorption solution). Total SG content was 95.5%. The sum percentage of SGs obtained by external standardization using authentic reference standards was 63.7%. The sum percentage of SGs with qualification of structure by ESI-MS obtained by external standardization using Reb-A as reference standard and mass correction for calculation was 22.1%. The sum percentage of SGs without qualification of structure obtained by external standardization using Reb-A as reference standard was 9.64%.

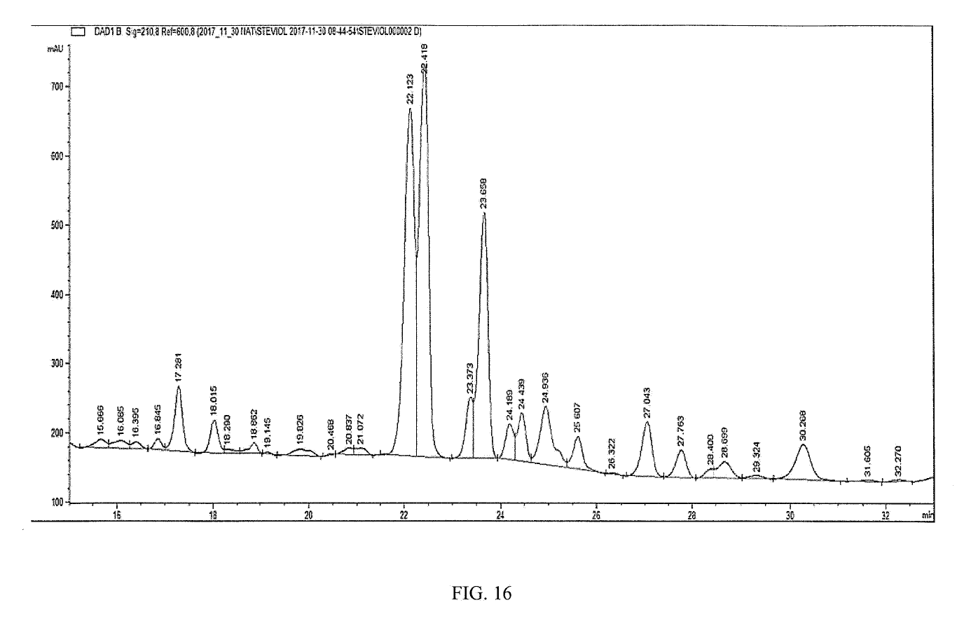

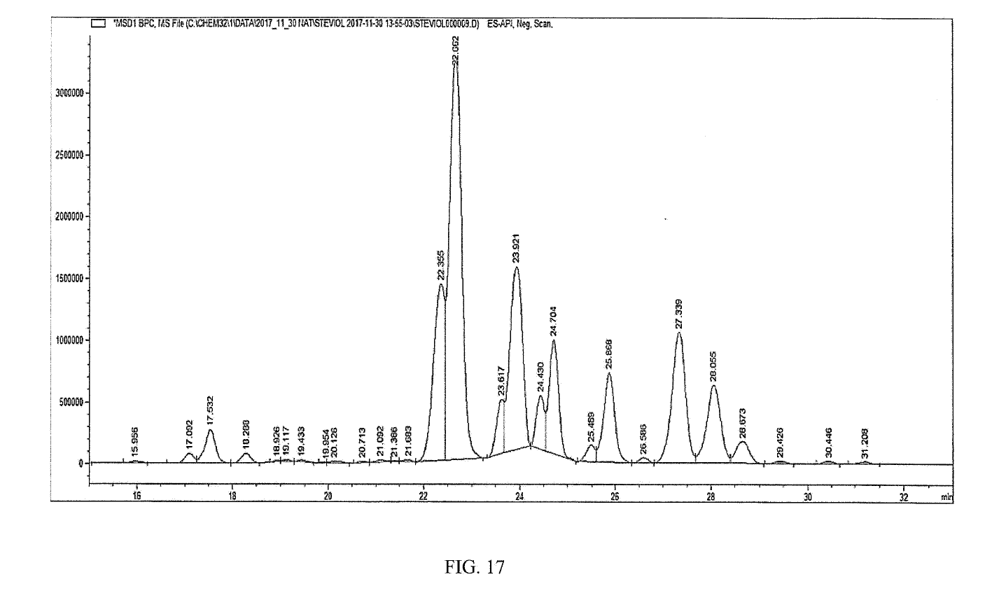

FIG. 16 shows the chromatogram for 150 mg of sample SCJ20170220-24/10 ml. FIG. 17 shows the chromatogram of the total ion current for sample SCJ20170220-24.

TABLE 14
Steviol-glycosides in sample SCJ20170220-24 (sample weight 147.2 mg/10 ml).

| | | | | MS | | | | |
|---|---|---|---|---|---|---|---|---|
| | Area | mg/ | | information | | Identified | | |
| Rt | 210 nm | 10 ml | % m/m | (m/z) | [M − H]⁻ | compound | R1 (C-19) | R2 (C-13) |
| 15.74 | 288.1 | 1.05 | 0.71 | 1127 803 | 1127 | Reb I3 (MS) | [Glcβ(1-2)Glcβ(1-6)] | Glcβ(1-2)Glcβ1- |
| | | | | 641 | | | Glcβ1- | |
| 16.16 | 310.7 | 1.59 | 1.08 | 803 (?) | 803 | SG-EPC01 | | |
| 16.94 | 211.1 | 0.449 | 0.31 | 1435 965 | 1435 | Reb-O (MS) | Glcβ(1-3)Rhaα(1- | Glcβ(1-2)[Glcβ(1- |
| | | | | 641 | | | 2)[Glcβ(1-3)]Glcβ1- | 3)]Glcβ1- |
| 17.38 | 1423.5 | 3.84 | 2.61 | 1127 803 | 1127 | Reb-D (Std) | Glcβ(1-2)Glcβ1- | Glcβ(1-2)[Glcβ(1- |
| | | | | | | | | 3)]Glcβ1- |
| 18.12 | 803.9 | 1.44 | 0.98 | 1289 1127 | 1289 | Reb-M (Std) | Glcβ(1-2)[Glcβ(1- | Glcβ(1-2)[Glcβ(1- |
| | | | | 965 803 641 | | | 3)]Glcβ1- | 3)]Glcβ1- |
| 18.59 | 45.3 | 0.765 | 0.52 | 1273 1111 | 1273 | Reb-N (Std) | Rhaα(1-2)[Glcβ(1- | Glcβ(1-2)[Glcβ(1- |
| | | | | 803 | | | 3)]Glcβ1- | 3)]Glcβ1- |
| 18.79 | 70.8 | 1.86 | 1.27 | 965 803 641 | 965 | Reb-E (Std) | Glcβ(1-2)Glcβ1- | Glcβ(1-2)Glcβ1- |
| 18.97 | 203.0 | 0.742 | 0.50 | 1111 949 | 1111 | Reb-K (MS) | Glcβ(1-2)Glcβ1- | Rhaα(1-2)[Glcβ(1- |
| | | | | 803 641 | | | | 3)]Glcβ1- |
| 19.23 | 71.3 | 0.215 | 0.15 | 1259 1097 | 1259 | Reb-Y (MS) | Glcβ(1-2)[Araβ(1- | Glcβ(1-2)[Glcβ(1- |
| | | | | 965 803 479 | | | 3)]Glcβ1- | 3)]Glcβ1- |
| 19.96 | 99.1 | 0.349 | 0.24 | 1111 949 | 1111 | Reb-J (MS) | Rhaα(1-2)Glcβ1- | Glcβ(1-2)[Glcβ(1- |
| | | | | 803 641 | | | | 3)]Glcβ1- |
| 20.08 | 103.0 | 0.321 | 0.22 | 1259 1111 | 1259 | Reb-V (MS) | Glcβ(1-2)[Glcβ(1- | Xylβ(1-2)[Glcβ(1-3)]- |
| | | | | 803 641 | | | 3)]Glcβ1- | Glcβ1- |
| 20.31 | 148.0 | 0.471 | 0.32 | 1259 965 | 1259 | Reb-V2 (MS) | Xylβ(1-2)[Glcβ(1-3)]- | Glcβ(1-2)[Glcβ(1- |
| | | | | 803 641 | | | Glcβ1- | 3)]Glcβ1- |
| 20.56 | 34.5 | 0.104 | 0.07 | 1111 949 | 1111 | Reb-H (MS) | Glcβ1- | Glcβ(1-3)Rhaα(1- |
| | | | | 803 | | | | 2)[Glcβ(1-3)]Glcβ1- |
| 20.93 | 138.4 | 0.491 | 0.33 | 1127 965 | 1127 | Reb-I (MS) | Glcβ(1-3)Glcβ1- | Glcβ(1-2)[Glcβ(1- |
| | | | | 803 641 | | | | 3)]Glcβ1- |
| 21.19 | 68.2 | 0.234 | 0.16 | 1097 965 | 1097 | Reb U (MS) | Araα(1-2)-Glcβ1- | Glcβ(1-2)[Glcβ(1- |
| | | | | 803 641 | | | | 3)]Glcβ1- |
| 21.52 | 39.3 | 0.120 | 0.08 | 1127 965 | 1127 | Reb L (MS) | Glcβ1- | Glcβ(1-6)Glcβ(1- |
| | | | | 803 641 | | | | 2)[Glcβ(1-3)]Glcβ1- |
| 22.23 | 8047.9 | 33.3 | 22.65 | 965 803 641 | 965 | Reb-A (Std) | Glcβ1- | Glcβ(1-2)[Glcβ(1- |
| | | | | | | | | 3)]Glcβ1- |
| 22.50 | 5733.0 | 32.2 | 21.90 | 803 641 | 803 | Stevioside (Std) | Glcβ1- | Glcβ(1-2)Glcβ1- |
| 23.48 | 1195.2 | 2.33 | 1.52 | 935 773 625 | 935 | Reb-R (MS) | Glcβ1- | Glcβ(1-2)[Glcβ(1- |
| | | | | | | | | 3)]Xylβ1- |
| 23.58 | 267.1 | 1.56 | 1.02 | 935 773 625 | 935 | Reb-F (Std) | Glcβ1- | Xylβ(1-2)[Glcβ(1- |
| | | | | | | | | 3)]Glcβ1- |
| 23.77 | 5863.0 | 8.48 | 5.77 | 949 787 | 949 | Reb-C (Std) | Glcβ1- | Rhaα(1-2)[Glcβ(1- |
| | | | | | | | | 3)]Glcβ1- |
| 24.30 | 652.3 | 0.487 | 0.33 | 787 625 479 | 787 | Dulcoside A | Glcβ1- | Rhaα(1-2)Glcβ1- |
| | | | | | | (Std) | | |
| 24.54 | 1029.5 | 5.60 | 3.81 | 803 641 479 | 803 | Reb-G (Std) | Glcβ1- | Glcβ(1-3)Glcβ1- |
| 25.03 | 605.5 | 2.05 | 1.39 | 949 787 479 | 949 | Reb-S (MS) | H- | Glcβ(1-3)Rhaα(1- |
| | | | | | | | | 2)[Glcβ(1-3)]Glcβ1- |
| 25.71 | 723.9 | 3.25 | 2.21 | 641 479 | 641 | Rubusoside | Glcβ1- | Glcβ1- |
| | | | | | | (Std) | | |
| 26.41 | 13.3 | 0.0332 | 0.02 | 787 625 | 787 | Stevioside B | Glcβ1- | Glcβ(1-2)6-deoxyGlcβ1- |
| | | | | | | (MS) | | |
| 27.18 | 1656.0 | 2.48 | 1.69 | 804 | 803 | Reb-B (Std) | H- | Glcβ(1-2)[Glcβ(1- |
| | | | | | | | | 3)]Glcβ1- |
| 27.90 | 637.5 | 4.14 | 2.82 | 641 479 | 641 | Reb G1 (MS) | H- | Glcβ(1-3)Glcβ1- |
| 28.53 | 201.8 | 4.10 | 2.79 | 787 641 | 787 | Dulcoside B | H- | Rhaα(1-2)[Glcβ(1- |
| | | | | | | (MS) | | 3)]Glcβ1- |
| 28.75 | 139.4 | 4.87 | 3.31 | 641 | 641 | Steviolbioside | H- | Glcβ(1-2)Glcβ1- |
| | | | | | | (MS) | | |
| 29.28 | 263.6 | 1.40 | 0.95 | 773 | 773 | Reb-R1 (MS) | H- | Glcβ(1-2)[Glcβ(1- |
| | | | | | | | | 3)]Xylβ1- |
| 30.40 | 953.9 | 5.16 | 3.51 | 773 625 | 773 | Reb-F1 (MS) | H- | Xylβ(1-2)[Glcβ(1- |
| | | | | | | | | 3)]Glcβ1- |
| 31.06 | 140.1985 | 0.87 | 0.59 | 641 | 641 | Iso- | H- | Glcβ(1-2)Glcβ1- |
| | | | | | | Steviolbioside | | |

### Example 11. SG Composition of Exemplary Samples

Multiple samples of exemplary liquid preparations were subjected to HPLC to determine the SG composition of the preparations. The HPLC was calibrated using standards of RA, RB, RC, RD, RE, RF, RG, RM, and RN.

Materials

Reference standards for steviolglycosides (RA, RB, RC, RD, RE, RF, RG, RM, RN) were obtained from Chromadex (LGC Germany). Solvents and reagents (HPLC grade) were obtained from VWR (Vienna) or Sigma-Aldrich (Vienna).

Davisil Grade 633 (high-purity grade silica gel, pore size 60 Å, 200-425 mesh particle size was obtained from Sigma-Aldrich (Vienna).

Preparation of Sample Compositions No. 1-13

Air-dried leaves of Stevia rebaudiana (1 kg) were extracted with distilled water at 45-55□ for 2 hours. The extracting stage is repeated for three times. The volume of water in each extracting stage is 5 L, 5 L and 3 L, respectively. The liquid extract was separated from the solids by centrifugation. The filtered supernatant liquid extract was flocculated and the supernatant was separated by centrifugation. The supernatant was passed through a macroporous resin (1 L, resin model: T28, available from Sunresin new materials Co. Ltd., China) and then desorbed with 3 L of 65% ethanol/water. The desorption solution was treated by 1 L of cationic exchange resin and 1 L of anion exchange resin for desalination and decoloration. The ionic exchange resin can be all that persons skilled in the art have known. After that the desorption solution was spray-dried to a powder and designated as the crude extract. The crude extract was dissolved in 3 times its weight of 80% ethanol aqueous solution. The solution was then heated to 75-80° C. and stirred for 1 hour. The solution was then cooled and allowed to stand for an hour at 20-25° C. The supernatant and precipitante were separated through centrifugation. The resultant precipitate was used to produce other stevia extract products such as RA97. The supernatant was distilled to recover ethanol and subsequently spray-dried to a powder. The powder was dissolved in 10 times its weight of water and treated with a macroporous resin (1 L, resin model: T28, available from Sunresin new materials Co. Ltd., China). Materials were desorbed with a mixture of ethanol and water with different blend ratios. The desorption solution with low blend ratio of ethanol/water mixture (the ratio of ethanol is from above 0 to less than 50%) such as 3 L of 30% ethanol was concentrated and subsequently spray-dried to provide a powder. This powder contained about 3-10% rebaudioside D and 0-0.4% rebaudioside M. The SG Compositions No. 1-9 are of this kind of product. The desorption solution with high blend ratio of ethanol/water mixture (the ratio of ethanol is from 50% to 100%) such as 3 L of 70% ethanol was concentrated and subsequently spray-dried to provide a powder. This powder contained about 1-4% rebaudioside D and 0-0.2% rebaudioside M. The SG Compositions No. 10-13 are of this kind of product

Sample Preparation

300 mg sample was dissolved in 20 ml Acetonitrile/H₂O=9/1 (v/v).

HPLC-Method

The HPLC system consisted of an Agilent 1100 system (autosampler, ternary gradient pump, column thermostat, VWD-UV/VIS detector, DAD-UV/VIS detector) connected in-line to an Agilent mass spectrometer (ESI-MS quadrupole G1956A VL). For HPLC analysis 150 mg of the corresponding sample was dissolved in Acetonitrile (1 ml) and filled up to 10 ml with H2O.

Samples were separated at 0.8 ml/min on a Phenomenex Synergi Hydro-RP (150×3 mm) followed by a Macherey-Nagel Nucleosil 100-7 C18 (250×4.6 mm) at 45° C. by gradient elution.

Mobile Phase A consisted of a 0.01 molar NH4-Acetate buffer (native pH) with 0.1% acetic acid, 0.05% trimethylamine and 0.001% dichloromethane. Mobile Phase B consisted of 0.01 molar NH4-Acetate buffer (native pH) and Acetonitrile (1/9 v/v) with 0.1% acetic acid, 0.05% trimethylamine and 0.001% dichloromethane. The gradient started with 22% B, was increased linearly in 20 minutes to 45% B and kept at this condition for another 15 minutes. Injection volume was set to 10 μl.

The detectors were set to 210 nm (VWD), to 205 and 254 nm (DAD with spectra collection between 200-600 nm) and to ESI negative mode TIC m/z 300-1500, Fragmentor 200, Gain 2 (MS, 300° C., nitrogen 12 l/min, nebulizer setting 50 psig. Capillary voltage 4500 V).

Detection at 210 nm was used to quantify the chromatograms, the MS-spectra were used to determine the molar mass and structural information of individual peaks. Detection at 254 nm was used to identify non-SG peaks.

Identification and Quantification

SGs were identified by comparison of retention times to authentic reference standards and/or by evaluation of the mass spectra obtained (including interpretation of the fragmentation pattern and double charged ions triggered by the presence of dichloromethane).

Steviol-glycosides were quantified against external standards. In case that no reference standard was available quantification was performed against Reb-A.

The maximum calibration range of reference standards was in a range 0.1-50 mg/10 ml (dissolved in Acetonitrile/H2O=9/1 (v/v)).

Tables 15-27 show the SG content of exemplary compositions of the present disclosure.

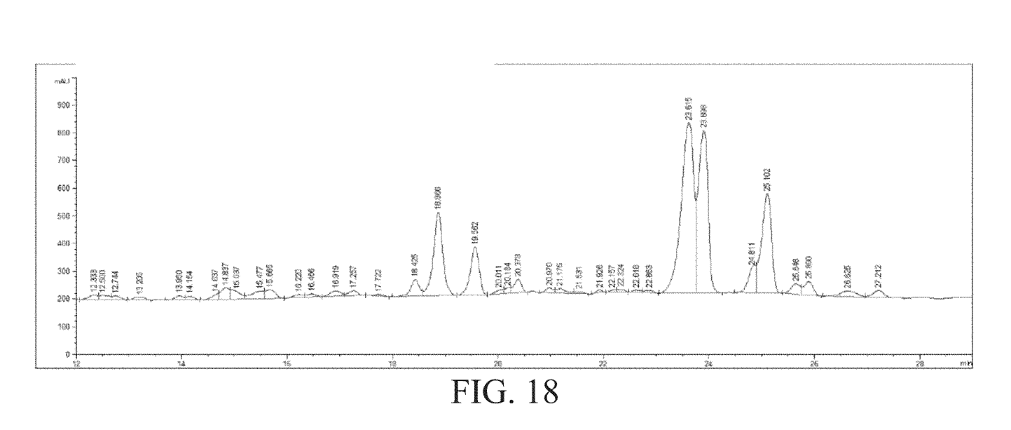

FIG. 18 depicts a chromatogram corresponding to the composition shown in Table 15.

TABLE 15
SGs in Sample Composition No. 1 (The concentration
of the sample in HPLC-MS detection is 182.3 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981 | <0.01 | <0.01 |
| Related SG #3 | 427 or 735 | <0.01 | <0.01 |
| Related SG #4 | 675 or 1127 | <0.01 | <0.01 |
| Related SG #5 | 981 | <0.01 | <0.01 |
| Reb-V | 1259 | 0.88 | 0.49 |
| Reb-T | 1127 | 0.80 | 0.44 |
| Reb-E | 965 | 0.34 | 0.19 |
| Reb-O | 1435 | 2.02 | 1.11 |
| Reb-D | 1127 | 14.16 | 7.77 |
| Reb-K | 1111 | 7.62 | 4.18 |
| Reb-N | 1273 | 0.54 | 0.30 |
| Reb-M | 1289 | 0.51 | 0.28 |
| Reb-S | 949 | 2.19 | 1.20 |
| Reb-J | 1111 | 0.73 | 0.40 |
| Reb-W | 1097 | 0.91 | 0.50 |
| Reb-U2 | 1097 | 0.29 | 0.16 |
| Reb-W2/3 | 1097 | <0.01 | <0.01 |
| Reb-O2 | 965 | 0.32 | 0.18 |
| Reb-Y | 1259 | 0.18 | 0.10 |
| Reb-I | 1127 | 0.30 | 0.16 |
| Reb-V2 | 1259 | 0.27 | 0.15 |
| Reb-K2 | 1111 | 0.39 | 0.22 |
| Reb-H | 1111 | <0.01 | <0.01 |
| Reb-A | 965 | 45.26 | 24.83 |
| Stevioside | 803 | 39.05 | 21.42 |
| Reb-F | 935 | 4.70 | 2.58 |
| Reb-C | 949 | 20.69 | 11.35 |
| Dulcoside-A | 787 | 2.53 | 1.39 |
| Rubusoside | 641 | 3.82 | 2.10 |
| Reb-B | 803 | 2.39 | 1.31 |
| Dulcoside B | 787 | 1.97 | 1.08 |
| Steviolbioside | 641 | <0.01 | <0.01 |
| Reb-R | 935 | <0.01 | <0.01 |
| Reb-G | 803 | <0.01 | <0.01 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 152.85 | 83.84 |

TABLE 16
SGs in Sample Composition No. 3 (154.4 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | 0.49 | 0.32 |
| Related SG #5 | 981 | 0.36 | 0.23 |
| Reb-V | 1259 | 0.83 | 0.54 |
| Reb-T | 1127 | 1.32 | 0.86 |
| Reb-E | 965 | 0.48 | 0.31 |
| Reb-O | 1435 | 1.95 | 1.27 |
| Reb-D | 1127 | 13.45 | 8.71 |
| Reb-K | 1111 | 6.90 | 4.47 |
| Reb-N | 1273 | 0.32 | 0.20 |
| Reb-M | 1289 | 0.39 | 0.25 |
| Reb-S | 949 | 2.36 | 1.53 |
| Reb-J | 1111 | 0.34 | 0.22 |
| Reb-W | 1097 | 0.57 | 0.37 |
| Reb-U2 | 1097 | 0.73 | 0.47 |
| Reb-W2/3 | 1097 | 0.31 | 0.20 |
| Reb-O2 | 965 | 0.23 | 0.15 |
| Reb-Y | 1259 | 0.22 | 0.15 |
| Reb-I | 1127 | 0.23 | 0.15 |
| Reb-V2 | 1259 | 0.48 | 0.31 |
| Reb-K2 | 1111 | 0.49 | 0.31 |
| Reb-H | 1111 | 0.28 | 0.18 |
| Reb-A | 965 | 44.56 | 28.86 |
| Stevioside | 803 | 38.40 | 24.87 |
| Reb-F | 935 | 4.75 | 3.07 |
| Reb-C | 949 | 16.32 | 10.57 |
| Dulcoside-A | 787 | 1.79 | 1.16 |
| Rubusoside | 641 | 2.77 | 1.80 |
| Reb-B | 803 | 1.83 | 1.19 |
| Dulcoside B | 787 | 0.48 | 0.31 |
| Steviolbioside | 641 | 1.91 | 1.24 |
| Reb-R | 935 | 0.95 | 0.62 |
| Reb-G | 803 | 0.64 | 0.41 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | 0.39 | 0.25 |
| Iso-Steviolbioside | 641 | <0.01 | <0.01 |
| | Sum | 147.52 | 95.54 |

TABLE 17
SGs in Sample Composition No. 4 (149.5 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | 0.15 | 0.10 |
| Related SG #5 | 981 | <0.01 | <0.01 |
| Reb-V | 1259 | 0.88 | 0.59 |
| Reb-T | 1127 | 1.46 | 0.98 |
| Reb-E | 965 | <0.01 | <0.01 |
| Reb-O | 1435 | 1.62 | 1.08 |
| Reb-D | 1127 | 11.70 | 7.83 |
| Reb-K | 1111 | 5.95 | 3.98 |
| Reb-N | 1273 | <0.01 | <0.01 |
| Reb-M | 1289 | 0.40 | 0.27 |
| Reb-S | 949 | 2.21 | 1.48 |
| Reb-J | 1111 | 0.26 | 0.17 |
| Reb-W | 1097 | 0.53 | 0.36 |
| Reb-U2 | 1097 | 0.75 | 0.50 |
| Reb-W2/3 | 1097 | 0.30 | 0.20 |
| Reb-O2 | 965 | 0.23 | 0.15 |
| Reb-Y | 1259 | 0.20 | 0.13 |
| Reb-I | 1127 | 0.36 | 0.24 |
| Reb-V2 | 1259 | 0.40 | 0.27 |
| Reb-K2 | 1111 | <0.01 | <0.01 |
| Reb-H | 1111 | <0.01 | <0.01 |
| Reb-A | 965 | 42.36 | 28.34 |
| Stevioside | 803 | 40.28 | 26.94 |
| Reb-F | 935 | 4.76 | 3.18 |
| Reb-C | 949 | 18.44 | 12.34 |
| Dulcoside-A | 787 | 1.96 | 1.31 |
| Rubusoside | 641 | 2.96 | 1.98 |
| Reb-B | 803 | 2.39 | 1.60 |
| Dulcoside B | 787 | 0.45 | 0.30 |
| Steviolbioside | 641 | 2.40 | 1.60 |
| Reb-R | 935 | <0.01 | <0.01 |
| Reb-G | 803 | <0.01 | <0.01 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 143.42 | 95.93 |

TABLE 18
SGs in Sample Composition No. 5 (151.4 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | <0.01 | <0.01 |
| Related SG #5 | 981 | 0.15 | 0.10 |
| Reb-V | 1259 | 0.71 | 0.47 |
| Reb-T | 1127 | 0.94 | 0.62 |
| Reb-E | 965 | 0.30 | 0.20 |
| Reb-O | 1435 | 1.39 | 0.92 |
| Reb-D | 1127 | 9.34 | 6.17 |
| Reb-K | 1111 | 4.98 | 3.29 |
| Reb-N | 1273 | <0.01 | <0.01 |
| Reb-M | 1289 | 0.28 | 0.19 |
| Reb-S | 949 | 1.85 | 1.22 |
| Reb-J | 1111 | 0.27 | 0.18 |
| Reb-W | 1097 | 0.40 | 0.27 |
| Reb-U2 | 1097 | 0.59 | 0.39 |
| Reb-W2/3 | 1097 | 0.27 | 0.18 |
| Reb-O2 | 965 | 0.21 | 0.14 |
| Reb-Y | 1259 | 0.46 | 0.31 |
| Reb-I | 1127 | 0.85 | 0.56 |
| Reb-V2 | 1259 | 0.67 | 0.44 |
| Reb-K2 | 1111 | 0.20 | 0.13 |
| Reb-H | 1111 | <0.01 | <0.01 |
| Reb-A | 965 | 43.90 | 29.00 |
| Stevioside | 803 | 44.06 | 29.10 |
| Reb-F | 935 | 4.65 | 3.07 |
| Reb-C | 949 | 16.80 | 11.09 |
| Dulcoside-A | 787 | 2.40 | 1.59 |
| Rubusoside | 641 | 3.15 | 2.08 |
| Reb-B | 803 | 1.91 | 1.26 |
| Dulcoside B | 787 | 0.62 | 0.41 |
| Steviolbioside | 641 | 2.32 | 1.54 |
| Reb-R | 935 | 0.27 | 0.18 |
| Reb-G | 803 | <0.01 | <0.01 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 143.96 | 95.09 |

TABLE 19
SGs in Sample Composition No. 6 (157.3 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | 0.29 | 0.18 |
| Related SG #4 | 675 or 1127 | 0.36 | 0.23 |
| Related SG #5 | 981 | 0.48 | 0.31 |
| Reb-V | 1259 | 0.55 | 0.35 |
| Reb-T | 1127 | 0.81 | 0.52 |
| Reb-E | 965 | <0.01 | <0.01 |
| Reb-O | 1435 | 1.51 | 0.96 |
| Reb-D | 1127 | 10.82 | 6.88 |
| Reb-K | 1111 | 4.81 | 3.06 |
| Reb-N | 1273 | 0.41 | 0.26 |
| Reb-M | 1289 | 0.30 | 0.19 |
| Reb-S | 949 | 1.99 | 1.27 |
| Reb-J | 1111 | 0.40 | 0.25 |
| Reb-W | 1097 | 0.20 | 0.13 |
| Reb-U2 | 1097 | 0.53 | 0.34 |
| Reb-W2/3 | 1097 | 0.28 | 0.18 |
| Reb-O2 | 965 | <0.01 | <0.01 |
| Reb-Y | 1259 | 0.23 | 0.15 |
| Reb-I | 1127 | 0.20 | 0.13 |
| Reb-V2 | 1259 | 0.23 | 0.14 |
| Reb-K2 | 1111 | 0.34 | 0.21 |
| Reb-H | 1111 | <0.01 | <0.01 |
| Reb-A | 965 | 40.82 | 25.95 |
| Stevioside | 803 | 46.30 | 29.43 |
| Reb-F | 935 | 6.98 | 4.43 |
| Reb-C | 949 | 19.76 | 12.56 |
| Dulcoside-A | 787 | 3.06 | 1.95 |
| Rubusoside | 641 | 3.57 | 2.27 |
| Reb-B | 803 | 0.87 | 0.56 |
| Dulcoside B | 787 | 0.83 | 0.53 |
| Steviolbioside | 641 | 2.35 | 1.50 |
| Reb-R | 935 | 0.63 | 0.40 |
| Reb-G | 803 | 0.38 | 0.24 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | 0.37 | 0.24 |
| Iso-Steviolbioside | 641 | <0.01 | <0.01 |
| | Sum | 150.67 | 95.78 |

TABLE 20
SGs in Sample Composition No. 7 (164.6 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | 0.52 | 0.32 |
| Related SG #5 | 981 | 0.41 | 0.25 |
| Reb-V | 1259 | 0.80 | 0.48 |
| Reb-T | 1127 | 1.10 | 0.67 |
| Reb-E | 965 | <0.01 | <0.01 |
| Reb-O | 1435 | 1.60 | 0.97 |
| Reb-D | 1127 | 10.65 | 6.47 |
| Reb-K | 1111 | 7.01 | 4.26 |
| Reb-N | 1273 | 0.40 | 0.24 |
| Reb-M | 1289 | 0.31 | 0.19 |
| Reb-S | 949 | 2.27 | 1.38 |
| Reb-J | 1111 | 0.57 | 0.34 |
| Reb-W | 1097 | 0.33 | 0.20 |
| Reb-U2 | 1097 | 0.54 | 0.33 |
| Reb-W2/3 | 1097 | 0.31 | 0.19 |
| Reb-O2 | 965 | 0.21 | 0.13 |
| Reb-Y | 1259 | 0.22 | 0.13 |
| Reb-I | 1127 | 0.59 | 0.36 |
| Reb-V2 | 1259 | 0.50 | 0.30 |
| Reb-K2 | 1111 | 0.26 | 0.16 |
| Reb-H | 1111 | 0.23 | 0.14 |
| Reb-A | 965 | 47.27 | 28.72 |
| Stevioside | 803 | 49.46 | 30.05 |
| Reb-F | 935 | 6.08 | 3.70 |
| Reb-C | 949 | 16.21 | 9.85 |
| Dulcoside-A | 787 | 2.87 | 1.75 |
| Rubusoside | 641 | 3.12 | 1.89 |
| Reb-B | 803 | 0.88 | 0.53 |
| Dulcoside B | 787 | 1.03 | 0.63 |
| Steviolbioside | 641 | 2.49 | 1.51 |
| Reb-R | 935 | 0.54 | 0.33 |
| Reb-G | 803 | 0.67 | 0.41 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | 0.55 | 0.33 |
| Iso-Steviolbioside | 641 | <0.01 | <0.01 |
| | Sum | 159.99 | 97.20 |

TABLE 21
SGs in Sample Composition No. 8 (156.8 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | <0.01 | <0.01 |
| Related SG #5 | 981 | <0.01 | <0.01 |
| Reb-V | 1259 | 0.75 | 0.48 |
| Reb-T | 1127 | 0.95 | 0.61 |
| Reb-E | 965 | <0.01 | <0.01 |
| Reb-O | 1435 | 1.74 | 1.11 |
| Reb-D | 1127 | 9.29 | 5.93 |
| Reb-K | 1111 | 7.57 | 4.83 |
| Reb-N | 1273 | 0.48 | 0.30 |
| Reb-M | 1289 | <0.01 | <0.01 |
| Reb-S | 949 | <0.01 | <0.01 |
| Reb-J | 1111 | <0.01 | <0.01 |
| Reb-W | 1097 | <0.01 | <0.01 |
| Reb-U2 | 1097 | <0.01 | <0.01 |
| Reb-W2/3 | 1097 | <0.01 | <0.01 |
| Reb-O2 | 965 | <0.01 | <0.01 |
| Reb-Y | 1259 | <0.01 | <0.01 |
| Reb-I | 1127 | <0.01 | <0.01 |
| Reb-V2 | 1259 | 0.41 | 0.26 |
| Reb-K2 | 1111 | 0.30 | 0.19 |
| Reb-H | 1111 | <0.01 | <0.01 |
| Reb-A | 965 | 50.34 | 32.10 |
| Stevioside | 803 | 51.85 | 33.07 |
| Reb-F | 935 | 4.22 | 2.69 |
| Reb-C | 949 | 14.39 | 9.18 |
| Dulcoside-A | 787 | 2.21 | 1.41 |
| Rubusoside | 641 | 2.17 | 1.38 |
| Reb-B | 803 | 0.81 | 0.52 |
| Dulcoside B | 787 | 0.51 | 0.33 |
| Steviolbioside | 641 | 2.00 | 1.27 |
| Reb-R | 935 | 0.89 | 0.57 |
| Reb-G | 803 | 0.41 | 0.26 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 151.28 | 96.48 |

TABLE 22
SGs in Sample Composition No. 9 (156.8 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | <0.01 | <0.01 |
| Related SG #5 | 981 | 0.17 | 0.11 |
| Reb-V | 1259 | 0.62 | 0.40 |
| Reb-T | 1127 | 0.93 | 0.59 |
| Reb-E | 965 | <0.01 | <0.01 |
| Reb-O | 1435 | 1.71 | 1.09 |
| Reb-D | 1127 | 7.81 | 4.98 |
| Reb-K | 1111 | 3.54 | 2.25 |
| Reb-N | 1273 | 0.34 | 0.22 |
| Reb-M | 1289 | 0.25 | 0.16 |
| Reb-S | 949 | 2.00 | 1.28 |
| Reb-J | 1111 | 0.27 | 0.18 |
| Reb-W | 1097 | <0.01 | <0.01 |
| Reb-U2 | 1097 | 0.37 | 0.24 |
| Reb-W2/3 | 1097 | 0.19 | 0.12 |
| Reb-O2 | 965 | <0.01 | <0.01 |
| Reb-Y | 1259 | 0.18 | 0.12 |
| Reb-I | 1127 | 0.18 | 0.12 |
| Reb-V2 | 1259 | 0.30 | 0.19 |
| Reb-K2 | 1111 | 0.53 | 0.33 |
| Reb-H | 1111 | 0.40 | 0.25 |
| Reb-A | 965 | 51.43 | 32.80 |
| Stevioside | 803 | 52.14 | 33.25 |
| Reb-F | 935 | 4.88 | 3.11 |
| Reb-C | 949 | 13.25 | 8.45 |
| Dulcoside-A | 787 | 2.94 | 1.88 |
| Rubusoside | 641 | 2.91 | 1.86 |
| Reb-B | 803 | 1.22 | 0.78 |
| Dulcoside B | 787 | 0.80 | 0.51 |
| Steviolbioside | 641 | 2.07 | 1.32 |
| Reb-R | 935 | 0.67 | 0.43 |
| Reb-G | 803 | 0.19 | 0.12 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | 0.14 | 0.09 |
| Iso-Steviolbioside | 641 | <0.01 | <0.01 |
| | Sum | 152.44 | 97.22 |

TABLE 23
SGs in Sample Composition No. 10 (150.7 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | <0.01 | <0.01 |
| Related SG #5 | 981 | <0.01 | <0.01 |
| Reb-V | 1259 | 0.60 | 0.40 |
| Reb-T | 1127 | 0.93 | 0.62 |
| Reb-E | 965 | <0.01 | <0.01 |
| Reb-O | 1435 | 1.14 | 0.76 |
| Reb-D | 1127 | 4.73 | 3.14 |
| Reb-K | 1111 | 2.66 | 1.77 |
| Reb-N | 1273 | <0.01 | <0.01 |
| Reb-M | 1289 | 0.54 | 0.36 |
| Reb-S | 949 | 1.35 | 0.90 |
| Reb-J | 1111 | 0.22 | 0.15 |
| Reb-W | 1097 | <0.01 | <0.01 |
| Reb-U2 | 1097 | <0.01 | <0.01 |
| Reb-W2/3 | 1097 | <0.01 | <0.01 |
| Reb-O2 | 965 | <0.01 | <0.01 |
| Reb-Y | 1259 | 0.23 | 0.15 |
| Reb-I | 1127 | <0.01 | <0.01 |
| Reb-V2 | 1259 | 0.37 | 0.24 |
| Reb-K2 | 1111 | 0.66 | 0.44 |
| Reb-H | 1111 | 0.30 | 0.20 |
| Reb-A | 965 | 45.81 | 30.40 |
| Stevioside | 803 | 55.99 | 37.15 |
| Reb-F | 935 | 5.76 | 3.82 |
| Reb-C | 949 | 12.90 | 8.56 |
| Dulcoside-A | 787 | 3.62 | 2.40 |
| Rubusoside | 641 | 3.41 | 2.26 |
| Reb-B | 803 | 1.36 | 0.90 |
| Dulcoside B | 787 | 0.91 | 0.60 |
| Steviolbioside | 641 | 2.83 | 1.88 |
| Reb-R | 935 | <0.01 | <0.01 |
| Reb-G | 803 | <0.01 | <0.01 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 146.33 | 97.10 |

TABLE 24
SGs in Sample Composition No. 11 (160.6 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | 0.34 | 0.21 |
| Related SG #5 | 981 | 0.23 | 0.14 |
| Reb-V | 1259 | 0.48 | 0.30 |
| Reb-T | 1127 | 0.79 | 0.49 |
| Reb-E | 965 | <0.01 | <0.01 |
| Reb-O | 1435 | 1.00 | 0.62 |
| Reb-D | 1127 | 4.41 | 2.75 |
| Reb-K | 1111 | 2.51 | 1.56 |
| Reb-N | 1273 | <0.01 | <0.01 |
| Reb-M | 1289 | <0.01 | <0.01 |
| Reb-S | 949 | 1.09 | 0.68 |
| Reb-J | 1111 | <0.01 | <0.01 |
| Reb-W | 1097 | <0.01 | <0.01 |
| Reb-U2 | 1097 | 0.39 | 0.25 |
| Reb-W2/3 | 1097 | 0.31 | 0.19 |
| Reb-O2 | 965 | 0.32 | 0.20 |
| Reb-Y | 1259 | 0.20 | 0.12 |
| Reb-I | 1127 | 0.39 | 0.24 |
| Reb-V2 | 1259 | 0.64 | 0.40 |
| Reb-K2 | 1111 | 0.26 | 0.16 |
| Reb-H | 1111 | <0.01 | <0.01 |
| Reb-A | 965 | 47.52 | 29.59 |
| Stevioside | 803 | 59.35 | 36.95 |
| Reb-F | 935 | 6.56 | 4.08 |
| Reb-C | 949 | 9.75 | 6.07 |
| Dulcoside-A | 787 | 4.54 | 2.83 |
| Rubusoside | 641 | 5.10 | 3.17 |
| Reb-B | 803 | 2.32 | 1.44 |
| Dulcoside B | 787 | 1.01 | 0.63 |
| Steviolbioside | 641 | 3.77 | 2.35 |
| Reb-R | 935 | 0.48 | 0.30 |
| Reb-G | 803 | 0.37 | 0.23 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 154.12 | 95.97 |

TABLE 25
SGs in Sample Composition No. 12 (166.6 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | <0.01 | <0.01 |
| Related SG #5 | 981 | <0.01 | <0.01 |
| Reb-V | 1259 | <0.01 | <0.01 |
| Reb-T | 1127 | <0.01 | <0.01 |
| Reb-E | 965 | <0.01 | <0.01 |
| Reb-O | 1435 | 0.87 | 0.52 |
| Reb-D | 1127 | 3.85 | 2.31 |
| Reb-K | 1111 | 2.30 | 1.38 |
| Reb-N | 1273 | <0.01 | <0.01 |
| Reb-M | 1289 | 0.24 | 0.14 |
| Reb-S | 949 | 0.72 | 0.43 |
| Reb-J | 1111 | <0.01 | <0.01 |
| Reb-W | 1097 | <0.01 | <0.01 |
| Reb-U2 | 1097 | 0.45 | 0.27 |
| Reb-W2/3 | 1097 | 0.25 | 0.15 |
| Reb-O2 | 965 | 0.20 | 0.12 |
| Reb-Y | 1259 | 0.21 | 0.13 |
| Reb-I | 1127 | 0.39 | 0.24 |
| Reb-V2 | 1259 | 0.80 | 0.48 |
| Reb-K2 | 1111 | 0.33 | 0.20 |
| Reb-H | 1111 | 0.42 | 0.25 |
| Reb-A | 965 | 48.56 | 29.15 |
| Stevioside | 803 | 55.86 | 33.53 |
| Reb-F | 935 | 7.34 | 4.40 |
| Reb-C | 949 | 14.97 | 8.99 |
| Dulcoside-A | 787 | 4.34 | 2.61 |
| Rubusoside | 641 | 6.24 | 3.75 |
| Reb-B | 803 | 3.42 | 2.05 |
| Dulcoside B | 787 | 1.05 | 0.63 |
| Steviolbioside | 641 | 4.43 | 2.66 |
| Reb-R | 935 | 0.73 | 0.44 |
| Reb-G | 803 | 0.61 | 0.37 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 158.58 | 95.19 |

TABLE 26
SGs in Sample Composition No. 13 (165.1 mg/10 ml)

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | <0.01 | <0.01 |
| Related SG #4 | 675 or 1127 | <0.01 | <0.01 |
| Related SG #5 | 981 | <0.01 | <0.01 |
| Reb-V | 1259 | 0.43 | 0.26 |
| Reb-T | 1127 | <0.01 | <0.01 |
| Reb-E | 965 | 0.25 | 0.15 |
| Reb-O | 1435 | 0.63 | 0.38 |
| Reb-D | 1127 | 3.70 | 2.24 |
| Reb-K | 1111 | 2.11 | 1.28 |
| Reb-N | 1273 | <0.01 | <0.01 |
| Reb-M | 1289 | <0.01 | <0.01 |
| Reb-S | 949 | 1.22 | 0.74 |
| Reb-J | 1111 | <0.01 | <0.01 |
| Reb-W | 1097 | 0.31 | 0.19 |
| Reb-U2 | 1097 | 0.57 | 0.34 |
| Reb-W2/3 | 1097 | 0.24 | 0.14 |
| Reb-O2 | 965 | 0.33 | 0.20 |
| Reb-Y | 1259 | 0.21 | 0.13 |
| Reb-I | 1127 | 0.36 | 0.22 |
| Reb-V2 | 1259 | 0.75 | 0.46 |
| Reb-K2 | 1111 | 0.28 | 0.17 |
| Reb-H | 1111 | <0.01 | <0.01 |
| Reb-A | 965 | 49.10 | 29.74 |
| Stevioside | 803 | 55.69 | 33.73 |
| Reb-F | 935 | 7.73 | 4.68 |
| Reb-C | 949 | 14.51 | 8.79 |
| Dulcoside-A | 787 | 4.65 | 2.82 |
| Rubusoside | 641 | 6.82 | 4.13 |
| Reb-B | 803 | 4.05 | 2.45 |
| Dulcoside B | 787 | 1.43 | 0.86 |
| Steviolbioside | 641 | 4.69 | 2.84 |
| Reb-R | 935 | 0.21 | 0.13 |
| Reb-G | 803 | <0.01 | <0.01 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 160.26 | 97.07 |

### Example 12. Taste Properties Versus RA97 and Solubility

Materials

| Sample No. | Composition | % RD | % RM | % RA | % ST | % RC | % RB | % STB | % TSG* |
|---|---|---|---|---|---|---|---|---|---|
| Sample 1 | Composition No. 5 in | 6.17 | 0.19 | 29.0 | 29.1 | 11.09 | 1.26 | 1.54 | 95.09 |
| | Example 11 | | | | | | | | |
| Sample 2 | RA97 | 0.15 | 0 | 97.08 | 0.55 | 0.40 | 0.73 | 0 | 99.1 |

*the total steviol glycosides (TSG) is based on all glycosylated derivatives of steviol.

Solutions

In order to make the content of TSG in the solutions nearly the same, the materials were dissolved in deionized water at different concentrations, thus making solutions having almost the same sweetness.

| Sample No. | Composition | Concentration |
|---|---|---|
| Sample 1 | Composition No. 5 | 830 ppm |
| | in Example 11 | |
| Sample 2 | RA97 | 580 ppm |

Evaluation

The sugar-like, bitterness, aftertaste, and lingering sweetness of each sample was evaluated by a panel of six trained panelists, each property being scored 0-5, with a higher score indicating a stronger sensation of that property.

| Sample No. | Sugar-Like | Bitterness | Aftertaste | Lingering | Taste Profile |
|---|---|---|---|---|---|
| Sample 1 | 4 | 0.5 | 0.5 | 2 | 1. Almost no bitterness |
| | | | | | 2. Herbal aftertaste |
| Sample 2 | 3 | 2.5 | 3 | 3 | 1. Very bitter |
| | | | | | 2. Strong metallic aftertaste |
| | | | | | 3. Long lingering sweetness |

Conclusion

Sample 1 (Composition No. 5 in Example 11) contains more RD and RM than Sample 2 (RA97). The taste profile of Composition No. 5 is obviously better than RA97.

Long-Term Solubility

The solubility in deionized water of Composition No. 5 in Example 11 was also evaluated.

| | | Period |
|---|---|---|
| Material | Concentration | as a Clear Solution |
| Composition No. 5 in Example 11 | 10% | >21 days |
| Composition No. 5 in Example 11 | 30% | >21 days |
| Composition No. 5 in Example 11 | 50% | >21 days |

### Example 13. Data Summary of Samples in Example 11

The SG composition of the samples in Example 11 were tabulated for the percentage of the 9 most common SGs (RA, ST, RB, RC, RD, RF, dulcoside-A, rubusoside, STB) and 13 common SGs (RA, ST, RB, RC, RD, RE, RF, RM, RN, RO, dulcoside-A, rubusoside, STB).

TABLE 27
Comparison of SGs in Sample Compositions

| | Composition Sample Number From Example 11 | | | | | | | | | | | | |
|---|---|---|---|---|---|---|---|---|---|---|---|---|---|
| Name | 1 | — | 3 | 4 | 5 | 6 | 7 | 8 | 9 | 10 | 11 | 12 | 13 |
| Reb-A* | 24.83 | — | 28.86 | 28.34 | 29.00 | 25.95 | 28.72 | 32.10 | 32.80 | 30.40 | 29.59 | 29.15 | 29.74 |
| Stevioside* | 21.42 | — | 24.87 | 26.94 | 29.10 | 29.43 | 30.05 | 33.07 | 33.25 | 37.15 | 36.95 | 33.53 | 33.73 |
| Reb-B* | 1.31 | — | 1.19 | 1.60 | 1.26 | 0.56 | 0.53 | 0.52 | 0.78 | 0.90 | 1.44 | 2.05 | 2.45 |
| Reb-C* | 11.35 | — | 10.57 | 12.34 | 11.09 | 12.56 | 9.85 | 9.18 | 8.45 | 8.56 | 6.07 | 8.99 | 8.79 |
| Reb-D* | 7.77 | — | 8.71 | 7.83 | 6.17 | 6.88 | 6.47 | 5.93 | 4.98 | 3.14 | 2.75 | 2.31 | 2.24 |
| Reb-E | 0.19 | — | 0.31 | <0.01 | 0.20 | <0.01 | <0.01 | <0.01 | <0.01 | <0.01 | <0.01 | <0.01 | 0.15 |
| Reb-F* | 2.58 | — | 3.07 | 3.18 | 3.07 | 4.43 | 3.70 | 2.69 | 3.11 | 3.82 | 4.08 | 4.40 | 4.68 |
| Reb-M | 0.28 | — | 0.25 | 0.27 | 0.19 | 0.19 | 0.19 | <0.01 | 0.16 | 0.36 | <0.01 | 0.14 | <0.01 |
| Reb-N | 0.30 | — | 0.20 | <0.01 | <0.01 | 0.26 | 0.24 | 0.30 | 0.22 | <0.01 | <0.01 | <0.01 | <0.01 |
| Reb-O | 1.11 | — | 1.27 | 1.08 | 0.92 | 0.96 | 0.97 | 1.11 | 1.09 | 0.76 | 0.62 | 0.52 | 0.38 |
| Dulcoside-A* | 1.39 | — | 1.16 | 1.31 | 1.59 | 1.95 | 1.75 | 1.41 | 1.88 | 2.40 | 2.83 | 2.61 | 2.82 |
| Rubusoside* | 2.10 | — | 1.80 | 1.98 | 2.08 | 2.27 | 1.89 | 1.38 | 1.86 | 2.26 | 3.17 | 3.75 | 4.13 |
| Steviolbioside* | <0.01 | — | 1.24 | 1.60 | 1.54 | 1.50 | 1.51 | 1.27 | 1.32 | 1.88 | 2.35 | 2.66 | 2.84 |
| Sum of above 9 | 72.75 | — | 81.47 | 85.12 | 84.90 | 85.53 | 84.47 | 87.55 | 88.43 | 90.51 | 89.23 | 89.45 | 91.42 |
| SGs (*) | | | | | | | | | | | | | |
| Sum of non-9 | 11.09 | — | 14.07 | 10.81 | 10.19 | 10.25 | 12.73 | 8.93 | 8.79 | 6.59 | 6.74 | 5.74 | 5.65 |
| SGs | | | | | | | | | | | | | |
| Sum of above | 74.63 | — | 83.50 | 86.47 | 86.21 | 86.94 | 85.87 | 88.96 | 89.90 | 91.63 | 89.85 | 90.11 | 91.95 |
| 13 SGs | | | | | | | | | | | | | |
| Sum of non-13 | 9.21 | — | 12.04 | 9.46 | 8.88 | 8.84 | 11.33 | 7.52 | 7.32 | 5.47 | 6.12 | 5.08 | 5.12 |
| SGs | | | | | | | | | | | | | |
| Sum of all SGs | 83.84 | — | 95.54 | 95.93 | 95.09 | 95.78 | 97.20 | 96.48 | 97.22 | 97.10 | 95.97 | 95.19 | 97.07 |

The samples in Example 11 were also tabulated for the percentage of the composition made up by SGs having a molecular weight of greater than 965 daltons.

TABLE 28
Comparison of High Molecular Weight SGs in Sample Compositions

| | | Composition Sample Number From Example 11 | | | | | | | | | | | | | |
|---|---|---|---|---|---|---|---|---|---|---|---|---|---|---|---|
| Name | [M − H] | 1 | — | 3 | 4 | 5 | 6 | 7 | 8 | 9 | 10 | 11 | 12 | 13 | # |
| Reb-E | 965 | 0.19 | — | 0.31 | <0.01 | 0.20 | <0.01 | <0.01 | <0.01 | <0.01 | <0.01 | <0.01 | <0.01 | 0.15 | 5 |
| Reb-O2 | 965 | 0.18 | — | 0.15 | 0.15 | 0.14 | <0.01 | 0.13 | <0.01 | <0.01 | <0.01 | 0.20 | 0.12 | 0.20 | |
| Reb-A | 965 | 24.83 | — | 28.86 | 28.34 | 29.00 | 25.95 | 28.72 | 32.10 | 32.80 | 30.40 | 29.59 | 29.15 | 29.74 | |
| Related | 981 | <0.01 | — | <0.01 | <0.01 | <0.01 | <0.01 | <0.01 | <0.01 | <0.01 | <0.01 | <0.01 | <0.01 | <0.01 | |
| SG #2 | | | | | | | | | | | | | | | |
| Related | 981 | <0.01 | — | 0.23 | <0.01 | 0.10 | 0.31 | 0.25 | <0.01 | 0.11 | <0.01 | 0.14 | <0.01 | <0.01 | |
| SG #5 | | | | | | | | | | | | | | | |
| Reb-W | 1097 | 0.50 | — | 0.37 | 0.36 | 0.27 | 0.13 | 0.20 | <0.01 | <0.01 | <0.01 | <0.01 | <0.01 | 0.19 | 3 |
| Reb-U2 | 1097 | 0.16 | — | 0.47 | 0.50 | 0.39 | 0.34 | 0.33 | <0.01 | 0.24 | <0.01 | 0.25 | 0.27 | 0.34 | |
| Reb-W2/3 | 1097 | <0.01 | — | 0.20 | 0.20 | 0.18 | 0.18 | 0.19 | <0.01 | 0.12 | <0.01 | 0.19 | 0.15 | 0.14 | |
| Reb-K | 1111 | 4.18 | — | 4.47 | 3.98 | 3.29 | 3.06 | 4.26 | 4.83 | 2.25 | 1.77 | 1.56 | 1.38 | 1.28 | 4 |
| Reb-J | 1111 | 0.40 | — | 0.22 | 0.17 | 0.18 | 0.25 | 0.34 | <0.01 | 0.18 | 0.15 | <0.01 | <0.01 | <0.01 | |
| Reb-K2 | 1111 | 0.22 | — | 0.31 | <0.01 | 0.13 | 0.21 | 0.16 | 0.19 | 0.33 | 0.44 | 0.16 | 0.20 | 0.17 | |
| Reb-H | 1111 | <0.01 | — | 0.18 | <0.01 | <0.01 | <0.01 | 0.14 | <0.01 | 0.25 | 0.20 | <0.01 | 0.25 | <0.01 | |
| Related | 675 or | <0.01 | — | 0.32 | 0.10 | <0.01 | 0.23 | 0.32 | <0.01 | <0.01 | <0.01 | 0.21 | <0.01 | <0.01 | 4 |
| SG #4 | 1127 | | | | | | | | | | | | | | |
| Reb-T | 1127 | 0.44 | — | 0.86 | 0.98 | 0.62 | 0.52 | 0.67 | 0.61 | 0.59 | 0.62 | 0.49 | <0.01 | <0.01 | |
| Reb-D | 1127 | 7.77 | — | 8.71 | 7.83 | 6.17 | 6.88 | 6.47 | 5.93 | 4.98 | 3.14 | 2.75 | 2.31 | 2.24 | |
| Reb-I | 1127 | 0.16 | — | 0.15 | 0.24 | 0.56 | 0.13 | 0.36 | <0.01 | 0.12 | <0.01 | 0.24 | 0.24 | 0.22 | |
| Reb-V | 1259 | 0.49 | — | 0.54 | 0.59 | 0.47 | 0.35 | 0.48 | 0.48 | 0.40 | 0.40 | 0.30 | <0.01 | 0.26 | 3 |
| Reb-Y | 1259 | 0.10 | — | 0.15 | 0.13 | 0.31 | 0.15 | 0.13 | <0.01 | 0.12 | 0.15 | 0.12 | 0.13 | 0.13 | |
| Reb-V2 | 1259 | 0.15 | — | 0.31 | 0.27 | 0.44 | 0.14 | 0.30 | 0.26 | 0.19 | 0.24 | 0.40 | 0.48 | 0.46 | |
| Reb-N | 1273 | 0.30 | — | 0.20 | <0.01 | <0.01 | 0.26 | 0.24 | 0.30 | 0.22 | <0.01 | <0.01 | <0.01 | <0.01 | 1 |
| Reb-M | 1289 | 0.28 | — | 0.25 | 0.27 | 0.19 | 0.19 | 0.19 | <0.01 | 0.16 | 0.36 | <0.01 | 0.14 | <0.01 | 1 |
| Reb-O | 1435 | 1.11 | — | 1.27 | 1.08 | 0.92 | 0.96 | 0.97 | 1.11 | 1.09 | 0.76 | 0.62 | 0.52 | 0.38 | 1 |

| | | | | | | | | | | | | | | |
|---|---|---|---|---|---|---|---|---|---|---|---|---|---|---|
| Sum of molecular | 41.46 | — | 48.53 | 45.19 | 43.56 | 40.24 | 44.85 | 45.81 | 44.15 | 38.63 | 37.22 | 35.34 | 35.90 | 22 |
| mass ≥966 | | | | | | | | | | | | | | |
| Sum of molecular | 16.26 | — | 18.98 | 16.70 | 14.12 | 13.98 | 15.75 | 13.71 | 11.24 | 8.23 | 7.29 | 6.07 | 5.81 | |
| mass ≥1097 | | | | | | | | | | | | | | |
| Sum of molecular | 15.60 | — | 17.94 | 15.64 | 13.28 | 13.33 | 15.03 | 13.71 | 10.88 | 8.23 | 6.85 | 5.65 | 5.14 | |
| mass ≥1111 | | | | | | | | | | | | | | |
| Sum of molecular | 10.80 | — | 12.76 | 11.49 | 9.68 | 9.81 | 10.13 | 8.69 | 7.87 | 5.67 | 5.13 | 3.82 | 3.69 | |
| mass ≥1127 | | | | | | | | | | | | | | |
| Sum of molecular | 1.69 | — | 1.72 | 1.35 | 1.11 | 1.41 | 1.40 | 1.41 | 1.47 | 1.12 | 0.62 | 0.66 | 0.38 | |
| mass ≥1273 | | | | | | | | | | | | | | |
| Sum of molecular | 1.11 | — | 1.27 | 1.08 | 0.92 | 0.96 | 0.97 | 1.11 | 1.09 | 0.76 | 0.62 | 0.52 | 0.38 | |
| mass ≥1305 | | | | | | | | | | | | | | |
| Sum of molecular | 1.11 | — | 1.27 | 1.08 | 0.92 | 0.96 | 0.97 | 1.11 | 1.09 | 0.76 | 0.62 | 0.52 | 0.38 | |
| mass ≥1435 | | | | | | | | | | | | | | |

### Example 14. SG Composition of Exemplary Samples

In a separate analysis, multiple samples of additional exemplary liquid preparations were subjected to HPLC to determine the SG composition of the preparations. The HPLC was calibrated using standards of RA, RB, RC, RD, RE, RF, RG, RM, and RN.

Materials

Reference standards for steviolglycosides (RA, RB, RC, RD, RE, RF, RG, RM, RN) were obtained from Chromadex (LGC Germany). Solvents and reagents (HPLC grade) were obtained from VWR (Vienna) or Sigma-Aldrich (Vienna).

Davisil Grade 633 (high-purity grade silica gel, pore size 60 Å, 200-425 mesh particle size was obtained from Sigma-Aldrich (Vienna).

Sample Preparation

300 mg sample was dissolved in 20 ml Acetonitrile/H₂O=9/1 (v/v).

HPLC-Method

The HPLC system consisted of an Agilent 1100 system (autosampler, ternary gradient pump, column thermostat, VWD-UV/VIS detector, DAD-UV/VIS detector) connected in-line to an Agilent mass spectrometer (ESI-MS quadrupole G1956A VL). For HPLC analysis 150 mg of the corresponding sample was dissolved in Acetonitrile (1 ml) and filled up to 10 ml with H2O.

Samples were separated at 0.8 ml/min on a Phenomenex Synergi Hydro-RP (150×3 mm) followed by a Macherey-Nagel Nucleosil 100-7 C18 (250×4.6 mm) at 45° C. by gradient elution.

Mobile Phase A consisted of a 0.01 molar NH4-Acetate buffer (native pH) with 0.1% acetic acid, 0.05% trimethylamine and 0.001% dichloromethane. Mobile Phase B consisted of 0.01 molar NH4-Acetate buffer (native pH) and Acetonitrile (1/9 v/v) with 0.1% acetic acid, 0.05% trimethylamine and 0.001% dichloromethane. The gradient started with 22% B, was increased linearly in 20 minutes to 45% B and kept at this condition for another 15 minutes. Injection volume was set to 10 μl.

The detectors were set to 210 nm (VWD), to 205 and 254 nm (DAD with spectra collection between 200-600 nm) and to ESI negative mode TIC m/z 300-1500, Fragmentor 200, Gain 2 (MS, 300° C., nitrogen 12 l/min, nebulizer setting 50 psig. Capillary voltage 4500 V).

Detection at 210 nm was used to quantify the chromatograms, the MS-spectra were used to determine the molar mass and structural information of individual peaks. Detection at 254 nm was used to identify non-SG peaks.

Identification and Quantification

SGs were identified by comparison of retention times to authentic reference standards and/or by evaluation of the mass spectra obtained (including interpretation of the fragmentation pattern and double charged ions triggered by the presence of dichloromethane).

Steviol-glycosides were quantified against external standards. In case that no reference standard was available quantification was performed against Reb-A.

The maximum calibration range of reference standards was in a range 0.1-50 mg/10 ml (dissolved in Acetonitrile/H2O=9/1 (v/v)).

Tables 29-31 show the SG content of exemplary compositions of the present disclosure.

TABLE 29
Steviol glycosides in Lot 20180122-2-1 (163.4 mg/10 ml)
Lot 20180122-2-1: Available from Sweet Green Fields.
Prepare according to the method described in Example 11.
It's the spray-dried powder of the supernatant of crude extract.

| Name | m/z [M − H]⁻ | mg/10 ml | % m/m |
|---|---|---|---|
| Related SG #1 | 517 or 427 | 0.27 | 0.17 |
| Related SG #2 | 981 | 0.14 | 0.09 |
| Related SG #3 | 427 or 735 | 1.42 | 0.87 |
| Related SG #4 | 675 or 1127 | <0.01 | <0.01 |
| Related SG #5 | 981 | 0.30 | 0.18 |
| Reb-V | 1259 | 0.09 | 0.06 |
| Reb-T | 1127 | 0.29 | 0.18 |
| Reb-E | 965 | 0.52 | 0.32 |
| Reb-O | 1435 | 1.85 | 1.13 |
| Reb-D | 1127 | 1.17 | 0.71 |
| Reb-K | 1111 | 0.14 | 0.08 |
| Reb-N | 1273 | 0.41 | 0.25 |
| Reb-M | 1289 | 0.06 | 0.04 |
| Reb-S | 949 | 0.02 | 0.01 |
| Reb-J | 1111 | 0.02 | 0.01 |
| Reb-W | 1097 | 0.06 | 0.04 |
| Reb-U2 | 1097 | 0.07 | 0.05 |
| Reb-W2/3 | 1097 | 0.14 | 0.08 |
| Reb-O2 | 965 | 0.02 | 0.01 |
| Reb-Y | 1259 | 0.22 | 0.13 |
| Reb-I | 1127 | 0.06 | 0.04 |
| Reb-V2 | 1259 | 0.35 | 0.22 |
| Reb-K2 | 1111 | 0.11 | 0.07 |
| Reb-H | 1111 | 0.34 | 0.21 |
| Reb-A | 965 | 81.06 | 49.61 |
| Stevioside | 803 | 40.79 | 24.96 |
| Reb-F | 935 | 3.57 | 2.18 |
| Reb-C | 949 | 15.72 | 9.62 |
| Dulcoside-A | 787 | 3.13 | 1.92 |
| Rubusoside | 641 | 1.99 | 1.22 |
| Reb-B | 803 | 1.26 | 0.77 |
| Dulcoside B | 787 | 0.65 | 0.40 |
| Steviolbioside | 641 | 1.38 | 0.84 |
| Reb-R | 935 | 1.49 | 0.91 |
| Reb-G | 803 | 0.46 | 0.28 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 159.57 | 97.65 |

TABLE 30
Steviol glycosides in Lot 20180156-2 (172.1 mg/10 ml)
Lot 20180156-2: Available from Sweet Green Fields. Prepare
according to the method described in Example 11. It's the
spray-dried powder of the supernatant of crude extract.

| Name | m/z [M − H]⁻ | mg/10 ml | % m/m |
|---|---|---|---|
| Related SG #1 | 517 or 427 | <0.01 | <0.01 |
| Related SG #2 | 981 | 1.92 | 1.12 |
| Related SG #3 | 427 or 735 | <0.01 | <0.01 |
| Related SG #4 | 675 or 1127 | <0.01 | <0.01 |
| Related SG #5 | 981 | 1.21 | 0.70 |
| Reb-V | 1259 | 0.45 | 0.26 |
| Reb-T | 1127 | 1.20 | 0.70 |
| Reb-E | 965 | 0.56 | 0.33 |
| Reb-O | 1435 | 1.23 | 0.71 |
| Reb-D | 1127 | 2.18 | 1.27 |
| Reb-K | 1111 | 0.05 | 0.03 |
| Reb-N | 1273 | 0.11 | 0.06 |
| Reb-M | 1289 | 0.11 | 0.06 |
| Reb-S | 949 | 0.52 | 0.30 |
| Reb-J | 1111 | 0.04 | 0.02 |
| Reb-W | 1097 | <0.01 | <0.01 |
| Reb-U2 | 1097 | 0.09 | 0.05 |
| Reb-W2/3 | 1097 | 0.10 | 0.06 |
| Reb-O2 | 965 | <0.01 | <0.01 |
| Reb-Y | 1259 | 1.02 | 0.59 |
| Reb-I | 1127 | 0.21 | 0.12 |
| Reb-V2 | 1259 | 0.08 | 0.05 |
| Reb-K2 | 1111 | 0.06 | 0.03 |
| Reb-H | 1111 | 0.10 | 0.06 |
| Reb-A | 965 | 73.88 | 42.93 |
| Stevioside | 803 | 51.67 | 30.03 |
| Reb-F | 935 | 3.94 | 2.29 |
| Reb-C | 949 | 14.62 | 8.49 |
| Dulcoside-A | 787 | 2.89 | 1.68 |
| Rubusoside | 641 | 3.21 | 1.87 |
| Reb-B | 803 | 0.02 | 0.01 |
| Dulcoside B | 787 | 0.44 | 0.26 |
| Steviolbioside | 641 | 0.38 | 0.22 |
| Reb-R | 935 | 1.66 | 0.97 |
| Reb-G | 803 | 0.19 | 0.11 |
| Stevioside-B | 787 | 2.06 | 1.20 |
| Reb-G1 | 641 | 2.67 | 1.55 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 168.87 | 98.12 |

TABLE 31
Steviolglycosides in Lot 20180143-1 (168.9 mg/10 ml)
Lot 20180143-1: Available from Sweet Green Fields. Prepare
according to the method described in Example 11. It's the
spray-dried powder of the supernatant of crude extract.

| Name | m/z [M − H]⁻ | mg/10 ml | % m/m |
|---|---|---|---|
| Related SG #1 | 517 or 427 | <0.01 | <0.01 |
| Related SG #2 | 981.00 | <0.01 | <0.01 |
| Related SG #3 | 427 or 735 | 0.67 | 0.40 |
| Related SG #4 | 675 or 1127 | 0.22 | 0.13 |
| Related SG #5 | 981 | 0.21 | 0.12 |
| Reb-V | 1259 | 0.14 | 0.08 |
| Reb-T | 1127 | 0.66 | 0.39 |
| Reb-E | 965 | 0.83 | 0.49 |
| Reb-O | 1435 | 3.06 | 1.81 |
| Reb-D | 1127 | 3.44 | 2.03 |
| Reb-K | 1111 | <0.01 | <0.01 |
| Reb-N | 1273 | 0.35 | 0.21 |
| Reb-M | 1289 | 0.04 | 0.02 |
| Reb-S | 949 | 0.23 | 0.13 |
| Reb-J | 1111 | 0.11 | 0.06 |
| Reb-W | 1097 | 0.07 | 0.04 |
| Reb-U2 | 1097 | 0.04 | 0.02 |
| Reb-W2/3 | 1097 | 0.24 | 0.14 |
| Reb-O2 | 965 | <0.01 | <0.01 |
| Reb-Y | 1259 | 0.85 | 0.50 |
| Reb-I | 1127 | 0.04 | 0.02 |
| Reb-V2 | 1259 | 0.11 | 0.06 |
| Reb-K2 | 1111 | 0.21 | 0.12 |
| Reb-H | 1111 | 0.14 | 0.08 |
| Reb-A | 965 | 79.16 | 46.87 |
| Stevioside | 803 | 42.13 | 24.94 |
| Reb-F | 935 | 3.66 | 2.17 |
| Reb-C | 949 | 14.04 | 8.31 |
| Dulcoside-A | 787 | 1.87 | 1.11 |
| Rubusoside | 641 | 2.62 | 1.55 |
| Reb-B | 803 | 0.67 | 0.40 |
| Dulcoside B | 787 | 0.41 | 0.25 |
| Steviolbioside | 641 | 1.39 | 0.83 |
| Reb-R | 935 | 0.03 | 0.02 |
| Reb-G | 803 | 0.10 | 0.06 |
| Stevioside-B | 787 | 2.92 | 1.73 |
| Reb-G1 | 641 | 1.85 | 1.09 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 162.49 | 96.21 |

### Example 15. SG Composition of an Exemplary Sample

In another separate analysis, a sample of an additional exemplary liquid preparation was subjected to HPLC to determine the SG composition of the preparation. The HPLC was calibrated using standards of RA, RB, RC, RD, RE, RF, RG, RM, and RN.

Materials

Reference standards for steviolglycosides (RA, RB, RC, RD, RE, RF, RG, RM, RN) were obtained from Chromadex (LGC Germany). Solvents and reagents (HPLC grade) were obtained from VWR (Vienna) or Sigma-Aldrich (Vienna).

Davisil Grade 633 (high-purity grade silica gel, pore size 60 Å, 200-425 mesh particle size was obtained from Sigma-Aldrich (Vienna).

Sample Preparation

300 mg sample was dissolved in 20 ml Acetonitrile/H₂O=9/1 (v/v).

HPLC-Method

The HPLC system consisted of an Agilent 1100 system (autosampler, ternary gradient pump, column thermostat, VWD-UV/VIS detector, DAD-UV/VIS detector) connected in-line to an Agilent mass spectrometer (ESI-MS quadrupole G1956A VL). For HPLC analysis 150 mg of the corresponding sample was dissolved in Acetonitrile (1 ml) and filled up to 10 ml with H2O.

Samples were separated at 0.8 ml/min on a Phenomenex Synergi Hydro-RP (150×3 mm) followed by a Macherey-Nagel Nucleosil 100-7 C18 (250×4.6 mm) at 45° C. by gradient elution.

Mobile Phase A consisted of a 0.01 molar NH4-Acetate buffer (native pH) with 0.1% acetic acid, 0.05% trimethylamine and 0.001% dichloromethane. Mobile Phase B consisted of 0.01 molar NH4-Acetate buffer (native pH) and Acetonitrile (1/9 v/v) with 0.1% acetic acid, 0.05% trimethylamine and 0.001% dichloromethane. The gradient started with 22% B, was increased linearly in 20 minutes to 45% B and kept at this condition for another 15 minutes. Injection volume was set to 10 μl.

The detectors were set to 210 nm (VWD), to 205 and 254 nm (DAD with spectra collection between 200-600 nm) and to ESI negative mode TIC m/z 300-1500, Fragmentor 200, Gain 2 (MS, 300° C., nitrogen 12 l/min, nebulizer setting 50 psig. Capillary voltage 4500 V).

Detection at 210 nm was used to quantify the chromatograms, the MS-spectra were used to determine the molar mass and structural information of individual peaks. Detection at 254 nm was used to identify non-SG peaks.

Identification and Quantification

SGs were identified by comparison of retention times to authentic reference standards and/or by evaluation of the mass spectra obtained (including interpretation of the fragmentation pattern and double charged ions triggered by the presence of dichloromethane).

Steviol-glycosides were quantified against external standards. In case that no reference standard was available quantification was performed against Reb-A.

The maximum calibration range of reference standards was in a range 0.1-50 mg/10 ml (dissolved in Acetonitrile/H2O=9/1 (v/v)).

Table 32 show the SG content of the present exemplary sample.

TABLE 32
Steviolglycosides in Sample 20170705 (179.7 mg/10 ml)
Sample 20170705: Available from Sweet Green Fields. Prepare
according to the method described in Example 11. It's the crude extract.

| Name | m/z [M − H]⁻ | mg/10 ml | % m/m |
|---|---|---|---|
| Related steviol glycoside #1 | 517 or 427 | <0.01 | <0.01 |
| Related steviol glycoside #2 | 981 | 0.23 | 0.130 |
| Related steviol glycoside #3 | 427 or 735 | 0.27 | 0.151 |
| Related steviol glycoside #4 | 675 or 1127 | 0.07 | 0.037 |
| Related steviol glycoside #5 | 981 | 2.23 | 1.242 |
| Reb-V | 1259 | <0.01 | <0.01 |
| Reb-T | 1127 | <0.01 | <0.01 |
| Reb-E | 965 | 0.87 | 0.487 |
| Reb-O | 1435 | 0.02 | 0.009 |
| Reb-D | 1127 | 2.63 | 1.464 |
| Reb-K | 1111 | 0.06 | 0.035 |
| Reb-N | 1273 | 0.03 | 0.014 |
| Reb-M | 1289 | 0.07 | 0.038 |
| Reb-S | 949 | 0.00 | −0.002 |
| Reb-J | 1111 | 0.05 | 0.028 |
| Reb-W | 1097 | 0.13 | 0.074 |
| Reb-U2 | 1097 | <0.01 | <0.01 |
| Reb-W2/3 | 1097 | <0.01 | <0.01 |
| Reb-O2 | 965 | 0.08 | 0.047 |
| Reb-Y | 1259 | 0.09 | 0.050 |
| Reb-I | 1127 | <0.01 | <0.01 |
| Reb-V2 | 1259 | <0.01 | <0.01 |
| Reb-K2 | 1111 | 1.19 | 0.661 |
| Reb-H | 1111 | <0.01 | <0.01 |
| Reb-A | 965 | 91.72 | 51.041 |
| Stevioside | 803 | 55.43 | 30.844 |
| Reb-F | 935 | 0.15 | 0.086 |
| Reb-C | 949 | 7.40 | 4.118 |
| Dulcoside-A | 787 | 0.45 | 0.248 |
| Rubusoside | 641 | 0.47 | 0.260 |
| Reb-B | 803 | 4.02 | 2.239 |
| Dulcoside B | 787 | 0.65 | 0.362 |
| Steviolbioside | 641 | 0.96 | 0.531 |
| Reb-R | 935 | 0.01 | 0.005 |
| Reb-G | 803 | 0.23 | 0.128 |
| Stevioside-B | 787 | 0.94 | 0.526 |
| Reb-G1 | 641 | <0.01 | <0.01 |
| Reb-R1 | 773 | 1.39 | 0.771 |
| Reb-F1 | 773 | <0.01 | <0.01 |
| Iso-Steviolbioside | 641 | 0.23 | 0.130 |
| | Sum | 171.33 | 95.34 |

### Example 16. SG Concentration to Reach Sweetness of 3, 5 and 7% Sucrose Solutions

Solutions of different SG standards and SG compositions were made and compared with 3%, 5% and 7% sucrose solutions. The target was to find out the right amount to reach the same maximum sweetness as the reference solutions.

Materials

Reference standards for sucrose at 3, 5 and 7% concentrations were prepared in purified H₂O. Dilutions of Sample Composition #3 (Table 16), Sample Composition #4 (Table 17), Sample Composition #11 (Table 24), and Sample Composition #12 (Table 25) were also prepared in purified H₂O.

Sample Testing

Sample dilutions of SG compositions were tasted by a panel of trained tasters and compared to the 3, 5, and 7% sucrose solutions to determine the concentration (in ppm) of each that was equivalent in sweetness to each sucrose concentration, establishing the sucrose equivalent (SE) of each.

Results are shown in Table 33 for the sample compositions.

TABLE 33
Sucrose Equvalent Concentrations of SG Sample Compositions

| SG Composition | sucrose solution | SE [ppm] |
|---|---|---|
| Sample Composition #3 | 3% | 160 |
| Sample Composition #4 | 3% | 149 |
| Sample Composition #11 | 3% | 164 |
| Sample Composition #12 | 3% | 159 |
| Sample Composition #3 | 5% | 398 |
| Sample Composition #4 | 5% | 392 |
| Sample Composition #11 | 5% | 404 |
| Sample Composition #12 | 5% | 416 |
| Sample Composition #3 | 7% | 651 |
| Sample Composition #4 | 7% | 687 |
| Sample Composition #11 | 7% | 701 |
| Sample Composition #12 | 7% | 692 |

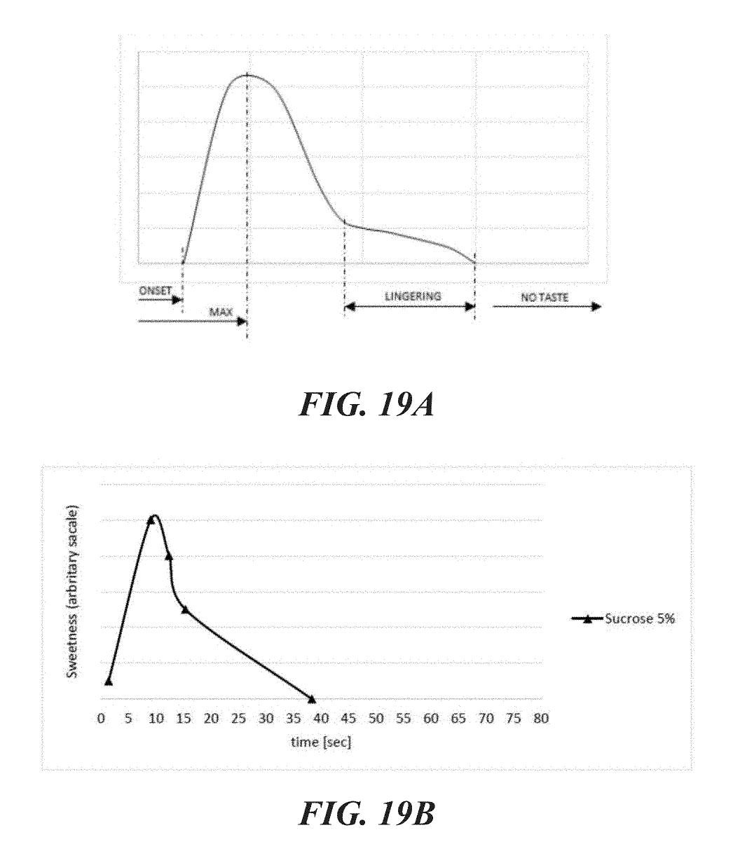

Sweetness profiles were then created for Sample Composition #3, Sample Composition #4, Sample Composition #11, and Sample Composition #12 at each SE concentration. A generic example for a sweetness profile is shown in FIG. 19A and a sweetness profile for 5% sucrose is shown in FIG. 19B.

Sample Testing

Sample Composition #3, Sample Composition #4, Sample Composition #11, and Sample Composition #12 were tested at the concentrations shown in Table 33. Results are shown in Table 34 (3% SE), Table 35 (5% SE) and Table 36 (7% SE).

TABLE 34
Sweetness Profiles of Sample Compositions at 3% SE

| | | Time in seconds to | | | | |
|---|---|---|---|---|---|---|
| Sample | | | | | LINEGRING | |
| Composition | SE (%) | ONSET | MAX | LINGERING ON | OFF | NO TASTE |
| #3 | 3% | 2.5 | 10.0 | 16.0 | 25.0 | 28.5 |
| #4 | 3% | 3.5 | 10.5 | 16.0 | 24.0 | 28.5 |
| #11 | 3% | 4.0 | 11.0 | 15.0 | 26.0 | 31.0 |
| #12 | 3% | 3.5 | 12.0 | 17.5 | 26.0 | 33.0 |

TABLE 35
Sweetness Profiles of Sample Compositions at 5% SE

| | | Time in seconds to | | | | |
|---|---|---|---|---|---|---|
| Sample | | | | | LINEGRING | |
| Composition | SE (%) | ONSET | MAX | LINGERING ON | OFF | NO TASTE |
| #3 | 5% | 0.5 | 10.5 | 16.5 | 28.0 | 36.0 |
| #4 | 5% | 1.5 | 6.0 | 12.0 | 24.0 | 30.5 |
| #11 | 5% | 2.0 | 8.5 | 13.0 | 23.5 | 32.5 |
| #12 | 5% | 3.0 | 11.0 | 15.5 | 27.7 | 37.0 |

TABLE 36
Sweetness Profiles of Sample Compositions at 7% SE

| | | Time in seconds to | | | | |
|---|---|---|---|---|---|---|
| Sample | | | | | LINEGRING | |
| Composition | SE (%) | ONSET | MAX | LINGERING ON | OFF | NO TASTE |
| #3 | 7% | 0.0 | 7.0 | 15.0 | 30.0 | 41.0 |
| #4 | 7% | 1.5 | 8.0 | 15.5 | 27.5 | 34.5 |
| #11 | 7% | 1.5 | 9.5 | 15.5 | 29.0 | 36.0 |
| #12 | 7% | 2.5 | 12.0 | 18.0 | 32.0 | 41.0 |

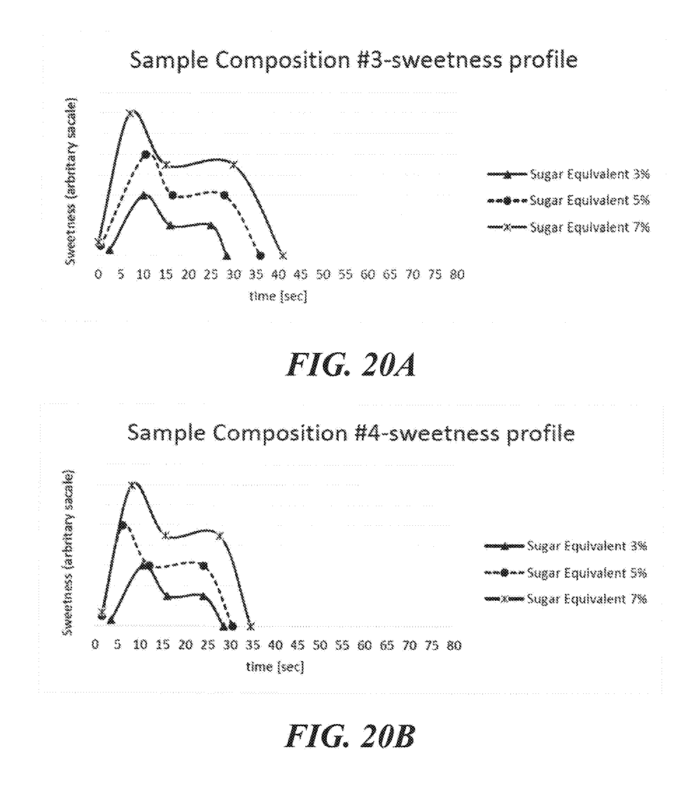

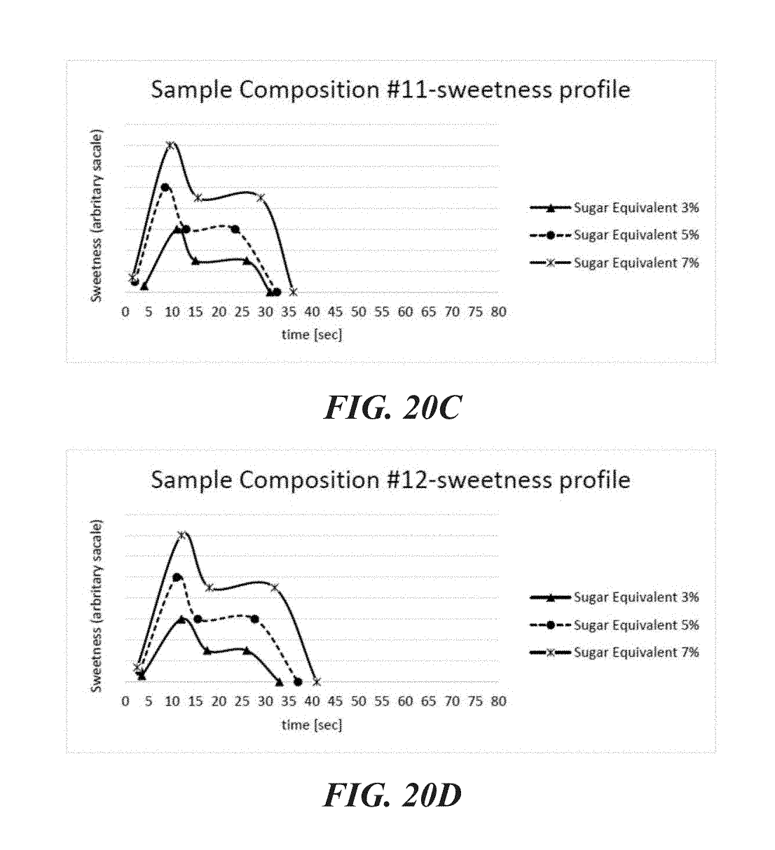

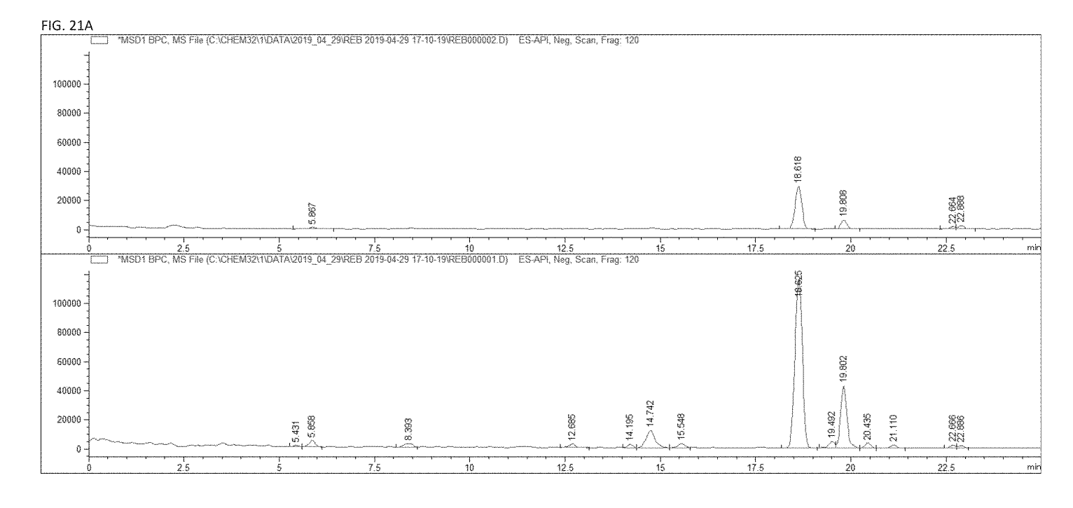

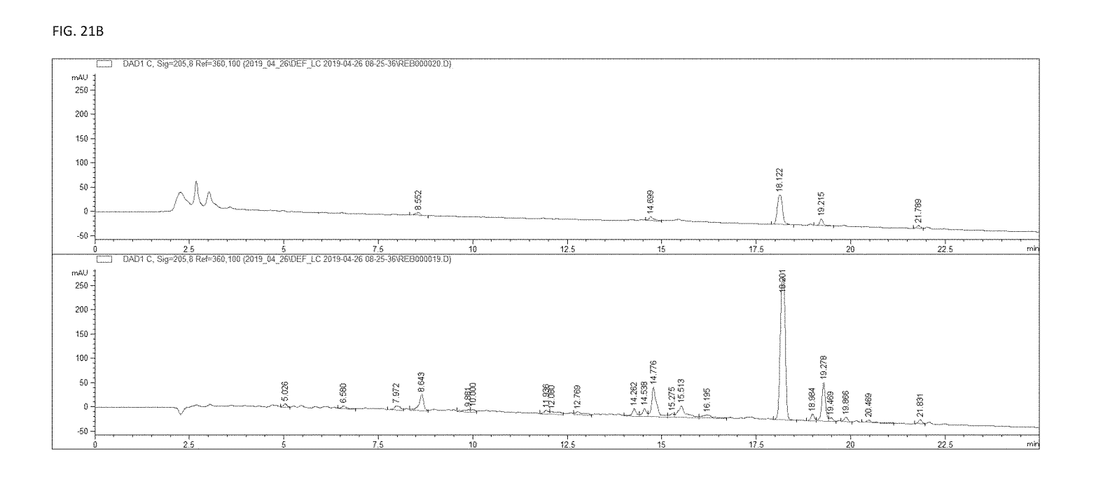

Graphic representation of the sweetness profiles for Sample Compositions 3, 4, 11 and 12 are shown in FIGS. 20A-D.

### Example 17. Establishing Charming Threshold and Detection Threshold for SG Compositions

Test Solutions

SG sample compositions #3 (Table 16), #4 (Table 17), #5 (Table 18), #6 (Table 19), #7 (Table 20), #8 (Table 21), #9 (Table 22), #10 (Table 23), #11 (Table 24), #12 (Table 25), and #13 (Table 26) were individually diluted to establish a charming (CT) and a detection threshold (DT). A pooled mixture of equal amounts of Sample Compositions #3-#10 (Pool 3-10) and a pooled mixture of equal amounts of Sample Compositions #11-#13 (Pool 11-13) were also diluted to establish a CT and a DT.

Serial dilutions of 0, 2.5, 5.0, 7.5, 10.0, 12.5, 15.0, 17.5 and 20.0 mg/L were prepared. The concentrations were chosen after a simple, open tasting of 20 mg/L (5 panelists) in which all sample compositions were perceived as “sweet.”

For triangle tests, the following samples were chosed: CT concentrations of Pool 3-10 and Pool 11-13; DT concentration of Pool 3-10 and Pool 11-13; CT concentration of sucrose (3 g/L); and a sucrose solution (15 g/L) assessed as low intensity, but clearly sweet, concentration.

Determination of Threshold

To establish CT (defined as the concentration where a difference to pure water is observed but no taste description is given) and DT (defined as the concentration where a difference to pure water is observed and a correct taste description is given) serially diluted solutions were presented to 10 panelists in ascending order of concentration. Panelists marked their perceptions in a table, as shown in Table 37, with a “0” for no taste, “?” for an unclear taste perception, “x” for a sweet taste perception, or “xx”-“xxxxx” for increasing sweet taste perception.

TABLE 37
Taste Perception Scoring Table

| | | | | | | | |
|---|---|---|---|---|---|---|---|
| Solution: | 1 | 2 | 3 | 4 | 5 | . . . | Evaluation: |

Taste Perception¹⁾:

The corresponding individual threshold values were then computed from the individual panelist results according to the following formulas:

CT_{ind}=\sqrt{C_{CT}−C_{CT-1}} Equation 1a:

and

DT_{ind}=\sqrt{C_{DT}−C_{DT-1}} Equation 1b:

C_{CT} is the charming threshold concentration and CCT-1 the concentration below this concentration, CDT is the detection threshold concentration and CDT-1 the concentration below this concentration.

The final group values were then computed using the formulas:

$$\begin{matrix}{CT}_{group} = \sqrt[n]{{\prod }_{i = 1}^{n} {CT}_{ind}} & Equation 2 a \\ and & \\ {DT}_{group} = \sqrt[n]{{\prod }_{i = 1}^{n} {DT}_{ind}} & Equation 2 b\end{matrix}$$

Triangle Tests

24 panelists were chosen according to Table 38 to establish with a 95% probability (100−β) a scenario where 50% of the panelists (p_{d}) can recognize the difference at a significance level α=0.05.

TABLE 38
Minimum Number of Panelists for a Triangle Test

| | | β | | | | |
|---|---|---|---|---|---|---|
| α | p4 | 0.20 | 0.10 | 0.05 | 0.01 | 0.001 |
| 0.20 | 50% | 7 | 12 | 16 | 25 | 36 |
| 0.10 | | 12 | 15 | 20 | 30 | 43 |
| 0.05 | | 16 | 20 | 23 | 35 | 48 |
| 0.01 | | 25 | 30 | 35 | 47 | 62 |
| 0.001 | | 36 | 43 | 48 | 62 | 81 |
| 0.20 | 40% | 12 | 17 | 25 | 36 | 55 |
| 0.10 | | 17 | 25 | 30 | 46 | 67 |
| 0.05 | | 23 | 30 | 40 | 57 | 79 |
| 0.01 | | 35 | 47 | 56 | 76 | 102 |
| 0.001 | | 55 | 68 | 76 | 102 | 130 |
| 0.20 | 30% | 20 | 28 | 39 | 64 | 97 |
| 0.10 | | 30 | 43 | 54 | 81 | 119 |
| 0.05 | | 40 | 53 | 66 | 98 | 136 |
| 0.01 | | 62 | 82 | 97 | 131 | 181 |
| 0.001 | | 93 | 120 | 138 | 181 | 233 |

Panelists were randomly allocated the following six sequences of the two samples A and B: ABB, BAA, AAB, ABA, BBA and BAB. Samples were marked with random 3 digit numbers.

After conducting the test, the number of correct answers (i.e., the difference between samples was correctly recognized) were compared to Table 39 (minimum required, correct answers for establishment of a difference at the given significance level).

TABLE 39
Minimum Number of Correct Answers for a Triangle Test to establish
a Difference

| | α | | | | |
|---|---|---|---|---|---|
| n | 0.20 | 0.10 | 0.05 | 0.01 | 0.001 |
| 6 | 4 | 5 | 5 | 6 | — |
| 7 | 4 | 5 | 5 | 6 | 7 |
| 8 | 5 | 5 | 6 | 7 | 8 |
| 9 | 5 | 6 | 6 | 7 | 8 |
| 10 | 6 | 6 | 7 | 8 | 9 |
| 11 | 6 | 7 | 7 | 8 | 10 |
| 12 | 6 | 7 | 8 | 9 | 10 |
| 13 | 7 | 8 | 8 | 9 | 11 |
| 14 | 7 | 8 | 9 | 10 | 11 |
| 15 | 8 | 8 | 9 | 10 | 12 |
| 16 | 8 | 9 | 9 | 11 | 12 |
| 17 | 8 | 9 | 10 | 11 | 13 |
| 18 | 9 | 10 | 10 | 12 | 13 |
| 19 | 9 | 10 | 11 | 12 | 14 |
| 20 | 9 | 10 | 11 | 13 | 14 |
| 21 | 10 | 11 | 12 | 13 | 15 |
| 22 | 10 | 11 | 12 | 14 | 15 |
| 23 | 11 | 12 | 12 | 14 | 16 |
| 24 | 11 | 12 | 13 | 15 | 16 |
| 25 | 11 | 12 | 13 | 15 | 17 |
| 26 | 12 | 13 | 14 | 15 | 17 |
| 27 | 12 | 13 | 14 | 16 | 18 |
| 28 | 12 | 14 | 15 | 16 | 18 |
| 29 | 13 | 14 | 15 | 17 | 19 |
| 30 | 13 | 14 | 15 | 17 | 19 |
| 31 | 14 | 15 | 16 | 18 | 20 |
| 32 | 14 | 15 | 16 | 18 | 20 |
| 33 | 14 | 15 | 17 | 18 | 21 |
| 34 | 15 | 16 | 17 | 19 | 21 |
| 35 | 15 | 16 | 17 | 19 | 21 |
| 36 | 15 | 17 | 18 | 20 | 22 |
| 42 | 18 | 19 | 20 | 22 | 25 |
| 48 | 20 | 21 | 22 | 25 | 27 |
| 54 | 22 | 23 | 25 | 27 | 30 |
| 60 | 24 | 26 | 27 | 30 | 33 |
| 66 | 26 | 28 | 29 | 32 | 35 |
| 72 | 28 | 30 | 32 | 34 | 38 |
| 78 | 30 | 32 | 34 | 37 | 40 |
| 84 | 33 | 35 | 36 | 39 | 43 |
| 90 | 35 | 37 | 38 | 42 | 45 |
| 96 | 37 | 39 | 41 | 44 | 48 |
| 102 | 39 | 41 | 43 | 46 | 50 |

Results for the CT concentration and DT concentration determination are shown in Tables 40-42. Bold numbers indicate the majority decision of the panelists; with the first assessment being “different from water, undefined taste,” and the second assessment being “different from water, sweet taste.”

TABLE 40
Threshold Concentrations Derived from the Test Results

| | | Charming | | Detection |
|---|---|---|---|---|
| | | Threshold | | Threshold |
| Sample | Number of | Concentration | Number | Concentration |
| Composition | Panelists | (mg/L) | of Panelists | (mg/L) |
| #3 | 1 | 2.5 | — | 5.0 |
| | 7 | 5.0 | 8 | 7.5 |
| | 2 | 7.5 | 2 | 10.0 |
| #4 | 3 | 5.0 | 1 | 10.0 |
| | 6 | 7.5 | 7 | 12.5 |
| | 1 | 10.0 | 2 | 15.0 |
| #5 | — | 2.5 | 1 | 5.0 |
| | 9 | 5.0 | 9 | 7.5 |
| | 1 | 7.5 | — | 10.0 |
| #6 | — | 0.0 | — | 2.5 |
| | 7 | 2.5 | 8 | 5.0 |
| | 3 | 5.0 | 2 | 7.5 |
| #7 | 3 | 5.0 | 2 | 10.0 |
| | 6 | 7.5 | 6 | 12.5 |
| | 1 | 10.0 | 2 | 15.0 |
| #8 | 3 | 7.5 | 1 | 10.0 |
| | 6 | 10.0 | 7 | 12.5 |
| | 1 | 12.5 | 2 | 15.0 |
| #9 | — | 5.0 | 1 | 7.5 |
| | 7 | 7.5 | 6 | 10.0 |
| | 3 | 10.0 | 3 | 12.5 |
| #10 | — | 2.5 | 1 | 7.5 |
| | 5 | 5.0 | 8 | 10.0 |
| | 5 | 7.5 | 1 | 12.5 |
| #11 | — | 2.5 | 2 | 5.0 |
| | 7 | 5.0 | 6 | 7.5 |
| | 3 | 7.5 | 2 | 10.0 |
| #12 | 1 | 2.5 | 2 | 7.5 |
| | 6 | 5.0 | 7 | 10.0 |
| | 3 | 7.5 | 1 | 12.5 |
| #13 | — | 5.0 | 1 | 7.5 |
| | 8 | 7.5 | 9 | 10.0 |
| | 2 | 10.0 | — | 12.5 |
| Pool 3-10 | 1 | 5.0 | 3 | 7.5 |
| | 7 | 7.5 | 6 | 10.0 |
| | 3 | 10.0 | 1 | 12.5 |
| Pool 11-13 | — | 2.5 | — | 5.0 |
| | 6 | 5.0 | 7 | 7.5 |
| | 4 | 7.5 | 3 | 10.0 |

TABLE 41
Computed Group Threshold Values (according to Equations 1a and 1b)

| | | Charming | | Detection |
|---|---|---|---|---|
| Sample | number of | Threshold | number of | Threshold |
| Composition | panelists | (mg/L) | panelists | (mg/L) |
| #3 | 1 | 1.6 | — | — |
| | 7 | 3.5 | 8 | 6.1 |
| | 2 | 6.1 | 2 | 8.7 |
| #4 | 3 | 3.5 | 1 | 8.7 |
| | 6 | 6.1 | 7 | 11.2 |
| | 1 | 8.7 | 2 | 13.7 |
| #5 | — | — | 1 | 3.5 |
| | 9 | 3.5 | 9 | 6.1 |
| | 1 | 6.1 | — | — |
| #6 | — | — | — | — |
| | 7 | 1.6 | 8 | 3.5 |
| | 3 | 3.5 | 2 | 6.1 |
| #7 | 3 | 3.5 | 2 | 8.7 |
| | 6 | 6.1 | 6 | 11.2 |
| | 1 | 8.7 | 2 | 13.7 |
| #8 | 3 | 6.1 | 1 | 8.7 |
| | 6 | 8.7 | 7 | 11.2 |
| | 1 | 11.2 | 2 | 13.7 |
| #9 | — | — | 1 | 6.1 |
| | 7 | 6.1 | 6 | 8.7 |
| | 3 | 8.7 | 3 | 11.2 |
| #10 | — | — | 1 | 6.1 |
| | 5 | 3.5 | 8 | 8.7 |
| | 5 | 6.1 | 1 | 11.2 |
| #11 | — | — | 2 | 3.5 |
| | 7 | 3.5 | 6 | 6.1 |
| | 3 | 6.1 | 2 | 8.7 |
| #12 | 1 | 1.6 | 2 | 6.1 |
| | 6 | 3.5 | 7 | 8.7 |
| | 3 | 6.1 | 1 | 11.2 |
| #13 | — | — | 1 | 6.1 |
| | 8 | 6.1 | 9 | 8.7 |
| | 2 | 8.7 | — | — |
| Pool 3-10 | 1 | 3.5 | 3 | 6.1 |
| | 7 | 6.1 | 6 | 8.7 |
| | 3 | 8.7 | 1 | 11.2 |
| Pool 11-13 | — | — | — | — |
| | 6 | 3.5 | 7 | 6.1 |
| | 4 | 6.1 | 3 | 8.7 |

TABLE 42
Computed Group Threshold Values (according to Equations 2a and 2b)

| Sample | Charming Threshold | Detection Threshold |
|---|---|---|
| Composition | (mg/L) | (mg/L) |
| #3 | 3.6 | 6.6 |
| #4 | 5.4 | 11.3 |
| #5 | 3.7 | 5.8 |
| #6 | 2.0 | 3.9 |
| #7 | 5.4 | 11.1 |
| #8 | 8.0 | 11.3 |
| #9 | 6.8 | 9.0 |
| #10 | 4.7 | 8.6 |
| #11 | 4.2 | 5.9 |
| #12 | 3.8 | 8.3 |
| #13 | 6.6 | 8.4 |
| Pool 3-10 | 7.7 | 8.0 |
| Pool 11-13 | 4.4 | 6.8 |

Based on these results, the pooled samples were further submitted to triangle tests to investigate sweetness enhancing effects. Table 43 shows the concentrations of the test solutions, while Table 44 shows the test design and Table 45 shows the results from Part 1 of the triangle testing.

TABLE 43
Test Solutions for Part 1 of Triangle Testing

| | Concentration |
|---|---|
| Test solution | (mg/L) |
| CT Pool 3-10 | 7.50 |
| CT Pool 11-13 | 5.00 |
| DT Pool 3-10 | 10.00 |
| DT Pool 11-13 | 7.50 |
| CT Sucrose | 3000 |

TABLE 44
Test Design for Part 1 of Triangle Testing

| | Triangle | | |
|---|---|---|---|
| Target | Test | A | B |
| Recognition of difference | #1 | CT Pool 3-10 | CT Sucrose |
| Recognition of difference | #2 | CT Pool 11-13 | CT Sucrose |
| Difference in Sweetness | #3 | CT Pool 3-10 | DT Pool 3-10 |
| Difference in Sweetness | #4 | CT Pool 11-13 | DT Pool 11-13 |

TABLE 45
Test Results Including Interpretation for Part 1 of Triangle Testing

| | Triangle | | |
|---|---|---|---|
| Target | Test | Correct answers | Interpretation |
| Recognition of | #1 | 4/24 | No difference (p > 0.20) |
| difference | | | |
| Recognition of | #2 | 9/24 | No difference (p > 0.20) |
| difference | | | |
| Difference in | #3 | 16/24 | DT more sweet than CT |
| Sweetness¹⁾ | | | (p < 0.05) |
| Difference in | #4 | 19/24 | DT more sweet than CT |
| Sweetness¹⁾ | | | (p < 0.05) |

¹⁾DT is more sweet than CT

Table 46 shows the concentrations of the test solutions, while Table 47 shows the test design and Table 48 shows the results from Part 2 of the triangle testing.

TABLE 46
Test Solutions for Part 2 of Triangle Testing

| | Concentration |
|---|---|
| Test solutions | (mg/L) |
| CT Sucrose | 3000 |
| DT Pool 3-10 | 10 |
| CT Sucrose | 3000 |
| DT Pool 11-13 | 7.5 |
| Sucrose “Sweet” | 15000 |
| DT Pool 3-10 | 10.00 |
| Sucrose “Sweet” | 15000 |
| DT Pool 11-13 | 7.5 |
| CT Sucrose | 3000 |
| Sucrose “Sweet” | 15000 |

TABLE 47
Test Design for Part 2 of Triangle Testing

| Target | Triangle Test | A | B |
|---|---|---|---|
| Difference in Sweetness | #5 | CT Sucrose/ | CT Sucrose |
| | | DT Pool 3-10 | |
| Difference in Sweetness | #6 | CT Sucrose/ | CT Sucrose |
| | | DT Pool 11-13 | |
| Difference in Sweetness | #7 | Sucrose “Sweet”/ | Sucrose “Sweet” |
| | | DT Pool 3-10 | |
| Difference in Sweetness | #8 | Sucrose “Sweet”/ | Sucrose “Sweet” |
| | | DT Pool 11-13 | |

TABLE 48
Test Results Including Interpretation for Part 2 of Triangle Testing

| | Triangle | Correct | |
|---|---|---|---|
| Target | Test | answers | Interpretation |
| Difference in | #5 | 12/24 | No difference (p = 0.05) |
| Sweetness¹⁾ | | | Difference (p = 0.10) |
| Difference in | #6 | 14/24 | Difference (p < 0.05) |
| Sweetness¹⁾ | | | |
| Difference in | #7 | 19/24 | Difference (p < 0.05) |
| Sweetness¹⁾ | | | |
| Difference in | #8 | 22/24 | Difference (p < 0.05) |
| Sweetness¹⁾ | | | |

¹⁾Mixture is sweeter than corresponding pure sample

In a final series of triangle tests the extent of the sweetness increase was tested by 6 panelists. Table 49 shows the concentrations of the test solutions, while Table 50 shows the test design and Table 51 shows the results from Part 3 of the triangle testing.

TABLE 49
Test Solutions for Part 3 of Triangle Testing

| Test solutions | Concentration (mg/L) |
|---|---|
| Sucrose “Sweet” (1.5%) | 15000 |
| DT Pool 3-10 | 10 |
| Sucrose “Sweet” | 15000 |
| DT Pool 11-13 | 7.5 |
| Sucrose 2% | 20000 |
| Sucrose 2.5% | 25000 |

TABLE 50
Test Design for Part 3 of Triangle Testing

| | Triangle | | |
|---|---|---|---|
| Target | Test | A | B |
| Difference in Sweetness | #9 | Sucrose “Sweet”/ | Sucrose 2% |
| | | DT Pool 3-10 | |
| Difference in Sweetness | #10 | Sucrose “Sweet”/ | Sucrose 2% |
| | | DT Pool 11-13 | |
| Difference in Sweetness | #11 | Sucrose “Sweet”/ | Sucrose 2.5% |
| | | DT Pool 3-10 | |
| Difference in Sweetness | #12 | Sucrose “Sweet”/ | Sucrose 2.5% |
| | | DT Pool 11-13 | |

TABLE 51
Test Results Including Interpretation for Part 3 of Triangle Testing

| | Triangle | Correct | |
|---|---|---|---|
| Target | Test | answers | Interpretation |
| Difference in Sweetness¹⁾ | #9 | 8/24 | No difference (p > 0.20) |
| Difference in Sweetness¹⁾ | #10 | 10/24 | No difference (p > 0.20) |
| Difference in Sweetness¹⁾ | #11 | 15/24 | Difference (p < 0.05) |
| Difference in Sweetness¹⁾ | #12 | 28/24 | Difference (p < 0.05) |

¹⁾Sucrose 2% and Sucrose 2.5% are sweeter than the mixture of sucrose 1.5% with pooled mother liquid

Conclusion

The threshold test showed CT and DT in the range of 5-10 mg sample/L. Pooled samples 3-10 and 11-13 yielded group charming thresholds of 7.7 and 4.4 mg/L, respectively, with corresponding detection thresholds of 8.0 and 6.8 mg/L, respectively.

The triangle tests showed convincingly that the pooled samples for sample compositions at concentrations near to or very slightly above the sweetness threshold exert a clear sweetness enhancing effect when added at DT concentrations. A first estimate provides evidence for an increase in sucrose sweetness from 1.5% sucrose to 2.0% sucrose.

### Example 18. Evaluation of Flavoring Compositions

SG Compositions

Two SG compositions were evaluated for their equi-sweetness and flavor modifying properties. The SG make up of lots of A1 and A2 are shown in Table 52.

TABLE 52
Lot Compositions of Samples A1 and A2

| | Lot # | RD | RA | STV | RF | RC | Dulc A | RUB | RB | STB | RM | Total SG |
|---|---|---|---|---|---|---|---|---|---|---|---|---|
| A1 | A1-1 | 3.61 | 22.39 | 21.16 | 1.51 | 9.35 | 0.8 | 0.41 | 0.03 | 0.29 | 1.81 | 61.36 |
| | A1-1 | 3.07 | 26.47 | 22.97 | 1.9 | 10.24 | 0.97 | 0.44 | 1 | 0.57 | 2.54 | 70.17 |
| | A1-2 | 5.35 | 25.74 | 18.87 | 2.11 | 11.41 | 0.56 | 0.34 | 2.01 | 0.86 | 3.22 | 70.47 |
| | A1-3 | 6.33 | 21.68 | 14.96 | 1.7 | 9.09 | 0.41 | 0.2 | 3.84 | 1.68 | 3.84 | 63.73 |
| | A1-4 | 5.59 | 25.06 | 21.2 | 1.7 | 8.89 | 0.42 | 0.18 | 1.91 | 0.85 | 2.98 | 68.78 |
| | A1-5 | 8.06 | 31.11 | 9.48 | 1.69 | 8.67 | 0.29 | 0.16 | 2.82 | 0.96 | 3.41 | 66.65 |
| A2 | A2-1 | 1.52 | 25.04 | 30.63 | 1.99 | 11.43 | 1.26 | 0.77 | 0.11 | 0.82 | 0.69 | 74.26 |
| | A2-2 | 0.32 | 22.31 | 33.34 | 2.63 | 14.65 | 2.35 | 2.11 | 1.88 | 1.06 | 0.2 | 80.85 |
| | A2-3 | 0.34 | 20.96 | 28.32 | 2.76 | 16.47 | 1.8 | 1.61 | 2.68 | 2.3 | 0.37 | 77.61 |
| | A2-4 | 1.15 | 26.07 | 29.31 | 2.96 | 17.16 | 1.57 | 1.32 | 1.89 | 0.67 | 0.64 | 82.74 |
| | A2-5 | 0.44 | 24.73 | 34.07 | 2.56 | 14.86 | 1.69 | 1.47 | 2.34 | 0.43 | 0.52 | 83.11 |

A1 is a mixture of A1-1 to A1-5, A2 is a mixture of A2-1 to A2-5. A1 and A2 are available from Sweet Green Fields. A1 was prepared according to the method described in Example 11. It's the spray-dried powder of 30% ethanol desorption solution. A2 was prepared according to the method described in Example 11. It's the spray-dried powder of 70% ethanol desorption solution.

Test for Equi-Sweetness

The equi-sweetness of A1 and A2 was established as highest concentration of each sample which tastes less sweet than a 1.5% (m/m) sucrose solution.

24 panelists were chosen to establish with a 95% probability (100−β) a scenario where 50% of the panelists (pd) can recognize an existing difference at a significance level α=0.05. The statistical decision was based on Tables 44 and 45 for the minimum required correct answers in a triangle test.

The panelists were randomly allocated to following sequences of the two samples A and B: ABB, BAA, AAB, ABA, BBA and BAB.

Samples were marked with random 3 digit numbers. All panelists recorded their observations on a table as shown in Table 53.

TABLE 53
Panelist Recordation of Sweetness Observation

| sensory code | which one is sweeter? |
|---|---|
| ____/____/____ | |

Correct identification of the different samples by panelists were counted and compared to the total number of panelists. This test design is a triangle test with a 3-AFC test design (3 Alternative Forced Choice Test). Table 54 shows the samples tested in six independent trials and Table 55 shows the results of the tests.

TABLE 54
Test Design for Triangle Tests with a 3-AFC Test Design

| Target | Test | A¹⁾ | B |
|---|---|---|---|
| Recognition of | #1 | 65 ppm A1 in water | 1.5% sucrose |
| difference | #2 | 70 ppm A1 in water | |
| | #3 | 75 ppm A1water | |
| | #4 | 65 ppm A2 in water | |
| | #5 | 70 ppm A2 in water | |
| | #6 | 75 ppm A2 in water | |

¹⁾concentrations were chosen on basis of pre-tests with 5 test persons

TABLE 55
Test Results for Equi-Sweetness Tests

| | Correctly identified | |
|---|---|---|
| | and rated sweeter/ | |
| | total number of | Statistical |
| Test # | test persons | significance |
| #1 | 6/24 | not significant |
| #2 | 12/24 | significant (p < 0.1) |
| #3 | 16/24 | significant (p < 0.01) |
| #4 | 2/24 | not significant |
| #5 | 11/24 | significant (p < 0.2) |
| #6 | 14/24 | significant (p < 0.05) |

Based on a fixed significance level of 5%, the highest concentrations not recognized as sweeter than a 1.5% sucrose solution are 70 ppm for both A1 and A2. At this concentration, A1 and A2 can be used as flavor due to a lack of “primary sweet taste.”

Test for Flavor Modifying Properties of A1 and A2

The potential flavor modifying properties of A1 and A2 were tested for 2 separate properties. In a first series of tests the effect on the sweetness intensity was evaluated. In a second series of tests the effect on the flavor perception was evaluated.

Qualitative Effect on Sweetness

24 panelists were chosen to establish with a 95% probability (100−β) a scenario where 50% of the panelists (pd) can recognize an existing difference at a significance level α=0.05. The statistical decision was based on Tables 38 and 39 for the minimum required correct answers in a triangle test.

The panelists were randomly allocated to following sequences of the two samples A and B: ABB, BAA, AAB, ABA, BBA and BAB.

Samples were marked with random 3 digit numbers. All panelists recorded their observations on a table as shown in Table 56.

TABLE 56
Panelist Recordation of Sweetness Observation

| sensory code | which one is sweeter? |
|---|---|
| ____/____/____ | |

Correct identification of the different samples by panelists were counted and compared to the total number of panelists. This test design is a triangle test with a 3-AFC test design (3 Alternative Forced Choice Test). Table 57 shows the samples tested in two independent trials.

TABLE 57
Test Design for Triangle Tests
with a 3-AFC Test Design

| Target | Test | A | B |
|---|---|---|---|
| Recognition | #1 | 5% Sucrose plus 70 ppm A1in water | 5% |
| of | #2 | 5% Sucrose plus 70 ppm A2 in water | Sucrose |
| Difference | | | |

In the test with A1, 18/24 rated the sample with 5% sucrose plus added Awesome-01 as more sweet than the sample with 5% sucrose alone. The corresponding number for the test with A2 was 21/24. Accordingly, both A1 and A2 added at a dose of 70 ppm increases the sweetness of a 5% sugar solution significantly (p<<0.001).

Quantitative Effect on Sweetness

After establishing a qualitative flavor modifying effect (sweetness increasing), triangle tests were performed with the same requirements as the qualitative tests, with samples as shown in Table 58 in order to estimate the quantitative effect of sweetness increase. Table 59 shows the quantitative results.

TABLE 58
Test Design for Triangle Tests
with a 3-AFC Test Design

| Target | Test | A | B |
|---|---|---|---|
| Recognition of | #1 | 5% Sucrose | 6.0% Sucrose |
| Difference | #2 | plus 70 ppm | 6.5% Sucrose |
| | #3 | A1 in water | 7.0% Sucrose |
| | #4 | 5% Sucrose | 6.0% Sucrose |
| | #5 | plus 70 ppm | 6.5% Sucrose |
| | #6 | A2 in water | 7.0% Sucrose |

TABLE 59
Test Results for Degree of Sweetness

| | Correctly identified | |
|---|---|---|
| | and rated sweeter/ | Statistical |
| Test # | total number of panelists | significance |
| #1 | 17/24 | significant (p < 0.01) |
| #2 | 14/24 | significant (p < 0.05) |
| #3 | 7/24 | not significant |
| #4 | 18/24 | significant (p < 0.01) |
| #5 | 16/24 | significant (p < 0.01) |
| #6 | 9/24 | not significant |

Based on a fixed significance level of 5%, the sweetness increase of 70 ppm A1 or A2 is equivalent to 1.5% sucrose.

Flavor Modifying Properties

Flavor modifying properties of A1 and A2 were tested in a beverage composed of water, sucrose (8.0%), carbonic acid, citric acid (0.2%), and flavor (0.05-0.1%). The flavors used were commercially available lemon or orange flavor.

The sensory test setting was the same as described above, except that the question was modified to “Which one is better flavored?” Samples as shown in Table 60 in order to evaluate the effect of A1 and A2 on flavor, while Table 61 shows the results.

TABLE 60
Test Design for Triangle Tests
with a 3-AFC Test Design

| Target | Test | A | B |
|---|---|---|---|
| Recognition | #1 | Beverage base lemon with | Beverage base lemon |
| of Difference | | 70 ppm A1 | |
| | #2 | Beverage base orange | Beverage base orange |
| | | with 70 ppm A1 | |
| | #3 | Beverage base lemon with | Beverage base lemon |
| | | 70 ppm A2 | |
| | #4 | Beverage base orange | Beverage base orange |
| | | with 70 ppm A2 | |

TABLE 61
Results for Tests Investigating Flavor Modifying Properties

| | Correctly identified | |
|---|---|---|
| | and rated better/ | Statistical |
| Test # | total number of test persons | significance |
| #1 | 14/24 | significant (p < 0.05) |
| #2 | 16/24 | significant (p < 0.01) |
| #3 | 13/24 | significant (p < 0.05) |
| #4 | 18/24 | significant (p < 0.01) |

The test results show that both A1 and A2 exert flavor modifying properties.

### Example 19 SG Composition of Exemplary Samples

Multiple samples of exemplary liquid preparations were subjected to HPLC to determine the SG composition of the preparations. The HPLC was calibrated using standards of RA, RB, RC, RD, RE, RF, RG, RM, and RN. Materials Reference standards for steviolglycosides (RA, RB, RC, RD, RE, RF, RG, RM, RN) were obtained from Chromadex (LGC Germany). Solvents and reagents (HPLC grade) were obtained from VWR (Vienna) or Sigma-Aldrich (Vienna). Davisil Grade 633 (high-purity grade silica gel, pore size 60 Å, 200-425 mesh particle size was obtained from Sigma-Aldrich (Vienna).

### Preparation of Sample Compositions FEML and SEML

The SG composition No. 1 of Example 11 was dissolved in 10 times its weight of water and treated with a macroporous resin (1 L, resin model: T28, available from Sunresin new materials Co. Ltd., China). Materials were desorbed with a mixture of ethanol and water with different blend ratios. In this example, the materials were desorbed first with 20% ethanol and secondly with 70% ethanol. The desorption solution with 20% ethanol was concentrated and subsequently spray-dried to provide a powder. This powder was named FEML. The desorption solution with 70% ethanol was concentrated and subsequently spray-dried to provide a powder. This powder was named SEML.

### Sample Preparation

Dissolve 10 mg sample in 10 ml acetonitrile/water=9/1 (v/v), clarify by syringe filtration (0.45 m) and inject on to the HPLC system.

### HPLC-Method

The HPLC system consisted of an Agilent 1100 system (autosampler, ternary gradient pump, column thermostat, VWD-UV/VIS detector, DAD-UV/VIS detector) connected in-line to an Agilent mass spectrometer (ESI-MS quadrupole G1956A VL). For HPLC analysis 150 mg of the corresponding sample was dissolved in Acetonitrile (1 ml) and filled up to 10 ml with H2O.

Samples were separated at 0.8 ml/min on a Phenomenex Synergi Hydro-RP (150×3 mm) followed by a Macherey-Nagel Nucleosil 100-7 C18 (250×4.6 mm) at 45° C. by gradient elution.

Mobile Phase A consisted of a 0.01 molar NH4-Acetate buffer (native pH) with 0.1% acetic acid, 0.05% trimethylamine and 0.001% dichloromethane. Mobile Phase B consisted of 0.01 molar NH4-Acetate buffer (native pH) and Acetonitrile (1/9 v/v) with 0.1% acetic acid, 0.05% trimethylamine and 0.001% dichloromethane. The gradient started with 22% B, was increased linearly in 20 minutes to 45% B and kept at this condition for another 15 minutes. Injection volume was set to 10 μl.

The detectors were set to 210 nm (VWD), to 205 and 254 nm (DAD with spectra collection between 200-600 nm) and to ESI negative mode TIC m/z 300-1500, Fragmentor 200, Gain 2 (MS, 300° C., nitrogen 12 l/min, nebulizer setting 50 psig. Capillary voltage 4500 V).

Detection at 210 nm was used to quantify the chromatograms, the MS-spectra were used to determine the molar mass and structural information of individual peaks. Detection at 254 nm was used to identify non-SG peaks.

Identification and Quantification

SGs were identified by comparison of retention times to authentic reference standards and/or by evaluation of the mass spectra obtained (including interpretation of the fragmentation pattern and double charged ions triggered by the presence of dichloromethane).

Steviol-glycosides were quantified by the percentage of their peak area to the peak area of total steviol glycosides.

Tables 62 and 63 show the SG content of exemplary compositions of the present disclosure. Result

TABLE 62
Steviolglycosides detected and quantified in sample FEML

| | | % in SG |
|---|---|---|
| | mg/10 ml | fraction |
| Reb-D | 0.09 | 12.14 |
| Reb-A | 0.51 | 70.73 |
| Stev | 0.09 | 12.14 |
| Reb-B | 0.04 | 4.99 |
| Sum: | 0.73 | 100.00 |

TABLE 63
Steviolglycosides detected and quantified in sample SEML

| SEML | mg/10 ml | % in SG fraction |
|---|---|---|
| Reb-O | 0.10 | 2.16 |
| Reb-D | 0.51 | 11.03 |
| Reb-M | 0.12 | 2.63 |
| Reb-N | 0.14 | 2.91 |
| Reb-E | 0.06 | 1.30 |
| Reb-H | 0.33 | 7.05 |
| Reb-I | 0.15 | 3.24 |
| Reb-A | 2.44 | 52.44 |
| Stev | 0.09 | 1.94 |
| Reb-C | 0.51 | 10.84 |
| Reb-G | 0.05 | 0.99 |
| Reb-B | 0.06 | 1.39 |
| Dulcoside | 0.04 | 0.87 |
| Steviolbioside | 0.06 | 1.20 |
| | 4.66 | 100.00 |

### Conclusion

The steviol glycosides can be absorbed by macroporous resin and desorbed by ethanol solution. The steviol glycosides with high molecular weight can be enriched by adjusting the concentration of the ethanol solution. When the concentration of ethanol solution is about 20%, most non-steviol glycosides and some steviol glycosides with low molecular weight are desorbed from resin and most steviol glycosides with high molecular weight still retain on the resin. After desorbed by ethanol solution with the concentration of about 70%, almost all steviol glycosides retained on resin can be desorbed. Thus the steviol glycosides with high molecular weight can be purified and enriched by the method in this example.

Although the present application has been described with reference to preferred embodiments, persons skilled in the art will recognize that changes may be made in form and detail without departing from the spirit and scope of the application. All references cited throughout the specification, including those in the background, are incorporated herein in their entirety. Those skilled in the art will recognize, or be able to ascertain, using no more than routine experimentation, many equivalents to specific embodiments of the application described specifically herein. Such equivalents are intended to be encompassed in the scope of the following claims.

What is claimed is:

1. An orally consumable composition comprising SGs from table A, wherein the composition comprises one or more SGs having high molecular weight, and wherein the one or more SGs having high molecular weight are selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, and RO2; and wherein the composition comprises RA, wherein RA comprises 15-50 wt % of the total SGs in the composition; wherein the composition further comprises ST, wherein the ST comprises 15-30 wt % of the total SGs in the composition; and further wherein the composition comprises RE, wherein the RE comprises 0.3-0.9 wt % of the composition.

2. The orally consumable composition of claim 1, wherein the one or more SGs having high molecular weight have a molecular weight equal to or greater than 1097 daltons, and wherein the one or more SGs having high molecular weight comprise 4-20% by weight of the total SGs in the composition.

3. The orally consumable composition of claim 1, wherein the one or more SGs having high molecular weight have a molecular weight equal to or greater than 1127 daltons, and wherein the one or more SGs having high molecular weight comprise 2-15% by weight of the total SGs in the composition.

4. The orally consumable composition of claim 1, wherein the one or more SGs having high molecular weight have a molecular weight equal to or greater than 1273 daltons, and wherein the one or more SGs having high molecular weight comprise 0.3-2% by weight of the total SGs in the composition.

5. The orally consumable composition of claim 1, wherein the one or more SGs having high molecular weight have a molecular weight equal to or greater than 1305 daltons, and wherein the one or more SGs having high molecular weight comprise 0.4-1.5% by weight of the total SGs in the composition.

6. The orally consumable composition of claim 1, wherein the one or more SGs having high molecular weight have a molecular weight equal to or greater than 1435 daltons, and wherein the one or more SGs having high molecular weight comprise 0.4-1.5% by weight of the total SGs in the composition.

7. The orally consumable composition of claim 1, wherein the one or more SGs having high molecular weight are selected from the group consisting of one or more of RM is 0-0.4% by weight of the total SGs in the composition, RN is 0-2% by weight of the total SGs in the composition, RO is 0.2-1.5% by weight of the total SGs in the composition, RH is 0-0.3% by weight of the total SGs in the composition, RI is 0-0.6% by weight of the total SGs in the composition, RI3 is 0.4-1% by weight of the total SGs in the composition, RJ is 0-0.7% by weight of the total SGs in the composition, RK is 1-5% by weight of the total SGs in the composition, RL is 0-0.4% by weight of the total SGs in the composition, RU is 0.1-0.5% by weight of the total SGs in the composition, RV is 0-0.6% by weight of the total SGs in the composition, RV2 is 0-0.6% by weight of the total SGs in the composition, and RY is 0-0.4% by weight of the total SGs in the composition.

8. The orally consumable composition of claim 1, wherein the composition has an improved taste profile including aftertaste, bitterness and/or lingering taste compared to a composition without the composition of claim 2.

9. The orally consumable composition of claim 1, wherein the composition has an increased solubility in an aqueous solution compared to a composition without the composition of claim 2.

10. The orally consumable composition according to claim 1, further comprising one or more non-SG sweeteners.

11. The orally consumable composition according to claim 1, further comprising one or more salts.

12. The orally consumable composition according to claim 1, wherein the composition contains trace amounts of non-SG off-taste components.

13. The orally consumable composition of claim 1, wherein the orally consumable composition is a sweetener.

14. The orally consumable composition of claim 1, wherein the orally consumable composition is a flavoring agent.

15. The orally consumable composition of claim 1, wherein the one or more SGs having a high molecular weight constitute at least 5 ppm of the total orally consumable composition.

16. A method for improving the taste profile including aftertaste, bitterness and/or lingering of a SGs composition, comprising the step of adding an effective amount of the composition of claim 1 to the SGs composition.

17. A method for increasing the solubility of a SGs composition in an aqueous solution, comprising the step of adding an effective amount of the composition of claim 1 to the SGs composition.

18. A method for increasing the sweetness of an orally consumable composition, comprising the step of: adding an effective amount of a composition of claim 1 to the orally consumable composition.

19. A method for increasing a taste or flavor of an orally consumable composition, comprising the step of: adding an effective amount of a composition of claim 1 to the orally consumable composition.

20. A composition comprising one or more SGs, wherein the SG has a parent structure of formula II or formula III; wherein R₁ and R₂ are substituent groups individually selected from the group consisting of glucosyl (G), rhamnosyl (R), xylosyl (X), deoxy-glucosyl (dG), frucosyl (F), arabinosyl (A), galactosyl (Ga) group, and any combination thereof, and wherein the number of the glucosyl group is equal to or greater than 4; and wherein the composition comprises stevioside (ST) in the range 20-70 wt % of the total SGs in the composition.

21. The composition of claim 20, wherein the one or more SGs are selected from the group consisting of Related SG#2, Related SG#5, RU2, RT, RW, RW2, RW3, RU, SG-12, RH, RJ, RK, RK2, SG-Unk4, SG-Unk5, RD, RI, RL, RI3, SG-Unk6, RQ, RI2, RQ2, RQ3, RT1, Related SG#4, RV2, RV, RY, RN, RM, 15α-OH RM, RO, and RO2.

22. The composition of claim 20, wherein the total SGs are present at an amount of over 80% by weight of the composition.

23. The composition of claim 20, wherein the one or more SGs are present at an amount of 1-30% by weight of the total SGs in the composition.

24. The composition of claim 20, wherein the one or more SGs are selected from the group consisting of one or more selected from RV is 0-0.6% by weight of the total SGs in the composition, RT is 0-0.9% by weight of the total SGs in the composition, RN is 0-0.3% by weight of the total SGs in the composition, RM is 0-0.4% by weight of the total SGs in the composition, RJ is 0-0.3% by weight of the total SGs in the composition, RW is 0-0.4% by weight of the total SGs in the composition, RU2 is 0-0.5% by weight of the total SGs in the composition, RY is 0-0.3% by weight of the total SGs in the composition, RI is 0-0.3% by weight of the total SGs in the composition, RV2 is 0-0.5% by weight of the total SGs in the composition, RK2 is 0-0.5% by weight of the total SGs in the composition, and RH is 0-0.3% by weight of the total SGs in the composition.

25. A composition comprising RA and the composition of claim 20.

26. The composition of claim 25, wherein RA is 15-50 wt % of the total SGs in the composition.

27. The composition of claim 26, wherein the ST is in the range of 14-40 wt % of the total SGs in the composition.

28. The composition of claim 27, wherein the ST is in the range of 15-30 wt % of the total SGs in the composition.

29. A composition comprising two groups of SGs, the first group of SGs comprises one or more SGs selected from claim 20, and the second group of SGs comprises one or more SGs selected from the groups essentially consisting of RA, RB, Stevioside, RC, RD, RM or the combination thereof, wherein the ratio of the weight of the first group and the second group of SG is selected from one of the group consisting of 1:99, 2:98, 3:97, 4:96; 5:95; 6:94; 7:93; 8:94; 9:91; 10:90; 11:89; 12:88; 13:87; 14:86; 15:85; 16:84; 17:83; 18:82; 19:81; 20:80; 21:79; 22:78; 23:77; 24:76; 25:75; 26:74; 27:73; 28:72; 29:71; 30:70; 31:69; 32:68; 33:67; 34:66; 35:65; 36:64; 37:63; 38:62; 39:61; 40:60; 41:59; 42:58; 43:57; 44:56; 45:55; 46:54; 47:53; 48:52; 49:51; 50:50; 51:49; 52:48; 53:47; 54:45; 55:45; 56:44; 57:43; 58:42; 59:41; 60:40; 61:39; 62:38; 63:37; 64:36; 65:35; 66:37; 67:33; 68:32; 69:31; 70:30; 71:29; 72:28; 73:27; 74:26; 75:25; 76:24; 77:23; 78:22; 79:21; 80:20; 81:19; 82:18; 83:17; 84:16; 85:15; 86:14; 87:13; 88:12; 89:11; 90:10; 91:9; 92:8; 93:7; 94:6; 95:5; 96:4; 97:3; 98:2 and 99:1, wherein the ST is in the range of 14-40 wt % of the total SGs in the composition.

30. A method of preparing a composition according to claim 1, comprising the steps:
dissolving the crude extract of stevia with a first ethanol aqueous solution to form a mixture, heating the mixture until the mixture provides a solution;
cooling the solution to ambient temperature;
separating the supernatant and precipitant from the solution;
subjecting the supernatant to drying to form a powder;
dissolving the powder with water to form a second solution;
treating the second solution with macroporous resin to form a material; and
desorbing the material with a second ethanol aqueous solution.

31. The method of claim 30, wherein the concentration of the second ethanol aqueous solution is above 0 to less than 50 wt %, preferably 20-50 wt %, more preferably 25-35 wt %.

32. The method of claim 30, wherein the concentration of the second ethanol aqueous solution is 50-100 wt %, preferably 60-80 wt %, more preferably 65-75 wt %.
